(19) United States
(12) Patent Application Publication
(10) Pub. No.: US 2011/0211739 A1
(43) Pub. Date: Sep. 1, 2011

(54) Identifying a characteristic of an individual utilizing facial recognition and providing a display for the individual

(75) Inventors: Philip A. Eckhoff, Bellevue, WA (US); William Gates, Redmond, WA (US); Peter L. Hagelstein, Carlisle, MA (US); Roderick A. Hyde, Redmond, WA (US); Muriel Y. Ishikawa, Livermore, CA (US); Jordin T. Kare, Seattle, WA (US); Robert Langer, Newton, MA (US); Eric C. Leuthardt, St. Louis, MO (US); Erez Lieberman, Cambridge, MA (US); Nathan P. Myhrvold, Bellevue, WA (US); Michael Schnall-Levin, Cambridge, MA (US); Clarence T. Tegreene, Bellevue, WA (US); Lowell L. Wood, JR., Bellevue, WA (US)

(73) Assignee: Searete LLC, a limited liability corporation of the State of Delaware

(21) Appl. No.: 12/931,156

(22) Filed: Jan. 25, 2011

Related U.S. Application Data
(63) Continuation-in-part of application No. 12/655,179, filed on Dec. 23, 2009.
Application No. 12/655,179 is a continuation-in-part of application No. 12/655,194, filed on Dec. 23, 2009.
Application No. 12/655,194 is a continuation-in-part of application No. 12/655,184, filed on Dec. 23, 2009.
Application No. 12/655,184 is a continuation-in-part of application No. 12/655,188, filed on Dec. 23, 2009.
Application No. 12/655,188 is a continuation-in-part of application No. 12/655,185, filed on Dec. 23, 2009.
Application No. 12/655,185 is a continuation-in-part of application No. 12/655,186, filed on Dec. 23, 2009.
Application No. 12/655,186 is a continuation-in-part of application No. 12/655,183, filed on Dec. 23, 2009.
Application No. 12/655,183 is a continuation-in-part of application No. 12/655,187, filed on Dec. 23, 2009.

(51) Int. Cl. G06K 9/00

(52) U.S. Cl. 382/118

(57) ABSTRACT

A method may include automatically remotely identifying at least one characteristic of an individual via facial recognition; and providing a display for the individual, the display having a content at least partially based on the identified at least one characteristic of the individual. A system may include means for automatically remotely identifying at least one characteristic of an individual via facial recognition; and means for providing a display for the individual, the display having a content at least partially based on the identified at least one characteristic of the individual.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)).

### RELATED APPLICATIONS

For purposes of the USPTO extra-statutory requirements, the present application constitutes a continuation-in-part of U.S. patent application Ser. No. 12/655,179, entitled IDENTIFYING A CHARACTERISTIC OF AN INDIVIDUAL UTILIZING FACIAL RECOGNITION AND PROVIDING A DISPLAY FOR THE INDIVIDUAL, naming Philip Eckhoff; William Gates; Peter L. Hagelstein; Roderick A. Hyde; Muriel Y. Ishikawa; Jordin T. Kare; Robert Langer; Eric C. Leuthardt; Erez Lieberman; Nathan P. Myhrvold; Michael Schnall-Levin; Clarence T. Tegreene; and Lowell L. Wood, Jr. as inventors, filed Dec. 23, 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/655,194, entitled IDENTIFYING A CHARACTERISTIC OF AN INDIVIDUAL UTILIZING FACIAL RECOGNITION AND PROVIDING A DISPLAY FOR THE INDIVIDUAL, naming Philip Eckhoff; William Gates; Peter L. Hagelstein; Roderick A. Hyde; Muriel Y. Ishikawa; Jordin T. Kare; Robert Langer; Eric C. Leuthardt; Erez Lieberman; Nathan P. Myhrvold; Michael Schnall-Levin; Clarence T. Tegreene; and Lowell L. Wood, Jr. as inventors, filed Dec. 23, 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/655,184, entitled IDENTIFYING A CHARACTERISTIC OF AN INDIVIDUAL UTILIZING FACIAL RECOGNITION AND PROVIDING A DISPLAY FOR THE INDIVIDUAL, naming Philip Eckhoff; William Gates; Peter L. Hagelstein; Roderick A. Hyde; Muriel Y. Ishikawa; Jordin T. Kare; Robert Langer; Eric C. Leuthardt; Erez Lieberman; Nathan P. Myhrvold; Michael Schnall-Levin; Clarence T. Tegreene; and Lowell L. Wood, Jr. as inventors, filed Dec. 23, 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/655,188, entitled IDENTIFYING A CHARACTERISTIC OF AN INDIVIDUAL UTILIZING FACIAL RECOGNITION AND PROVIDING A DISPLAY FOR THE INDIVIDUAL, naming Philip Eckhoff; William Gates; Peter L. Hagelstein; Roderick A. Hyde; Muriel Y. Ishikawa; Jordin T. Kare; Robert Langer; Eric C. Leuthardt; Erez Lieberman; Nathan P. Myhrvold; Michael Schnall-Levin; Clarence T. Tegreene; and Lowell L. Wood, Jr. as inventors, filed Dec. 23, 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/655,185, entitled IDENTIFYING A CHARACTERISTIC OF AN INDIVIDUAL UTILIZING FACIAL RECOGNITION AND PROVIDING A DISPLAY FOR THE INDIVIDUAL, naming Philip Eckhoff; William Gates; Peter L. Hagelstein; Roderick A. Hyde; Muriel Y. Ishikawa; Jordin T. Kare; Robert Langer; Eric C. Leuthardt; Erez Lieberman; Nathan P. Myhrvold; Michael Schnall-Levin; Clarence T. Tegreene; and Lowell L. Wood, Jr. as inventors, filed Dec. 23, 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/655,186, entitled IDENTIFYING A CHARACTERISTIC OF AN INDIVIDUAL UTILIZING FACIAL RECOGNITION AND PROVIDING A DISPLAY FOR THE INDIVIDUAL, naming Philip Eckhoff; William Gates; Peter L. Hagelstein; Roderick A. Hyde; Muriel Y. Ishikawa; Jordin T. Kare; Robert Langer; Eric C. Leuthardt; Erez Lieberman; Nathan P. Myhrvold; Michael Schnall-Levin; Clarence T. Tegreene; and Lowell L. Wood, Jr. as inventors, filed Dec. 23, 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/655,183, entitled IDENTIFYING A CHARACTERISTIC OF AN INDIVIDUAL UTILIZING FACIAL RECOGNITION AND PROVIDING A DISPLAY FOR THE INDIVIDUAL, naming Philip Eckhoff; William Gates; Peter L. Hagelstein; Roderick A. Hyde; Muriel Y. Ishikawa; Jordin T. Kare; Robert Langer; Eric C. Leuthardt; Erez Lieberman; Nathan P. Myhrvold; Michael Schnall-Levin; Clarence T. Tegreene; and Lowell L. Wood, Jr. as inventors, filed Dec. 23, 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/655,187, entitled IDENTIFYING A CHARACTERISTIC OF AN INDIVIDUAL UTILIZING FACIAL RECOGNITION AND PROVIDING A DISPLAY FOR THE INDIVIDUAL, naming Philip Eckhoff; William Gates; Peter L. Hagelstein; Roderick A. Hyde; Muriel Y. Ishikawa; Jordin T. Kare; Robert Langer; Eric C. Leuthardt; Erez Lieberman; Nathan P. Myhrvold; Michael Schnall-Levin; Clarence T. Tegreene; and Lowell L. Wood, Jr. as inventors, filed Dec. 23, 2009, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### SUMMARY

In one aspect, a method includes, but is not limited to, automatically remotely identifying at least one characteristic of an individual via facial recognition; providing a display for the individual, the display having a content at least partially based on the identified at least one characteristic of the individual; and cease providing at least one of the display or the content for the individual based on a change in at least one of the individual's environment or the individual's status. In addition to the foregoing, other method aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer.

In one aspect, a system includes, but is not limited to, means for automatically remotely identifying at least one characteristic of an individual via facial recognition; means for providing a display for the individual, the display having a content at least partially based on the identified at least one characteristic of the individual; and means for cease providing at least one of the display or the content for the individual based on a change in at least one of the individual's environment or the individual's status. In addition to the foregoing, other system aspects are described in the claims, drawings, and text forming a part of the present disclosure.

In addition to the foregoing, various other method and/or system and/or program product aspects are set forth and described in the teachings such as text (e.g., claims and/or detailed description) and/or drawings of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

FIG. 1 is a schematic of a display.

FIG. 2 is a schematic of one or more displays.

FIG. 3 is a schematic of an action of an individual.

FIG. 4 is a schematic of a display.

FIG. 5 is a schematic of one or more displays.

FIG. 6 is a schematic of one or more displays.

FIG. 7 is a schematic of one or more displays.

FIG. 8 is a schematic of one or more displays.

FIG. 9 is a schematic of one or more displays.

FIG. 10 is a schematic of a display.

FIG. 11 is a schematic of one or more display modules.

FIG. 12 is a schematic of a facial recognition module coupled with one or more display modules.

FIG. 13 is a schematic of a display and a light source.

FIG. 14 is a schematic of visibility characteristics of a display.

FIG. 15 is a schematic of demographics of an individual.

FIG. 16 illustrates an operational flow representing example operations related to automatically remotely identifying one or more characteristics of an individual utilizing facial recognition, providing a display for the individual having a content at least partially based on the one or more identified characteristics of the individual, and identifying a clear line of sight between the display and the individual.

FIG. 17 illustrates an alternative embodiment of the operational flow of FIG. 16.

FIG. 18 illustrates an alternative embodiment of the operational flow of FIG. 16.

FIG. 19 illustrates an alternative embodiment of the operational flow of FIG. 16.

FIG. 20 illustrates an alternative embodiment of the operational flow of FIG. 16.

FIG. 21 illustrates an alternative embodiment of the operational flow of FIG. 16.

FIG. 22 illustrates an alternative embodiment of the operational flow of FIG. 16.

FIG. 23 illustrates an alternative embodiment of the operational flow of FIG. 16.

FIG. 24 illustrates an operational flow representing example operations related to automatically remotely identifying one or more characteristics of an individual utilizing facial recognition, providing a display for the individual having a content at least partially based on the one or more characteristics of the individual, identifying a clear line of sight between the display and the individual, and ceasing providing a display for the individual.

FIG. 25 illustrates an operational flow representing example operations related to automatically remotely identifying one or more characteristics of an individual utilizing facial recognition, providing a display for the individual having a content at least partially based on the one or more characteristics of the individual, identifying a clear line of sight between the display and the individual, and ceasing providing a display for the individual.

FIG. 26 illustrates an operational flow representing example operations related to automatically remotely identifying one or more characteristics of an individual utilizing facial recognition, providing a display for the individual having a content at least partially based on the one or more characteristics of the individual, identifying a clear line of sight between the display and the individual, and ceasing providing a display for the individual.

FIG. 27 illustrates an operational flow representing example operations related to automatically remotely identifying one or more characteristics of an individual utilizing facial recognition, providing a display for the individual having a content at least partially based on the one or more characteristics of the individual, identifying a clear line of sight between the display and the individual, and ceasing providing a display for the individual.

FIG. 28 illustrates an operational flow representing example operations related to automatically remotely identifying one or more characteristics of an individual utilizing facial recognition, providing a display for the individual having a content at least partially based on the one or more characteristics of the individual, identifying a clear line of sight between the display and the individual, and ceasing providing a display for the individual.

FIG. 29 illustrates an operational flow representing example operations related to automatically remotely identifying one or more characteristics of an individual utilizing facial recognition, providing a display for the individual having a content at least partially based on the one or more characteristics of the individual, identifying a clear line of sight between the display and the individual, and ceasing providing a display for the individual.

FIG. 30 illustrates an operational flow representing example operations related to automatically remotely identifying one or more characteristics of an individual utilizing facial recognition, providing a display for the individual having a content at least partially based on the one or more characteristics of the individual, identifying a clear line of sight between the display and the individual, and selecting the content for the display.

FIG. 31 illustrates an operational flow representing example operations related to automatically remotely identifying one or more characteristics of an individual utilizing facial recognition, providing a display for the individual having a content at least partially based on the one or more characteristics of the individual, identifying a clear line of sight between the display and the individual, and selecting the content for the display.

FIG. 32 illustrates an alternative embodiment of the operational flow of FIG. 31.

FIG. 33 illustrates an operational flow representing example operations related to automatically remotely identifying one or more characteristics of an individual utilizing facial recognition, providing a display for the individual having a content at least partially based on the one or more characteristics of the individual, and ceasing providing at least one of the display or the content for the individual.

FIG. 34 illustrates an alternative embodiment of the operational flow of FIG. 33.

FIG. 35 illustrates an alternative embodiment of the operational flow of FIG. 33.

FIG. 36 illustrates an alternative embodiment of the operational flow of FIG. 33.

FIG. 37 illustrates an alternative embodiment of the operational flow of FIG. 33.

FIG. 38 illustrates an alternative embodiment of the operational flow of FIG. 33.

FIG. 39 illustrates an alternative embodiment of the operational flow of FIG. 33.

FIG. 40 illustrates an operational flow representing example operations related to automatically remotely identifying one or more characteristics of an individual utilizing facial recognition, providing a display for the individual having a content at least partially based on the one or more characteristics of the individual, ceasing providing at least one of the display or the content for the individual, and identifying a clear line of sight between the display and the individual.

FIG. 41 illustrates an operational flow representing example operations related to automatically remotely identifying one or more characteristics of an individual utilizing facial recognition, providing a display for the individual having a content at least partially based on the one or more characteristics of the individual, ceasing providing at least one of the display or the content for the individual, and identifying a clear line of sight between the display and the individual.

FIG. 42 illustrates an alternative embodiment of the operational flow of FIG. 33.

FIG. 43 illustrates an operational flow representing example operations related to automatically remotely identifying one or more characteristics of an individual utilizing facial recognition, providing a display for the individual having a content at least partially based on the one or more characteristics of the individual, and ceasing providing at least one of the display or the content for the individual.

FIG. 44 illustrates an operational flow representing example operations related to automatically remotely identifying one or more characteristics of an individual utilizing facial recognition, providing a display for the individual having a content at least partially based on the one or more characteristics of the individual, and ceasing providing at least one of the display or the content for the individual.

FIG. 45 illustrates an operational flow representing example operations related to automatically remotely identifying one or more characteristics of an individual utilizing facial recognition, providing a display for the individual having a content at least partially based on the one or more characteristics of the individual, and ceasing providing at least one of the display or the content for the individual.

FIG. 46 illustrates an operational flow representing example operations related to automatically remotely identifying one or more characteristics of an individual utilizing facial recognition, providing a display for the individual having a content at least partially based on the one or more characteristics of the individual, and ceasing providing at least one of the display or the content for the individual.

FIG. 47 illustrates an operational flow representing example operations related to automatically remotely identifying one or more characteristics of an individual utilizing facial recognition, providing a display for the individual having a content at least partially based on the one or more characteristics of the individual, and ceasing providing at least one of the display or the content for the individual.

FIG. 48 illustrates an operational flow representing example operations related to automatically remotely identifying one or more characteristics of an individual utilizing facial recognition, providing a display for the individual having a content at least partially based on the one or more characteristics of the individual, and ceasing providing at least one of the display or the content for the individual.

FIG. 49 illustrates an alternative embodiment of the operational flow of FIG. 48.

FIG. 50 illustrates an operational flow representing example operations related to automatically remotely identifying one or more characteristics of an individual utilizing facial recognition, providing a display for the individual having a content at least partially based on the one or more characteristics of the individual, and selecting the content for the individual at least partially based on identifying an object associated with a gaze orientation of the individual.

FIG. 51 illustrates an alternative embodiment of the operational flow of FIG. 50.

FIG. 52 illustrates an alternative embodiment of the operational flow of FIG. 50.

FIG. 53 illustrates an alternative embodiment of the operational flow of FIG. 50.

FIG. 54 illustrates an alternative embodiment of the operational flow of FIG. 50.

FIG. 55 illustrates an alternative embodiment of the operational flow of FIG. 50.

FIG. 56 illustrates an alternative embodiment of the operational flow of FIG. 50.

FIG. 57 illustrates an operational flow representing example operations related to automatically remotely identifying one or more characteristics of an individual utilizing facial recognition, providing a display for the individual having a content at least partially based on the one or more characteristics of the individual, selecting the content for the individual at least partially based on identifying an object associated with a gaze orientation of the individual, and identifying a clear line of sight between the display and the individual.

FIG. 58 illustrates an operational flow representing example operations related to automatically remotely identifying one or more characteristics of an individual utilizing facial recognition, providing a display for the individual having a content at least partially based on the one or more characteristics of the individual, selecting the content for the individual at least partially based on identifying an object associated with a gaze orientation of the individual, and ceasing providing the display for the individual.

FIG. 59 illustrates an operational flow representing example operations related to automatically remotely identifying one or more characteristics of an individual utilizing facial recognition, providing a display for the individual having a content at least partially based on the one or more characteristics of the individual, selecting the content for the individual at least partially based on identifying an object associated with a gaze orientation of the individual, and ceasing providing the display for the individual.

FIG. 60 illustrates an operational flow representing example operations related to automatically remotely identifying one or more characteristics of an individual utilizing facial recognition, providing a display for the individual having a content at least partially based on the one or more characteristics of the individual, selecting the content for the individual at least partially based on identifying an object associated with a gaze orientation of the individual, and ceasing providing the display for the individual.

FIG. 61 illustrates an operational flow representing example operations related to automatically remotely identifying one or more characteristics of an individual utilizing facial recognition, providing a display for the individual having a content at least partially based on the one or more characteristics of the individual, selecting the content for the individual at least partially based on identifying an object associated with a gaze orientation of the individual, and ceasing providing the display for the individual.

FIG. 62 illustrates an operational flow representing example operations related to automatically remotely identifying one or more characteristics of an individual utilizing facial recognition, providing a display for the individual having a content at least partially based on the one or more characteristics of the individual, selecting the content for the individual at least partially based on identifying an object associated with a gaze orientation of the individual, and ceasing providing the display for the individual.

FIG. 63 illustrates an operational flow representing example operations related to automatically remotely identifying one or more characteristics of an individual utilizing facial recognition, providing a display for the individual having a content at least partially based on the one or more characteristics of the individual, selecting the content for the individual at least partially based on identifying an object associated with a gaze orientation of the individual, and ceasing providing the display for the individual.

FIG. 64 illustrates an operational flow representing example operations related to automatically remotely identifying one or more characteristics of an individual utilizing facial recognition, providing a display for the individual having a content at least partially based on the one or more characteristics of the individual, selecting the content for the individual at least partially based on identifying an object associated with a gaze orientation of the individual, and selecting the content for the first individual at least partially based on at least one characteristic of a second individual.

FIG. 65 is a illustrates an alternative embodiment of the operational flow of FIG. 64.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit a device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled/implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

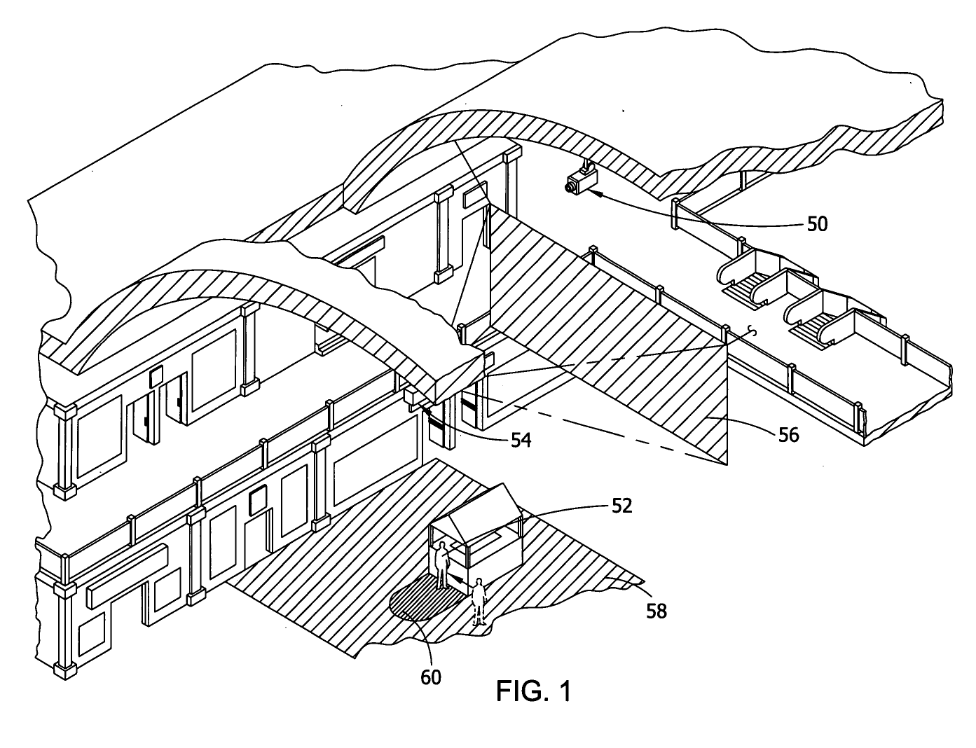

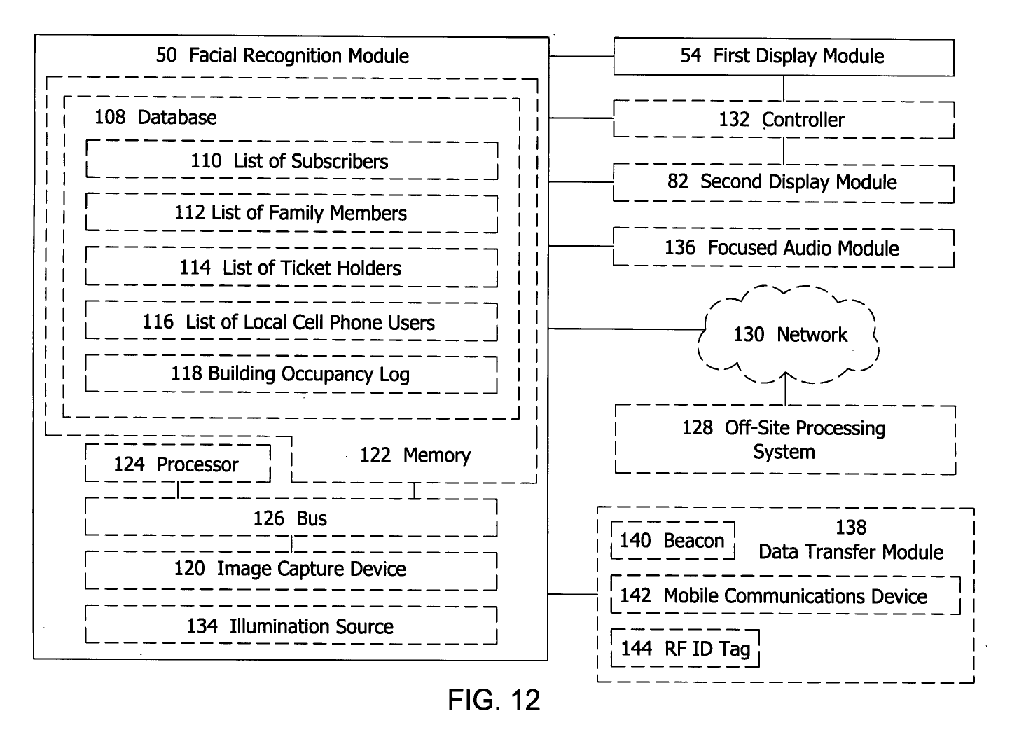

Referring now to FIGS. 1 and 12, a facial recognition module 50 may be utilized to automatically remotely identify one or more characteristics of a first individual 52. In an embodiment, the facial recognition module 50 may include an image capture device 120, such as a digital camera, a video camera, or the like for capturing an image of the first individual 52. The facial recognition module 50 may also include hardware, software, firmware or the like for implementing one or more facial recognition algorithms to identify the first individual 52. For instance, one or more facial characteristics of the first individual 52 may be stored in a memory 122 (which may include a database or the like) accessible by the facial recognition module 50, and the facial recognition module 50 may utilize data (e.g., facial characteristic data) stored in the database to identify the first individual 52. In embodiments, identifying the first individual 52 may include determining an identity of the first individual 52. For example, an identity of the first individual 52 may be determined by comparing facial characteristics of the first individual 52 stored in the memory 122 against one or more facial characteristics as imaged by the image capture device 120. In embodiments, the memory 122 may be connected to a processor 124 (e.g., via bus 126) for implementing one or more facial recognition algorithms to identify the first individual 52. The facial recognition algorithms may be stored in the memory 122. Additionally, data (e.g., facial characteristic data) may be provided to the facial recognition module 50 via a data transfer 138. For instance, a data transfer module 138 may be connected to the facial recognition module 50. In embodiments, the data transfer module 138 may include one or more of a beacon 140, a mobile communications device 142, an RFID tag 144, or the like. Alternatively, the facial recognition module 50 may be remotely connected to an off-site processing system 128 or the like via a network 130 (e.g., the Internet, an intranet, a Local Area Network (LAN), a Wide Area Network (WAN), an ad-hoc network, or the like). The off-site processing system 128 may implement one or more facial recognition algorithms to identify the first individual 52 and communicate the results to the facial recognition module 50 via the network 130.

A first display module 54 may be utilized to provide a first display 56 for the first individual 52, where the first display 56 has a content at least partially based on the one or more identified characteristics of the first individual 52. The first display module 54 may provide a first display 56 comprising visual stimuli such as an image or a series of images (e.g., a video) visible to the first individual 52. In an embodiment, the first display module 54 may include a video projector, a slide projector, a film projector, or another device for projecting moving or still images visible to the individual. The first display module 54 may provide a first display 56 comprising audio stimuli such as a sound or a series of sounds (e.g., a series of spoken words) audible to the first individual 52. In an embodiment, the first display module 54 may include a speaker, a loudspeaker, a focused sound projector, or another device for projecting audio to the individual. For example, a focused sound projector may be utilized to project a narrow beam of sound at the first individual 52 while at least substantially excluding others from being able to hear the audio broadcast to the first individual 52. The first display module 54 may provide a first display 56 comprising olfactory or tactile stimuli such as a current of air that may be smelled or felt by the first individual 52. For example, a fan may be utilized to direct a scented stream of air at the first individual 52. In embodiments, the first display module 54 may provide a first display 56 comprising any combination of one or more images, sounds, or sensations for the first individual 52.

In embodiments, the content of the first display 56 may comprise an advertisement, entertainment, or information. The content of the first display 56 may be uniquely targeted to the first individual 52. Alternatively, the content of the first display 56 may be targeted to the first individual 52 based on characteristics of one or more other individuals who share some type of relationship with (e.g., a spatial relationship) or connection (e.g., a social connection) to the first individual 52. For example, the content of the first display 56 for the first individual 52 may be selected at least partially based on a characteristic (e.g., a facial characteristic, an audio characteristic, or an identity) of the second individual 80. In embodiments, the second individual 80 may occupy a general area in proximity with the first individual 52. In addition, the second individual 80 may be traveling with the first individual 52. For instance, the second individual 80 may be connected to the first individual 52 via a social connection, such as occupying the role of an acquaintance, a friend, a spouse, or the like. In such an instance, identification of some characteristic of the second individual 80 (e.g., a gender) may be utilized when selecting the content of the first display 56 for the first individual 52. In embodiments, the display may include information about a product the first individual 52 may want to purchase for the second individual 80, for example, an article of clothing.

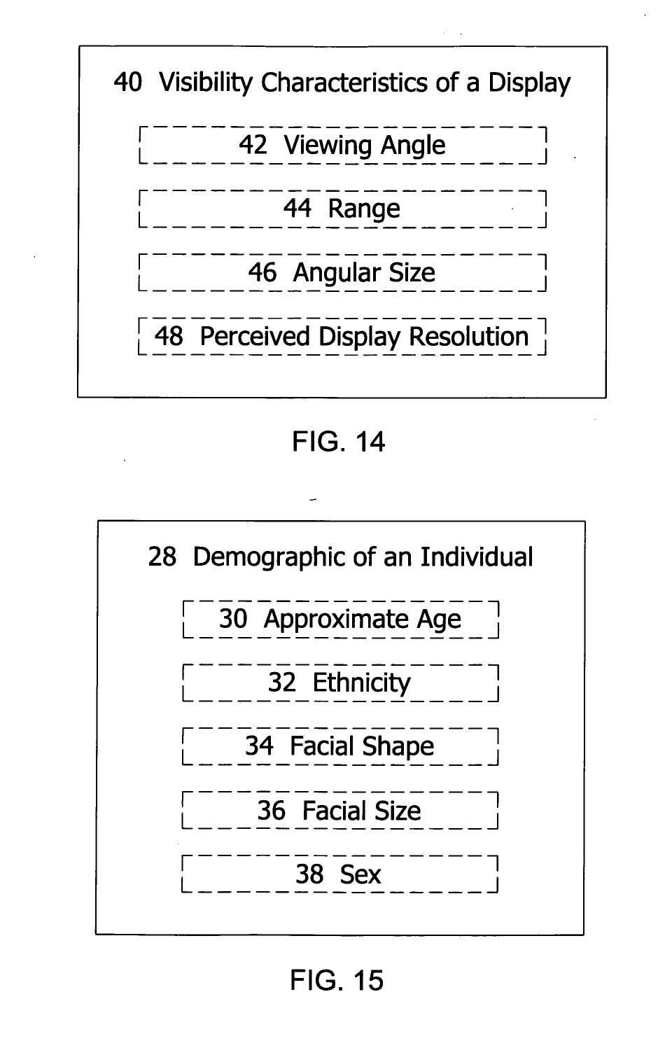

Referring now to FIGS. 1 and 14, the first display module 54 may be utilized to provide a first display 56 for the first individual 52 at least partially based on one or more identified visibility characteristics of the first display 56 for the first individual 52. In embodiments, visibility characteristics of the first display 56 for the first individual 52 may include a viewing angle 42 (i.e., an angle of the first individual 52 from a line extending away from the first display 56 in a direction generally normal to the display), a range 44 (e.g., a distance of the first individual 52 from the first display 56), an angular size 46 (e.g., a perceived size of the first display 56 based on an angle of the first individual from the display), or a perceived resolution of the display 48. Further, visibility characteristics of the first display 56 for the first individual 52 may be based on one or more of an identity or a demographic of the first individual 52. The first display module 54 may document the length of time the first display 56 is visible to the first individual 52. Visibility of the first display 56 to the first individual 52 may be determined at least partially based on identifying a clear line of sight between the first individual 52 and the display (i.e., identifying a generally unobstructed visual path between the first individual 52 and the first display 56) or a facial orientation of the first individual 52 relative to the first display 56 (e.g., a facial orientation directed generally towards the display). In embodiments, the documented length of time the first display 56 is visible to the first individual 52 may be utilized to assign a monetary value to the provision of the first display 56 visible to the first individual 52.

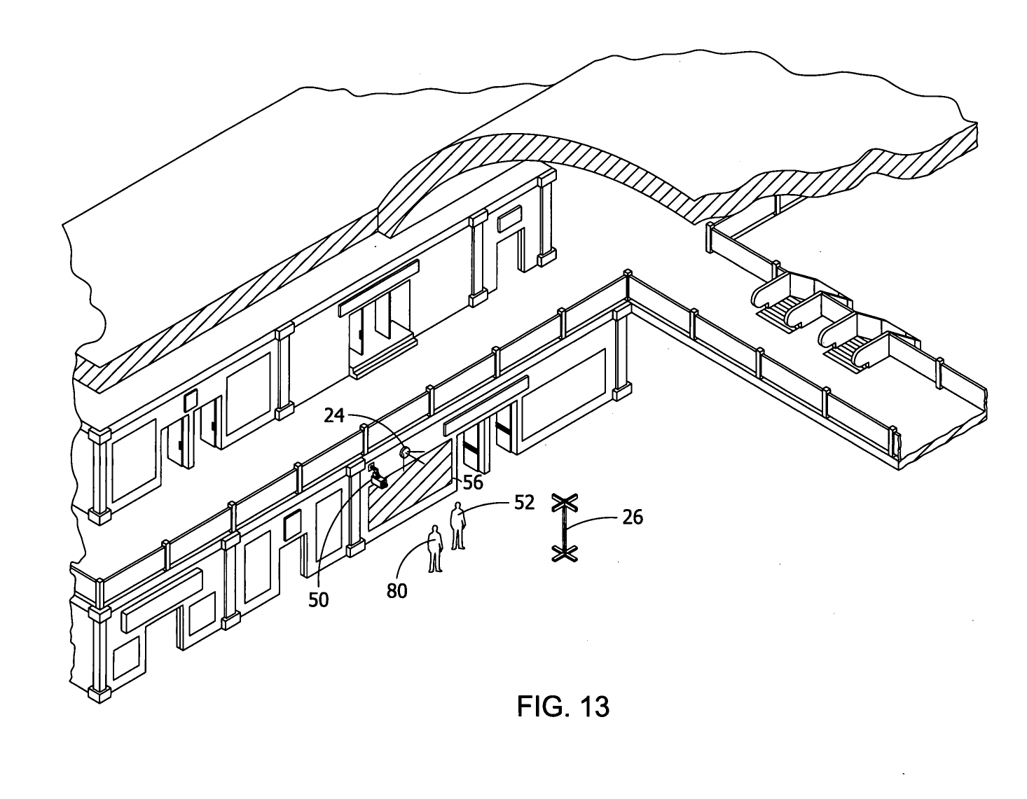

Referring to FIG. 13, the first display module 54 may utilize various techniques to identify a clear line of sight to the first individual 52. For example, the facial recognition module 50 may identify one or more characteristics of the first individual 52 from a location proximal to the first display 56. In embodiments, a light source 26 may be directed towards the first individual 52, and a reflectance of light from the light source 26 to a location proximal to the first display 56 may be detected. Thus, a position of one or more of the first display 56, the first individual 52, a proximate second individual 80, or a proximate object 26 may be utilized for predicting one or more line of sight characteristics.

Referring to FIGS. 1 and 15, the first display module 54 may provide a content at least partially based on a demographic 28 of the first individual 52. For example, the demographic 28 for the first individual may include one or more of an approximate age 30, an ethnicity 32, a facial shape 34, a facial size 36, or a sex 40. In an embodiment, the first display module 54 may provide a content at least partially based on the identity of the first individual 52. Further, the one or more facial recognition algorithms may utilize an orientation of the face of the first individual 52 relative to the first display 56 to identify the first individual 52. The one or more facial recognition algorithms may also utilize an orientation of an eye of the first individual 52 relative to the first display 56 to identify the first individual 52.

The first display module 54 may cease providing the first display 56 or the content of the first display 56 to the first individual 52 based on one or more of a change in the individual's environment or a change in the status of the first individual 52 (e.g., when the first individual 52 moves from a first region 58 where the first display 56 is visible to the first individual 52 to a second region 60 where the first display 56 is not visible to the first individual 52). In addition, the first display module 54 may provide the first display 56 or the content of the first display 56 to the first individual 52 based on one or more of a change in the individual's environment or a change in the status of the first individual 52. Ceasing the provision of the first display 56 for the first individual 52 may be documented.

A change in the individual's environment may include the occurrence of an event (e.g., the individual is paged or receives a cellular telephone call) or a change in the status of some inanimate object (e.g., a sign previously facing the individual is now turned away from the individual). Additionally, a change in the individual's environment may include a change in one or more of movement, color, attitude, relationship, or time. A change in the status of the individual may include a change in a relationship between one or more of the individual and an inanimate article, an animate article, a person, a group of persons, or a set of articles. In embodiments, a change in the status of the individual may include a change in one or more of the presence or the absence of one or more of a second individual 80 or a third individual 86 in proximity to the first individual 52. A change in the status of the individual may include the location of a second individual. In an embodiment, a change in the status of the individual may include identifying an absence of a clear line of sight between the first display 56 and the first individual 52. Further, a change in the status of the individual may include an action of the individual (e.g., moving from the first region 58 to the second region 60). It will be appreciated that a display module may cease providing the display or the content to an individual based on a change in the individual's environment, a change in the status of the individual, or a combination of a change in the individual's environment and a change in the status of the individual. It will also be appreciated that a display module may provide the display or the content to an individual based on a change in the individual's environment, a change in the status of the individual, or a combination of a change in the individual's environment and a change in the status of the individual.

Referring now to FIGS. 1 and 14, the first display module 54 may be utilized to cease providing a first display 56 for the first individual 52 at least partially based on one or more identified visibility characteristics 40 of the first display 56 for the first individual 52. Visibility characteristics 40 of the first display 56 for the first individual 52 may include a viewing angle 42, a range 44, an angular size 46, or a perceived resolution of the display 48. Further, visibility characteristics of the first display 56 for the first individual 52 may be based on one or more of an identity or a demographic of the first individual 52.

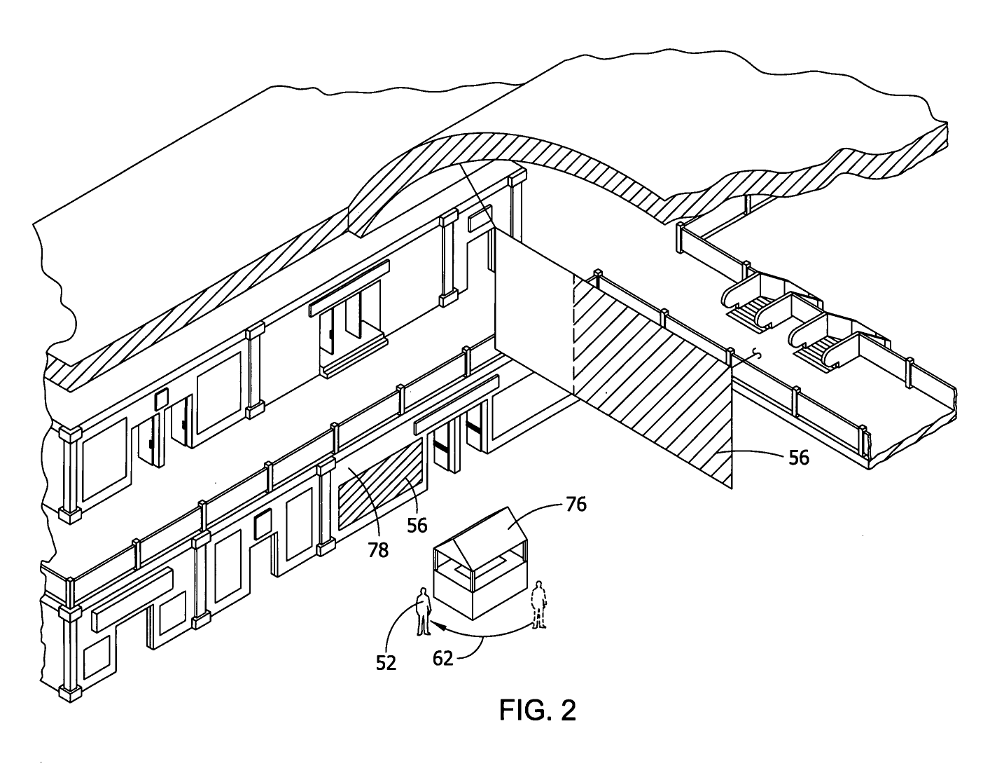

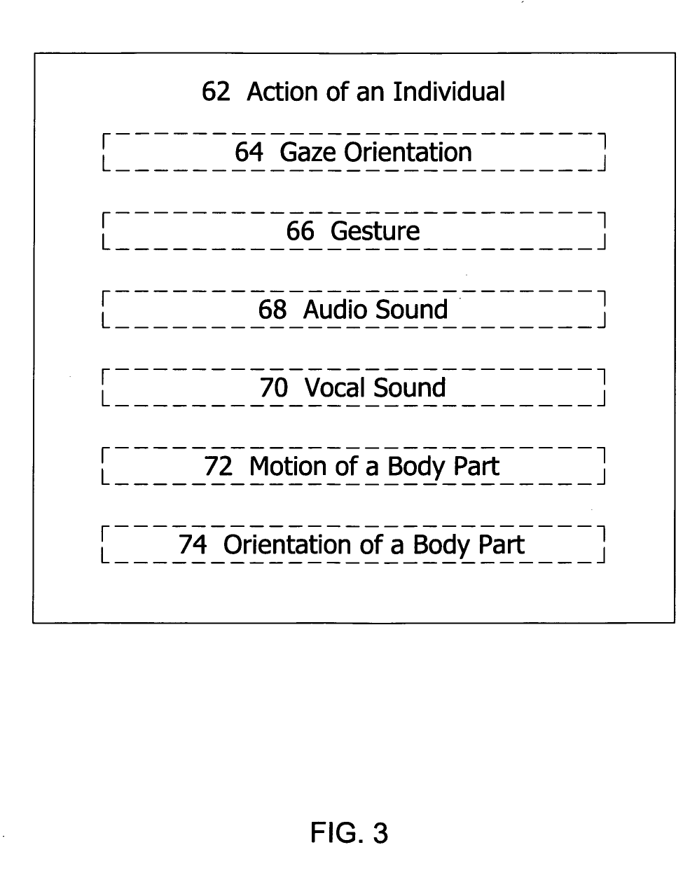

Referring now to FIGS. 2 and 3, the content selected for the first individual 52 may be selected based on an action of the individual 62. The action of the individual 62 may include one or more of a gaze orientation 64, a gesture 66, an audio sound 68, a vocal sound 70, a motion of at least a part of a body 72, or an orientation of at least a part of a body 74. In an embodiment, gaze orientation 64 may include, for instance, glancing at an item but not moving towards it. In an embodiment, gesture 66 may include a facial expression. In an embodiment, the orientation of at least a part of a body 74 may include, but is not limited to, the posture or stance of the individual, the angle of the individual to the display, or the range of the individual from the display. The first display 56 may be projected onto a hanging screen and may have a first content when the first individual 52 is standing next to a kiosk 76 (e.g., an advertisement for merchandise sold at the kiosk 76). When the first individual 52 begins to move toward a storefront 78, the first display 56 may be projected onto a wall of the storefront 78 and may have a different content (e.g., an advertisement for merchandise sold within).

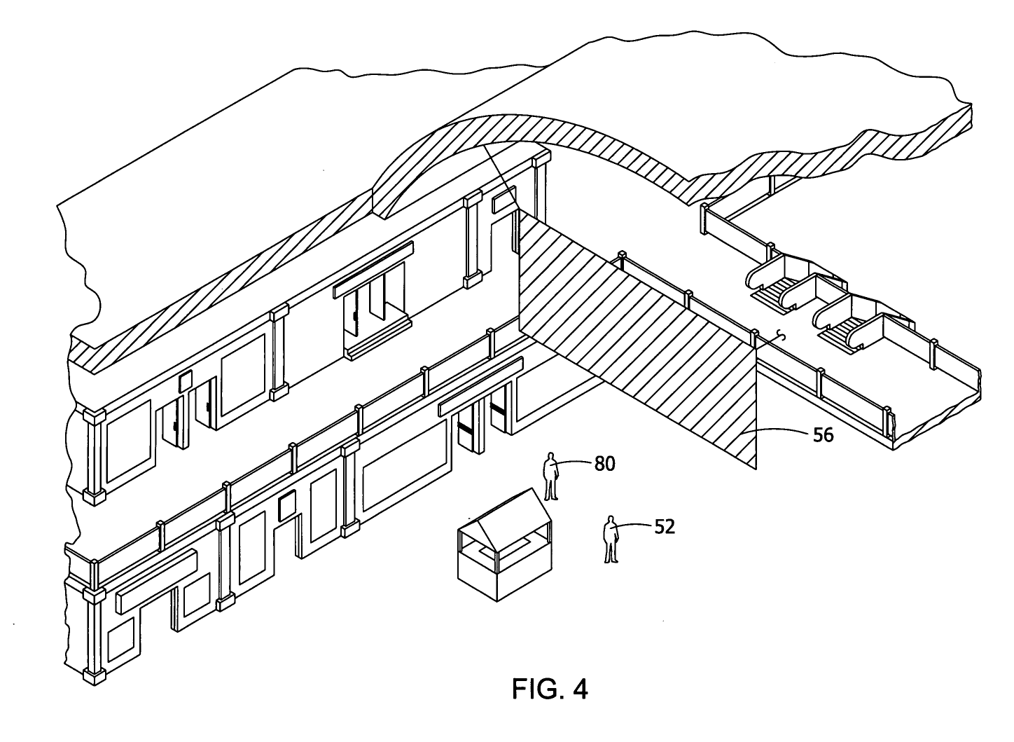

Referring now to FIG. 4, the first display module 54 may cease providing the first display 56 to the first individual 52 based on automatically remotely identifying one or more characteristics of a second individual 80. The facial recognition module 50 may be utilized to automatically remotely identify one or more characteristics of the second individual 80. The second individual 80 may be a higher priority individual (according to any user-specified criteria) than the first individual 52, and the first display module 54 may be utilized to provide the first display 56 to the second individual 80, where the first display 56 has a content at least partially based on the one or more identified characteristics of the second individual 80. In embodiments, the second individual 80 may be identified as a higher priority individual (e.g., relative to the first individual 52) utilizing a criteria such as an approximate age, an ethnicity, a demographic, a viewing angle, or a range. For example, the second individual 80 may be of an approximate age, an ethnicity, or a demographic that more closely matches target criteria for advertising content provided by the first display 54. Alternatively, the second individual 80 may be at a more desirable viewing angle or within a more desirable range of the first display 54, allowing for a more effective presentation of content to the second individual 80 utilizing the first display 54. In an embodiment, a controller 132 may be connected to the facial recognition module 50 and the first display module 54. When the facial recognition module 50 identifies the second individual 80, the controller 132 may instruct the first display module 54 to cease providing the first display 56 to the first individual 52. Additionally, the controller 132 may instruct the first display module 54 to provide the first display 56 to the second individual 80.

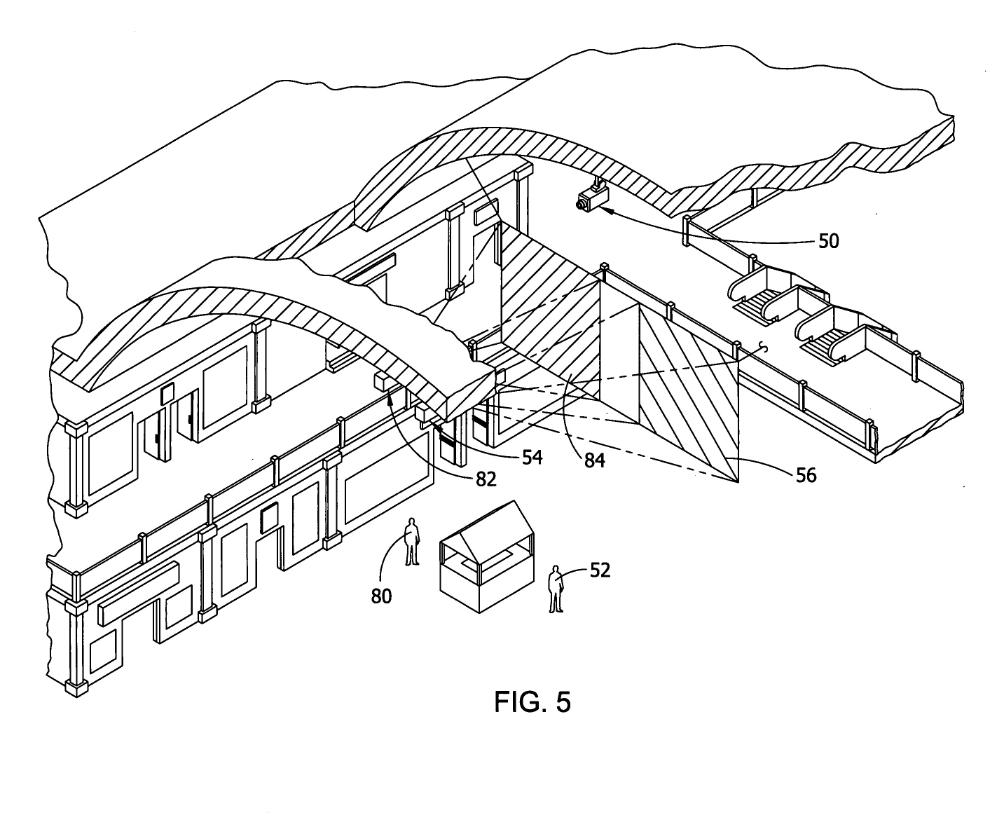

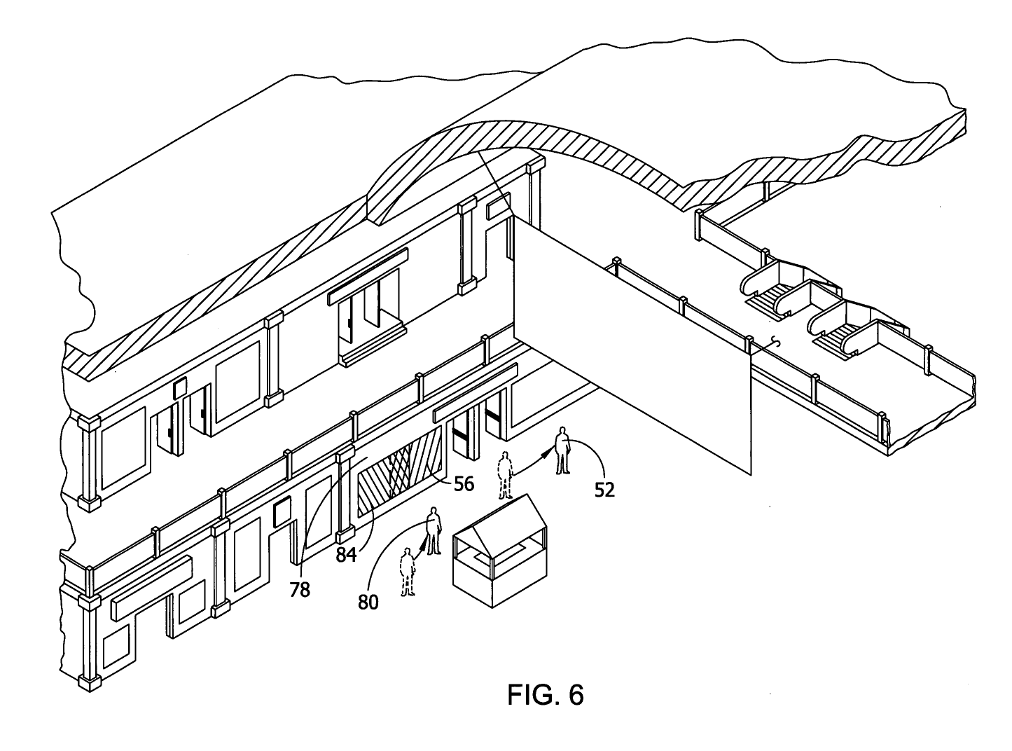

Referring now to FIGS. 5 and 6, the facial recognition module 50 may be utilized to automatically remotely identify one or more characteristics of a first individual 52. A first display module 54 may be utilized to provide a first display 56 for the first individual 52, where the first display 56 has a content at least partially based on the one or more identified characteristics of the first individual 52. Additionally, the facial recognition module 50 may be utilized to automatically remotely identify one or more characteristics of the second individual 80. A second display module 82 may be utilized to provide a second display 84 for the second individual 80, where the second display 84 has a content at least partially based on the one or more identified characteristics of the second individual 80. The first display module 54 may cease providing the first display 56 to the first individual 52 based on an action of the first individual 52 (e.g., when the first individual 52 moves away from the storefront 78 where the first display 56 is visible to the first individual 52). The second display module 82 may cease providing the second display 84 to the second individual 80 based on an action of the second individual 80 (e.g., when the second individual 80 moves away from the storefront 78 where the second display 84 is visible to the second individual 80).

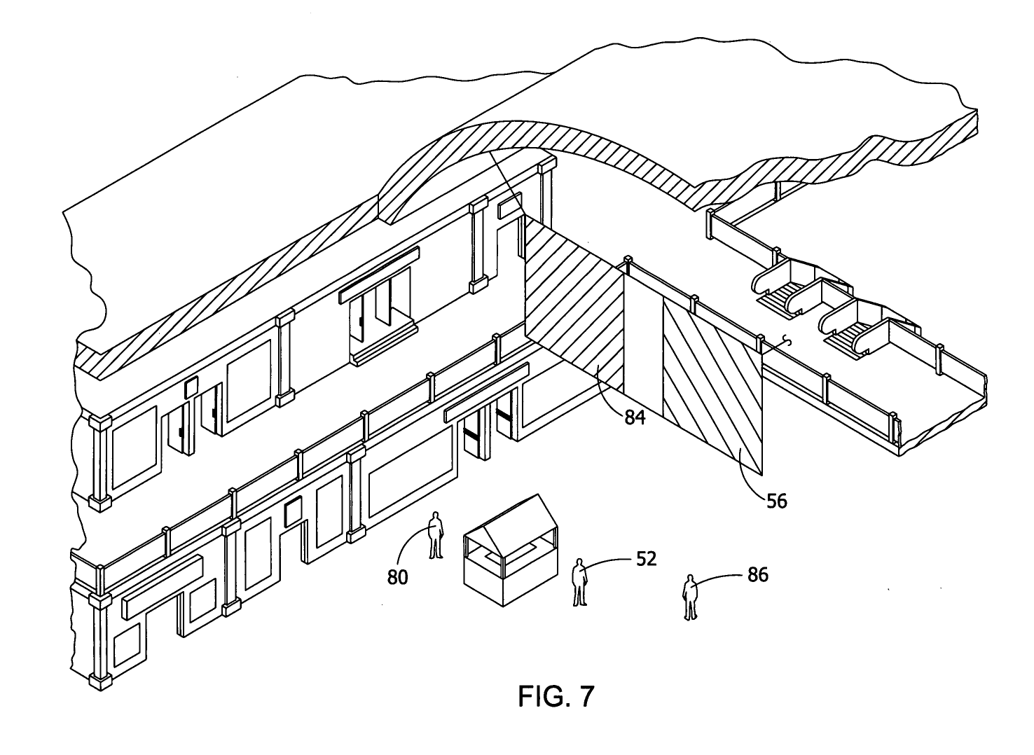

Referring now to FIG. 7, the facial recognition module 50 may be utilized to automatically remotely identify one or more characteristics of a third individual 86. The content for the first individual 52 or the content for the second individual 80 may be selected at least partially based on the third individual 86.

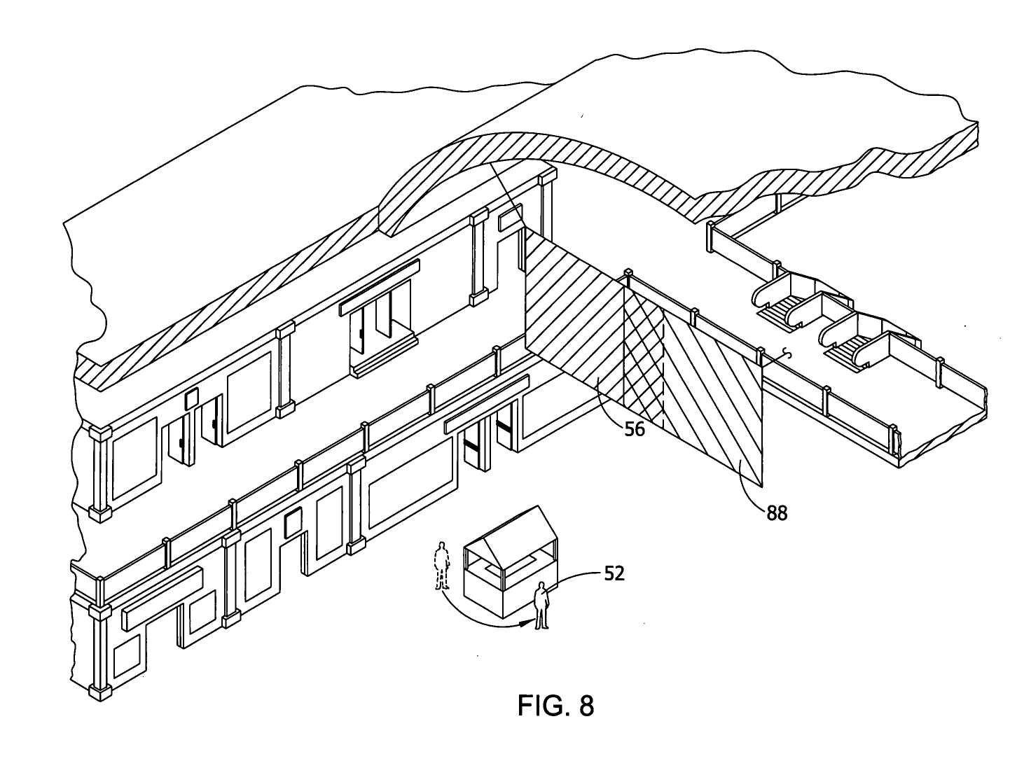

Referring now to FIG. 8, the first display module 54 may cease providing the first display 56 to the first individual 52 based on an action of the first individual 52. The facial recognition module 50 may be utilized to identify the action of the first individual 52 (e.g., when the first individual 52 moves from a first region where the first display 56 is visible to the first individual 52 to a second region where the first display 56 is not visible to the first individual 52). The first display module 54 may be utilized to provide a third display 88 for the first individual 52, where the third display 88 has a content at least partially based on the one or more identified characteristics of the first individual 52. And that content may be the same or different from the content provided by the first display 56.

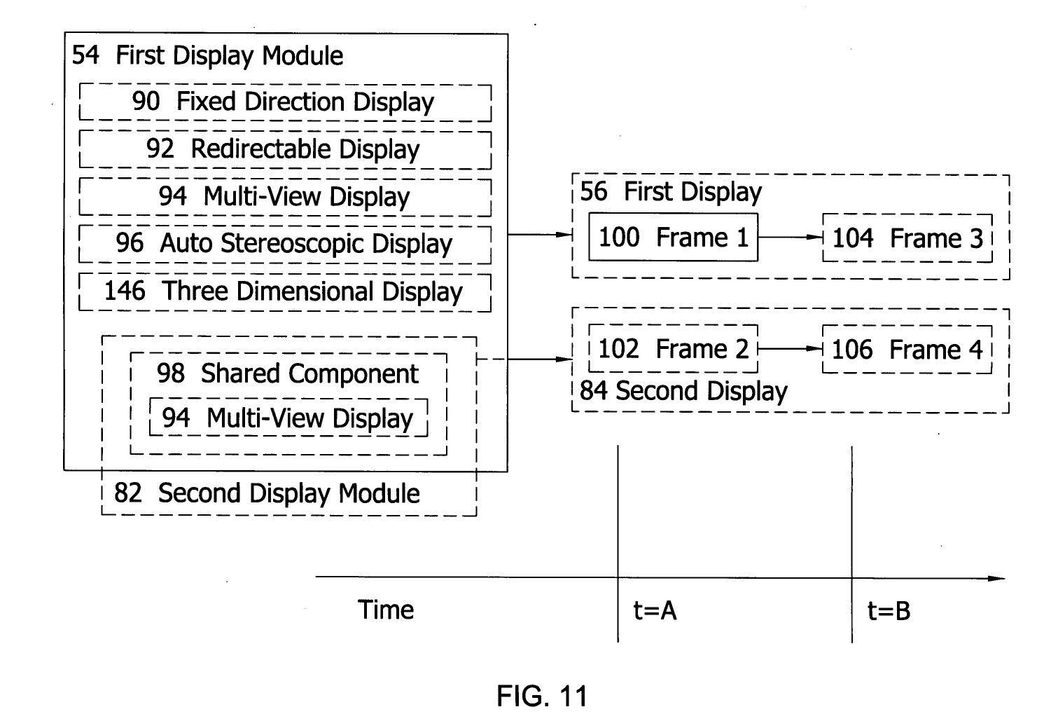

Referring now to FIG. 11, the first display module 54 or the second display module 82 may include one or more of a fixed direction display 90 or a redirectable display 92. Alternatively, the first display module 54 or the second display module 82 may include one or more of a multi-view display 94, an autostereoscopic display 96, or a three-dimensional display 146. In embodiments, a three-dimensional display 146 may include a holographic display or one or more tangible objects in an arrangement visible to the first individual 52. For example, the display may include a holographic image of a coat. Alternatively, the display may include one or more coats on a rack which is rotated to give the first individual 52 a thorough view of the coat. It is contemplated that the three-dimensional display 146 may be specific to an individual (e.g., a first article of clothing displayed for a first individual may be rotated out in favor of a second article of clothing for a second individual).

Additionally, the first display module 54 and the second display module 82 may include a shared component 98. The shared component 98 may include the multi-view display 94. In an embodiment, the multi-view display 94 may include one or more of a lenticular lens assembly, one or more polarization filters, one or more LCD filters, or like hardware for providing different images to the first individual 52 and the second individual 80. For instance, the first display 56 and the second display 84 may include alternate frames displayable by the multi-view display 94. The provision of the first display 56 to the first individual 52 may overlap in time with the provision of the second display 84 to the second individual 80 (e.g., a first frame 100 may be provided to the first individual 52 at a time t=A, while a second frame 102 may be provided to the second individual 80 at substantially the same time t=A; similarly, a third frame 104 may be provided to the first individual 52 at a time t=B, while a fourth frame 106 may be provided to the second individual 80 at substantially the same time t=B; and so forth).

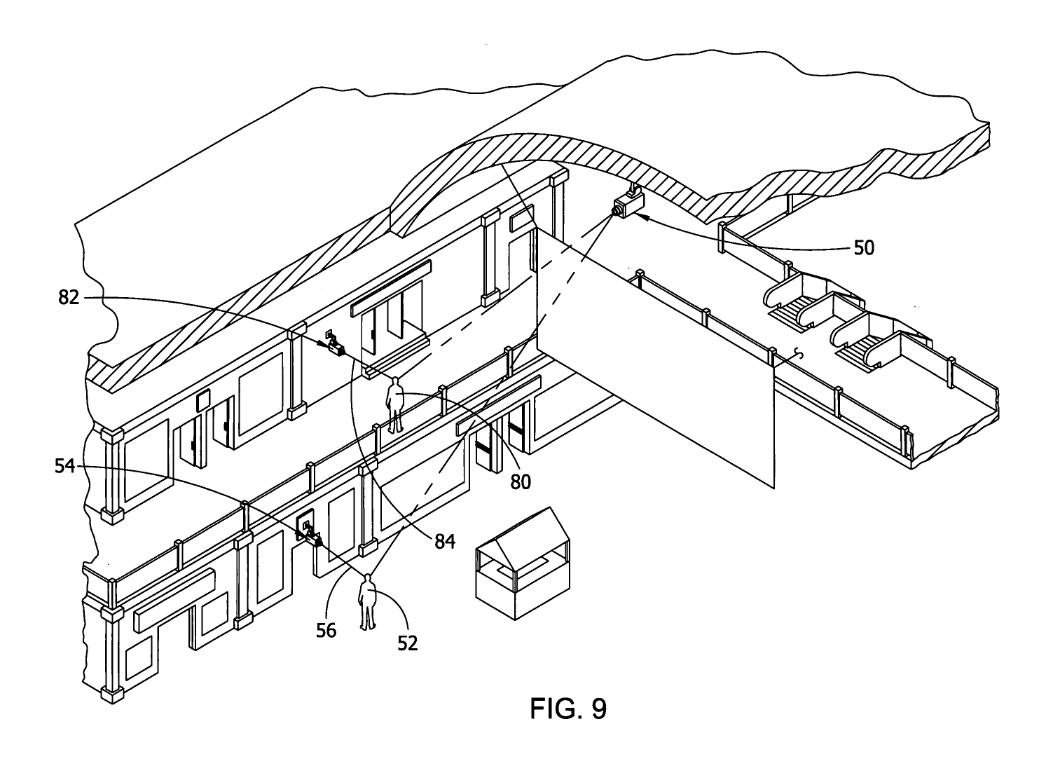

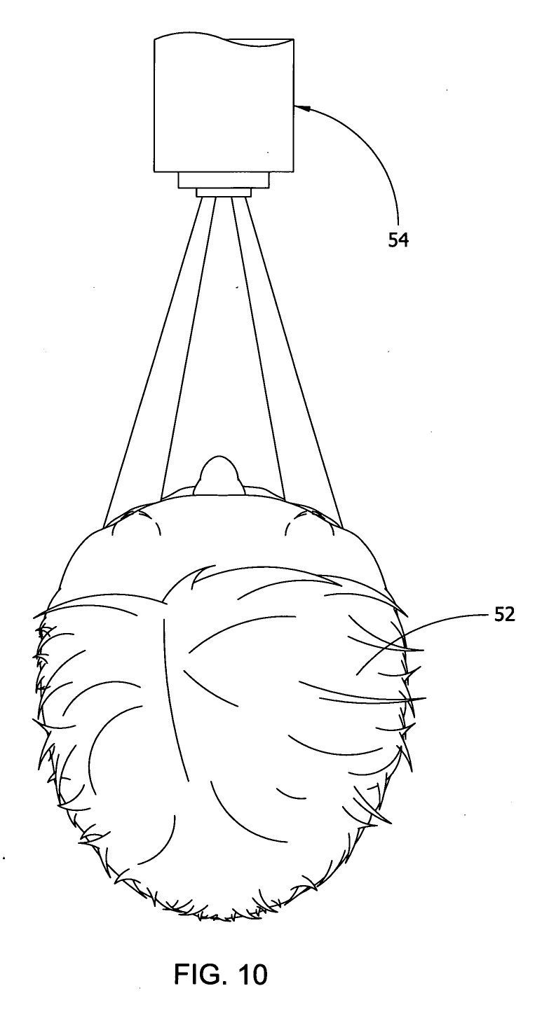

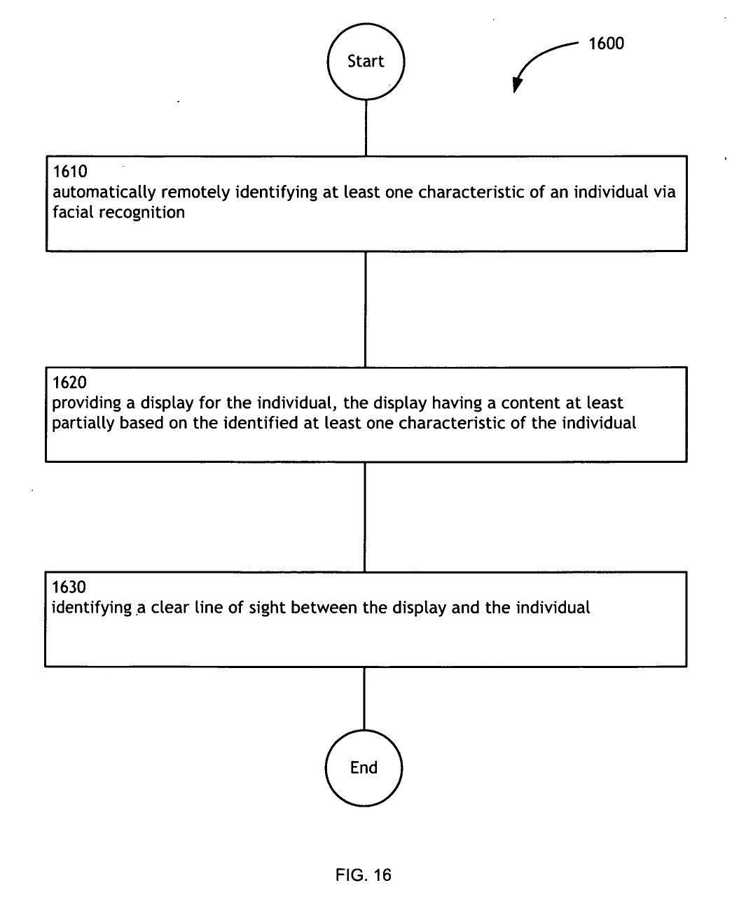

FIG. 16 illustrates an operational flow 1600 representing example operations related to automatically remotely identifying one or more characteristics of an individual utilizing facial recognition, providing a display for the individual having a content at least partially based on the one or more identified characteristics of the individual, and identifying a clear line of sight between the display and the individual. It should be understood that designations of “start” or “end” in operational flow diagrams herein are not to be construed in a limiting fashion. Such designations are not determinative but are provided as reference points. The illustrated and described processes or methods may be included with other processes or methods that include other steps or features. Nothing herein is intended to convey that no other operations can be performed either or both prior to or following the operations depicted in the figures. In FIG. 16 and in following figures that include various examples of operational flows, discussion and explanation may be provided with respect to the above-described examples of FIGS. 1 through 15, and/or with respect to other examples and contexts. However, it should be understood that the operational flows may be executed in a number of other environments and contexts, and/or in modified versions of FIGS. 1 through 15. Also, although the various operational flows are presented in the sequence(s) illustrated, it should be understood that the various operations may be performed in other orders than those which are illustrated, or may be performed concurrently.

After a start operation, the operational flow 1600 moves to an operation 1610. Operation 1610 depicts automatically remotely identifying at least one characteristic of an individual via facial recognition. For example, as shown in FIGS. 1 through 15, the facial recognition module 50 may include a computer application for identifying a characteristic of the first individual 52 via facial recognition. In an embodiment, the computer application may utilize one or more captured images of the individual to identify the facial characteristic.

Then, operation 1620 depicts providing a display for the individual, the display having a content at least partially based on the identified at least one characteristic of the individual. For example, as shown in FIGS. 1 through 15, the first display module 54 may be utilized to provide a first display 56 for the first individual 52, where the first display 56 has a content at least partially based on the one or more identified characteristics of the first individual 52. Then, operation 1630 depicts identifying a clear line of sight between the display and the individual. For example, as shown in FIGS. 1 through 15, the first display module 54 may utilize various techniques to identify a clear line of sight to the first individual 52.

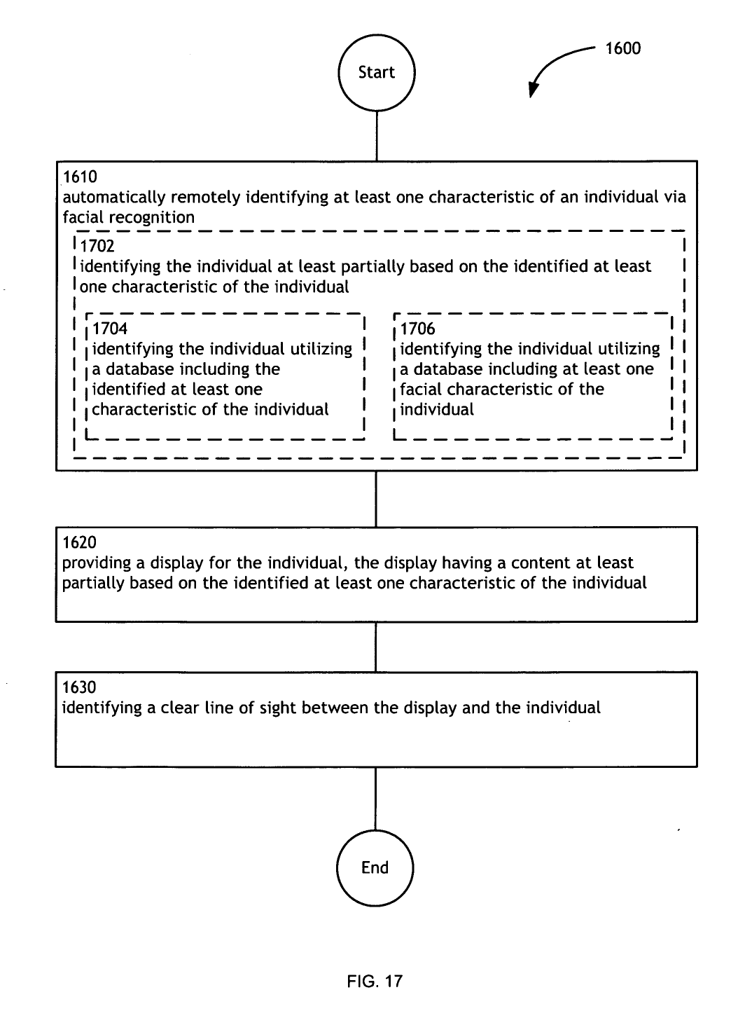

FIG. 17 illustrates alternative embodiments of the example operational flow 1600 of FIG. 16. FIG. 17 illustrates example embodiments where the operation 1610 may include at least one additional operation. Additional operations may include an operation 1702, an operation 1704, and/or an operation 1706.

The operation 1702 illustrates identifying the individual at least partially based on the identified at least one characteristic of the individual. For example, as shown in FIGS. 1 through 15, the facial recognition module 50 may be utilized to automatically remotely identify one or more characteristics of the first individual 52. In an embodiment, the facial recognition module 50 may include a computer application for automatically identifying a person utilizing a digital image, a video frame, or another captured image. For instance, the facial recognition module 50 may identify one or more distinguishable landmarks on a person's face pictured in a captured image, and use the landmarks to compile one or more identified characteristics of the individual (e.g., a distance between a person's eyes, or a width of a person's nose). The facial recognition module 50 may compare the one or more identified characteristics to characteristics of individuals in a database including facial characteristics for a number of different individuals. Utilizing the database and the one or more identified characteristics, the facial recognition module 50 may identify a specific individual. The identity of this specific individual may then be associated with the first individual 52. Further, the operation 1704 illustrates identifying the individual utilizing a database including the identified at least one characteristic of the individual. For example, as shown in FIGS. 1 through 15, the facial recognition module 50 may include a memory 122 including a database 108. The database 108 may include identifiable characteristics for a number of different individuals. For instance, an identifiable characteristic may include a height of an individual. Further, the operation 1706 illustrates identifying the individual utilizing a database including at least one facial characteristic of the individual. For example, as shown in FIGS. 1 through 15, the memory 122 of the facial recognition module 50 may include identifiable facial characteristics for a number of different individuals.

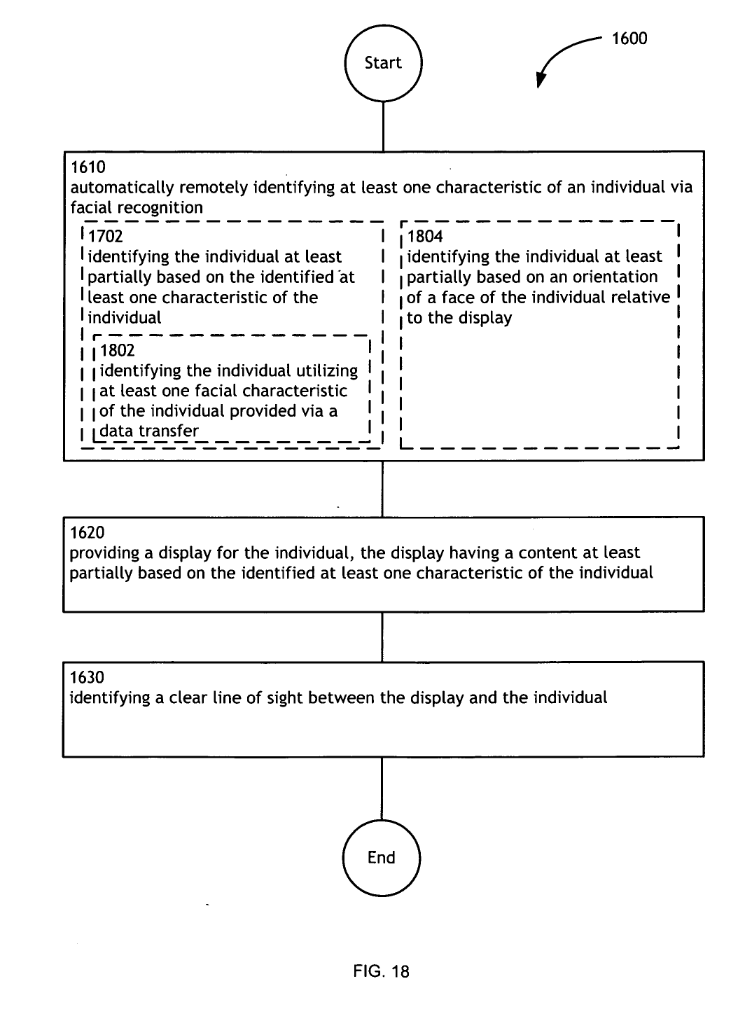

FIG. 18 illustrates alternative embodiments of the example operational flow 1600 of FIG. 16. FIG. 18 illustrates example embodiments where the operation 1610 may include at least one additional operation. Additional operations may include an operation 1802, and/or an operation 1804. Further, the operation 1802 illustrates identifying the individual utilizing at least one facial characteristic of the individual provided via a data transfer. For example, as shown in FIGS. 1 through 15, the data (e.g., facial characteristic data) may be provided to the facial recognition module 50 via a data transfer module 138.

The operation 1804 illustrates identifying the individual at least partially based on an orientation of a face of the individual relative to the display. For example, as shown in FIGS. 1 through 15, the facial recognition module 50 may utilize one or more facial recognition algorithms to identify an orientation of the face of the first individual 52 relative to the first display 56, and then utilize the orientation of the first individual's face to identify the first individual 52. For instance, the orientation of the first individual's face may be utilized to adjust a measured distance between two or more facial landmarks (e.g., to account for the distance being something other than what would be measured when the individual is directly facing an image capture device).

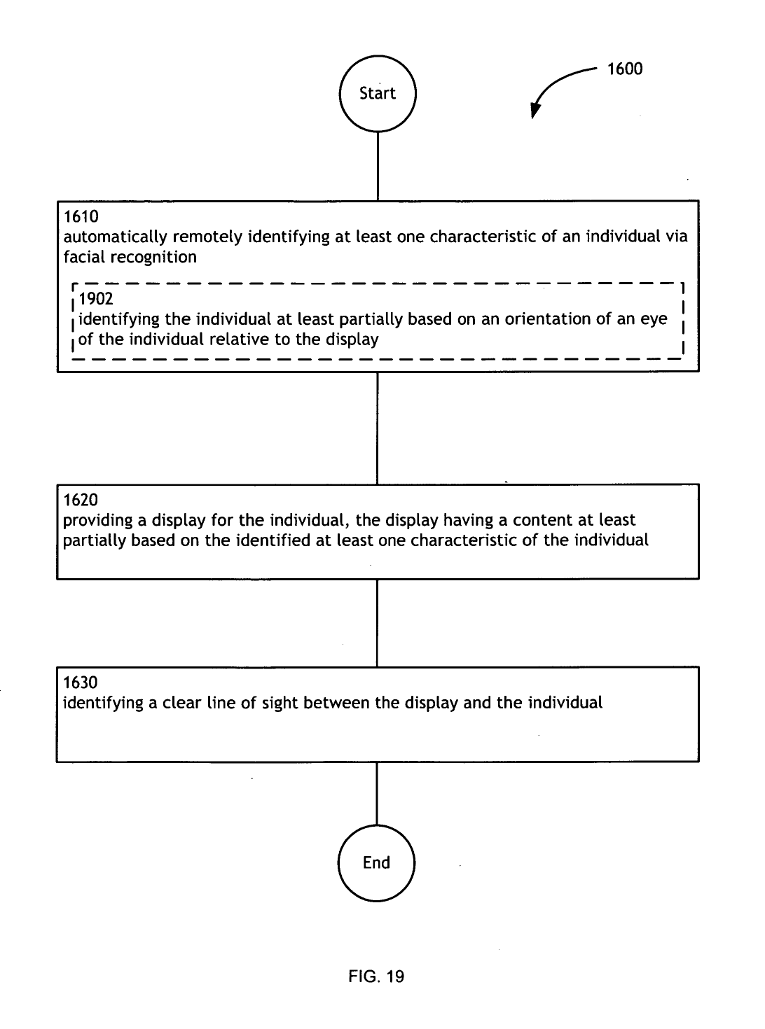

FIG. 19 illustrates alternative embodiments of the example operational flow 1600 of FIG. 16. FIG. 19 illustrates example embodiments where the operation 1610 may include at least one additional operation. Additional operations may include an operation 1902.

The operation 1902 illustrates identifying the individual at least partially based on an orientation of an eye of the individual relative to the display. For example, as shown in FIGS. 1 through 15, the facial recognition module 50 may utilize one or more facial recognition algorithms to identify an orientation of an eye of the first individual 52 relative to the first display 56 to identify the first individual 52. For instance, the orientation of the first individual's eye may be utilized to adjust a measured distance between another facial landmark and the eye of the first individual 52. Alternatively, the orientation of the first individual's eye may be utilized to adjust a measured distance between two other facial landmarks.

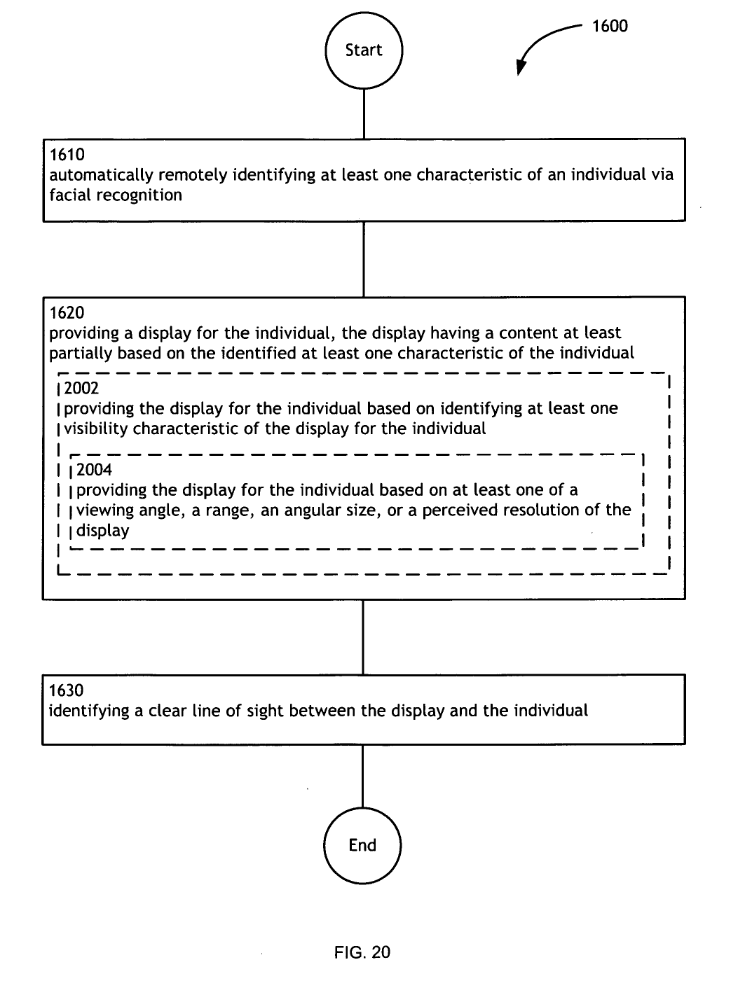

FIG. 20 illustrates alternative embodiments of the example operational flow 1600 of FIG. 16. FIG. 20 illustrates example embodiments where the operation 1620 may include at least one additional operation. Additional operations may include an operation 2002, and/or an operation 2004.

The operation 2002 illustrates providing the display for the individual based on identifying at least one visibility characteristic of the display for the individual. For example, as shown in FIGS. 1 through 15, the first display module 54 may be utilized to provide a first display 56 for the first individual 52 at least partially based on one or more identified visibility characteristics of the first display 56 for the first individual 52. Further, the operation 2004 illustrates providing the display for the individual based on at least one of a viewing angle, a range, an angular size, or a perceived resolution of the display. For example, as shown in FIGS. 1 through 15, the visibility characteristics of the first display 56 for the first individual 52 may include a viewing angle 42, a range 44, an angular size 46, or a perceived resolution of the display 48.

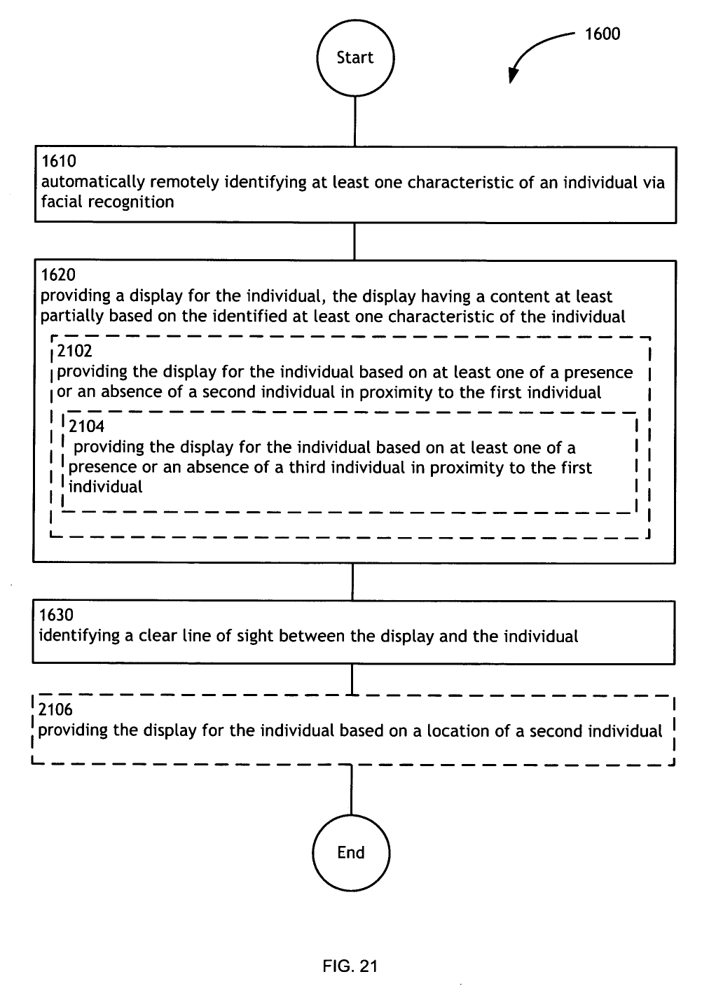

FIG. 21 illustrates alternative embodiments of the example operational flow 1600 of FIG. 16. FIG. 21 illustrates example embodiments where the operation 1620 may include at least one additional operation. FIG. 21 illustrates an example embodiment where the example operational flow 1600 of FIG. 16 may include at least one additional operation. Additional operations may include an operation 2102, an operation 2104, and/or an operation 2106.

The operation 2102 illustrates providing the display for the individual based on at least one of a presence or an absence of a second individual in proximity to the first individual. For example, as shown in FIGS. 1 through 15, the first display module may provide the first display 56 or the content of the first display 56 to the first individual 52 based on a change in the status of the first individual 52. A change in the status of the individual may include a change in one or more of the presence or the absence of one or more of a second individual 80 or a third individual 86 in proximity to the first individual 52. Further, the operation 2104 illustrates providing the display for the individual based on at least one of a presence or an absence of a third individual in proximity to the first individual. For example, as shown in FIGS. 1 through 15, the first display module may provide the first display 56 or the content of the first display 56 to the first individual 52 based on the presence or the absence of the third individual 86 in proximity to the first individual 52.

The operation 2106 illustrates providing the display for the individual based on a location of a second individual. For example, as shown in FIGS. 1 through 15, the first display module may provide the first display 56 or the content of the first display 56 to the first individual 52 based on the location of a second individual.

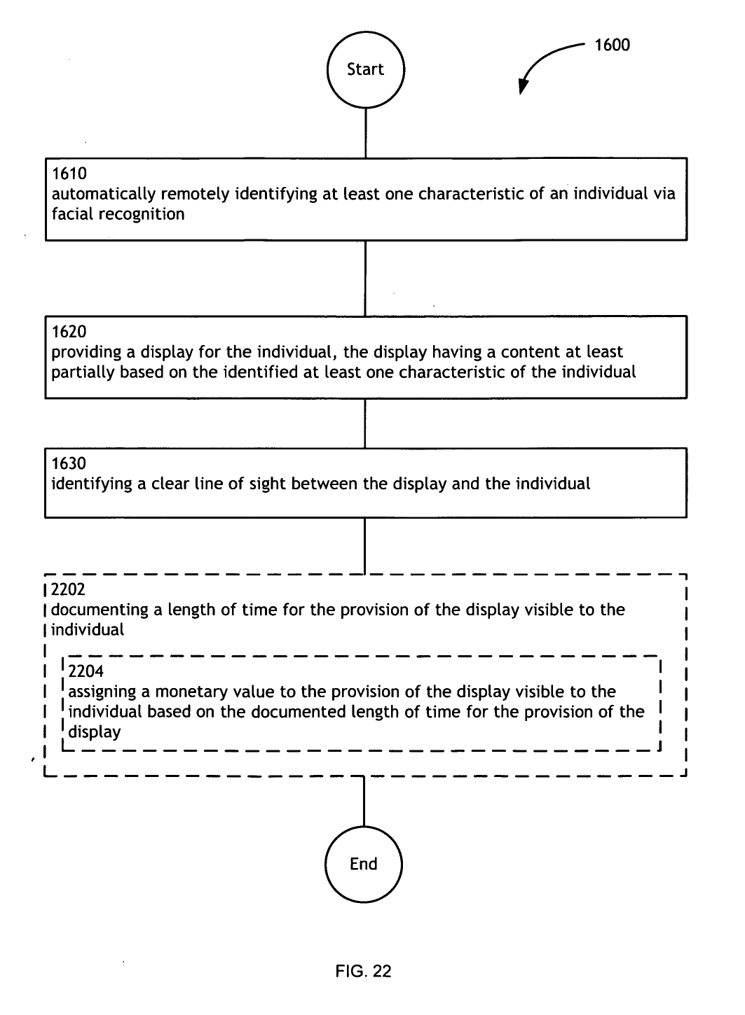

FIG. 22 illustrates alternative embodiments of the example operational flow 1600 of FIG. 16. FIG. 22 illustrates example embodiments where the example operational flow 1600 of FIG. 16 may include at least one additional operation. Additional operations may include an operation 2202, and/or an operation 2204.

The operation 2202 illustrates documenting a length of time for the provision of the display visible to the individual. For example, as shown in FIGS. 1 through 15, the first display module 54 may document the length of time the first display 56 is provided to the first individual 52. Further, the operation 2204 illustrates assigning a monetary value to the provision of the display visible to the individual based on the documented length of time for the provision of the display. For example, as shown in FIGS. 1 through 15, the first display module 54 may assign a monetary value to the first display based on the length of time the first display 56 is provided to the first individual 52.

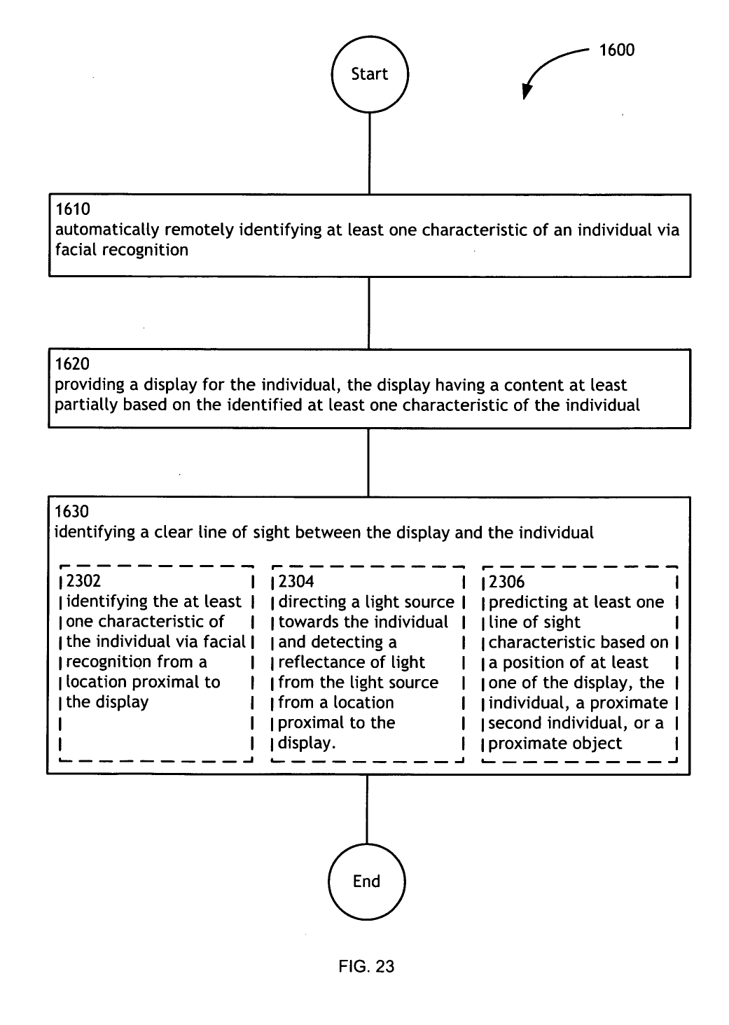

FIG. 23 illustrates alternative embodiments of the example operational flow 1600 of FIG. 16. FIG. 23 illustrates example embodiments where the operation 1630 may include at least one additional operation. Additional operations may include an operation 2302, an operation 2304, and/or an operation 2306.

The operation 2302 illustrates identifying the at least one characteristic of the individual via facial recognition from a location proximal to the display. For example, as shown in FIGS. 1 through 15, the facial recognition module 50 may identify one or more characteristics of the first individual 52 from a location proximal to the first display 56.

The operation 2304 illustrates directing a light source towards the individual and detecting a reflectance of light from the light source from a location proximal to the display. For example, as shown in FIGS. 1 through 15, the light source 26 may be directed towards the first individual 52, and a reflectance of light from the light source 26 to a location proximal to the first display 56 may be detected.

The operation 2306 illustrates predicting at least one line of sight characteristic based on a position of at least one of the display, the individual, a proximate second individual, or a proximate object. For example, as shown in FIGS. 1 through 15, the position of one or more of the first display 56, the first individual 52, a proximate second individual 80, or a proximate object 26 may be utilized for predicting one or more line of sight characteristics.

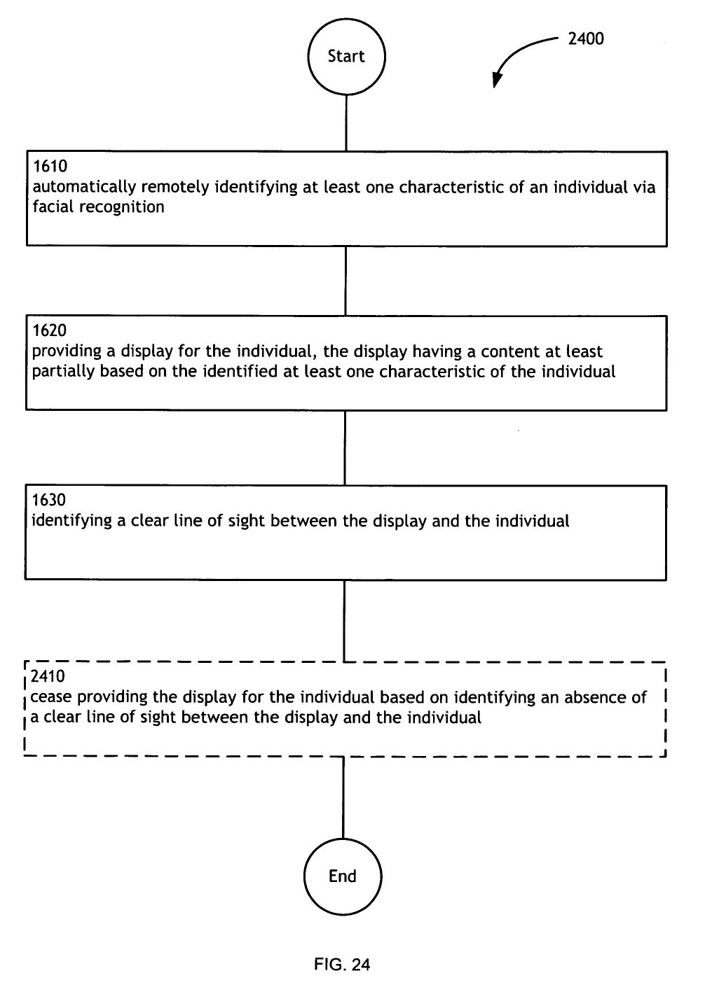

FIG. 24 illustrates an operational flow 2400 representing example operations related to automatically remotely identifying one or more characteristics of an individual utilizing facial recognition, providing a display for the individual having a content at least partially based on the one or more characteristics of the individual, identifying a clear line of sight between the display and the individual, and ceasing providing a display for the individual. FIG. 24 illustrates an example embodiment where the example operational flow 1600 of FIG. 16 may include at least one additional operation. Additional operations may include an operation 2410.

After a start operation, an operation 1610, an operation 1620, and an operation 1630, the operational flow 2400 moves to an operation 2410. Operation 2410 illustrates cease providing the display for the individual based on identifying an absence of a clear line of sight between the display and the individual. For example, as shown in FIGS. 1 through 15, the first display module 54 may cease providing the first display 56 or the content of the first display 56 to the first individual 52 based on identifying an absence of a clear line of sight between the first display 56 and the first individual 52

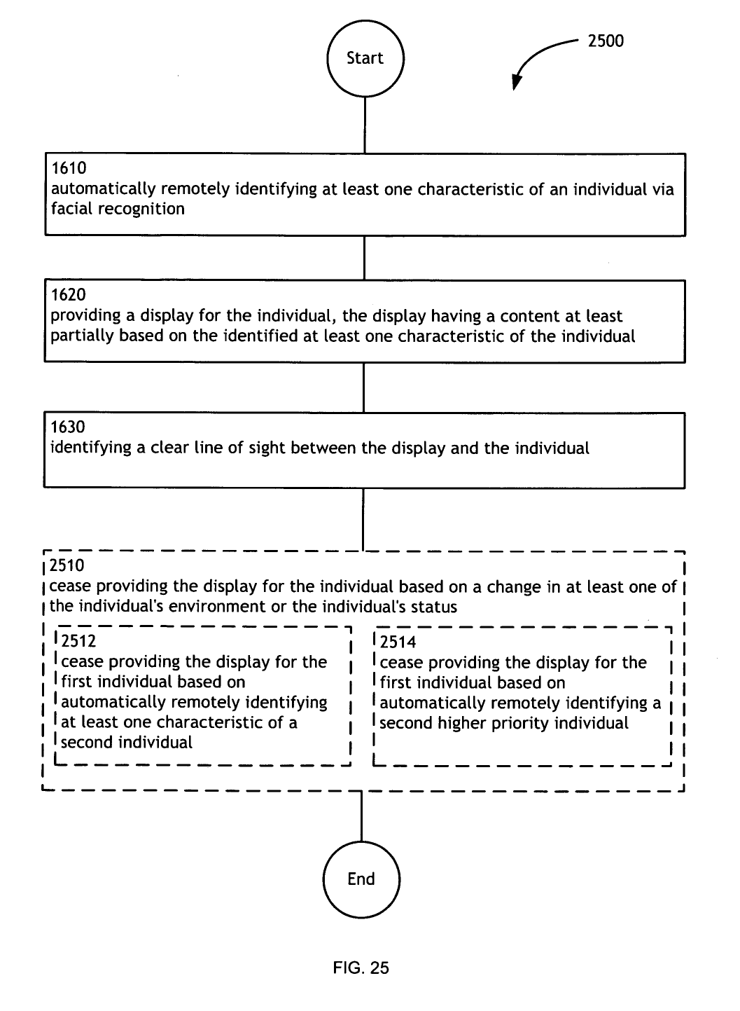

FIG. 25 illustrates an operational flow 2500 representing example operations related to automatically remotely identifying one or more characteristics of an individual utilizing facial recognition, providing a display for the individual having a content at least partially based on the one or more characteristics of the individual, identifying a clear line of sight between the display and the individual, and ceasing providing a display for the individual. FIG. 25 illustrates an example embodiment where the example operational flow 1600 of FIG. 16 may include at least one additional operation. Additional operations may include an operation 2510, an operation 2512, and/or an operation 2514.

After a start operation, an operation 1610, an operation 1620, and an operation 1630, the operational flow 2500 moves to an operation 2510. Operation 2510 illustrates cease providing the display for the individual based on a change in at least one of the individual's environment or the individual's status. For example, as shown in FIGS. 1 through 15, the first display module 54 may cease providing the first display 56 or the content of the first display 56 to the first individual 52 based on one or more of a change in the individual's environment or a change in the status of the first individual 52.

The operation 2512 illustrates cease providing the display for the first individual based on automatically remotely identifying at least one characteristic of a second individual. For example, as shown in FIGS. 1 through 15, the first display module 54 may cease providing the first display 56 to the first individual 52 based on automatically remotely identifying one or more characteristics of a second individual 80.

The operation 2514 illustrates cease providing the display for the first individual based on automatically remotely identifying a second higher priority individual. For example, as shown in FIGS. 1 through 15, the first display module 54 may cease providing the first display 56 to the first individual 52 based on automatically remotely identifying a second individual 80. The second individual 80 may be a higher priority individual (according to any user-specified criteria) than the first individual 52.

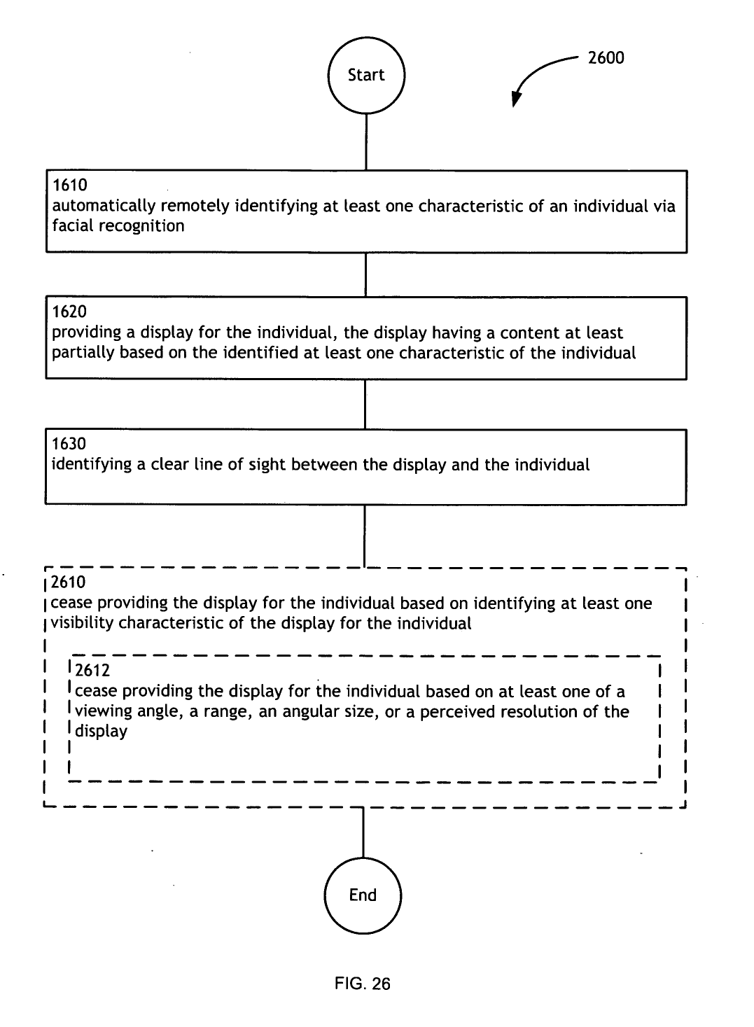

FIG. 26 illustrates an operational flow 2600 representing example operations related to automatically remotely identifying one or more characteristics of an individual utilizing facial recognition, providing a display for the individual having a content at least partially based on the one or more characteristics of the individual, identifying a clear line of sight between the display and the individual, and ceasing providing a display for the individual. FIG. 26 illustrates an example embodiment where the example operational flow 1600 of FIG. 16 may include at least one additional operation. Additional operations may include an operation 2610, and/or an operation 2612.

After a start operation, an operation 1610, an operation 1620, and an operation 1630, the operational flow 2600 moves to an operation 2610. Operation 2610 illustrates cease providing the display for the individual based on identifying at least one visibility characteristic of the display for the individual. For example, as shown in FIGS. 1 through 15, the first display module 54 may be utilized to cease providing a first display 56 for the first individual 52 at least partially based on one or more identified visibility characteristics 40 of the first display 56 for the first individual 52.

The operation 2612 illustrates cease providing the display for the individual based on at least one of a viewing angle, a range, an angular size, or a perceived resolution of the display. For example, as shown in FIGS. 1 through 15, the visibility characteristics 40 of the first display 56 for the first individual 52 may include a viewing angle 42, a range 44, an angular size 46, or a perceived resolution of the display 48.

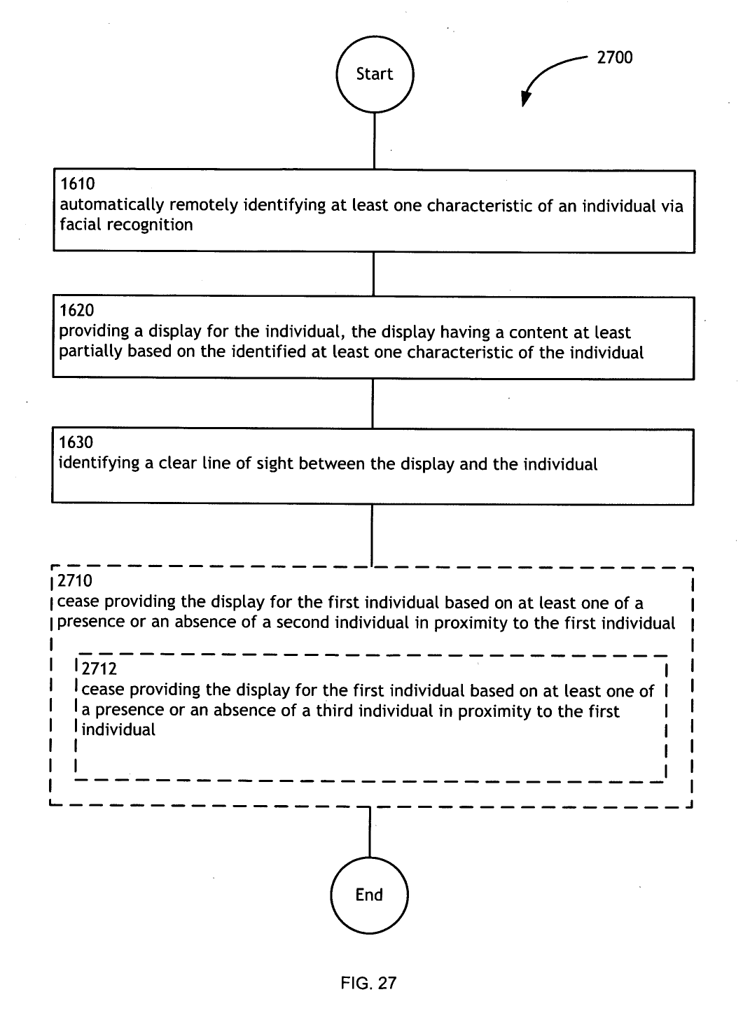

FIG. 27 illustrates an operational flow 2700 representing example operations related to automatically remotely identifying one or more characteristics of an individual utilizing facial recognition, providing a display for the individual having a content at least partially based on the one or more characteristics of the individual, identifying a clear line of sight between the display and the individual, and ceasing providing a display for the individual. FIG. 27 illustrates an example embodiment where the example operational flow 1600 of FIG. 16 may include at least one additional operation. Additional operations may include an operation 2710, and/or an operation 2712.

After a start operation, an operation 1610, an operation 1620, and an operation 1630, the operational flow 2700 moves to an operation 2710. Operation 2710 illustrates cease providing the display for the first individual based on at least one of a presence or an absence of a second individual in proximity to the first individual. For example, as shown in FIGS. 1 through 15, the first display module 54 may cease providing the first display 56 or the content of the first display 56 to the first individual 52 based on a presence or an absence of the second individual 80.

The operation 2712 illustrates cease providing the display for the first individual based on at least one of a presence or an absence of a third individual in proximity to the first individual. For example, as shown in FIGS. 1 through 15, the first display module 54 may cease providing the first display 56 or the content of the first display 56 to the first individual 52 based on the presence or the absence of the third individual 86 in proximity to the first individual 52.

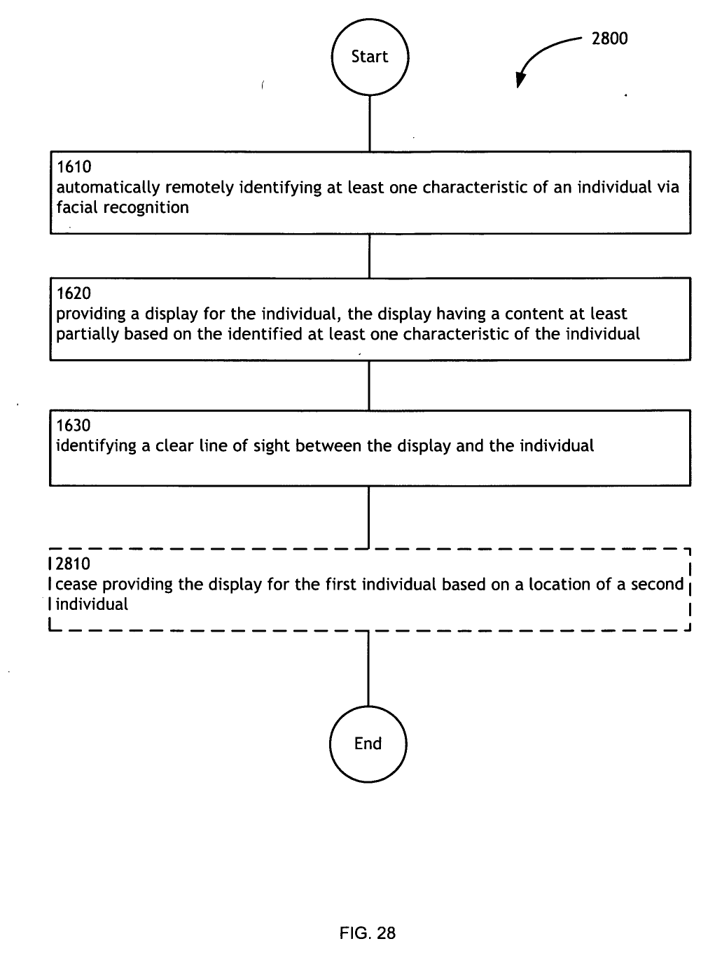

FIG. 28 illustrates an operational flow 2800 representing example operations related to automatically remotely identifying one or more characteristics of an individual utilizing facial recognition, providing a display for the individual having a content at least partially based on the one or more characteristics of the individual, identifying a clear line of sight between the display and the individual, and ceasing providing a display for the individual. FIG. 28 illustrates an example embodiment where the example operational flow 1600 of FIG. 16 may include at least one additional operation. Additional operations may include an operation 2810.

After a start operation, an operation 1610, an operation 1620, and an operation 1630, the operational flow 2800 moves to an operation 2810.

Operation 2810 illustrates cease providing the display for the first individual based on a location of a second individual. For example, as shown in FIGS. 1 through 15, the first display module 54 may cease providing the first display 56 or the content of the first display 56 to the first individual 52 based on the location of the second individual 80.

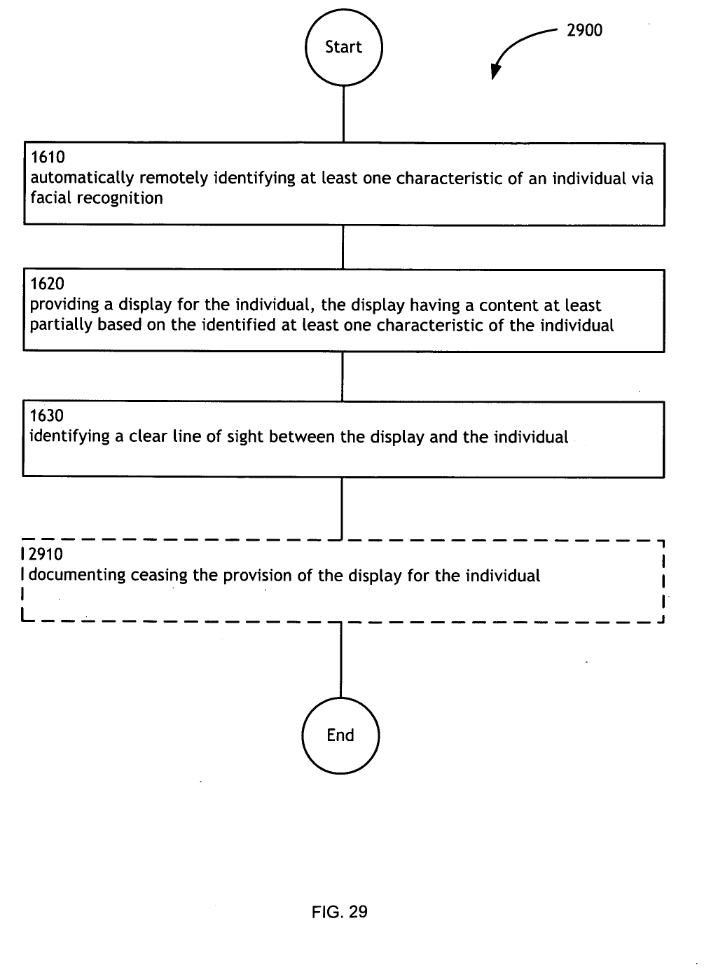

FIG. 29 illustrates an operational flow 2900 representing example operations related to automatically remotely identifying one or more characteristics of an individual utilizing facial recognition, providing a display for the individual having a content at least partially based on the one or more characteristics of the individual, identifying a clear line of sight between the display and the individual, and ceasing providing a display for the individual. FIG. 29 illustrates an example embodiment where the example operational flow 1600 of FIG. 16 may include at least one additional operation. Additional operations may include an operation 2910.

After a start operation, an operation 1610, an operation 1620, and an operation 1630, the operational flow 2900 moves to an operation 2910. Operation 2910 illustrates documenting ceasing the provision of the display for the individual. For example, as shown in FIGS. 1 through 15, the ceasing the provision of the first display 56 for the first individual 52 may be documented.

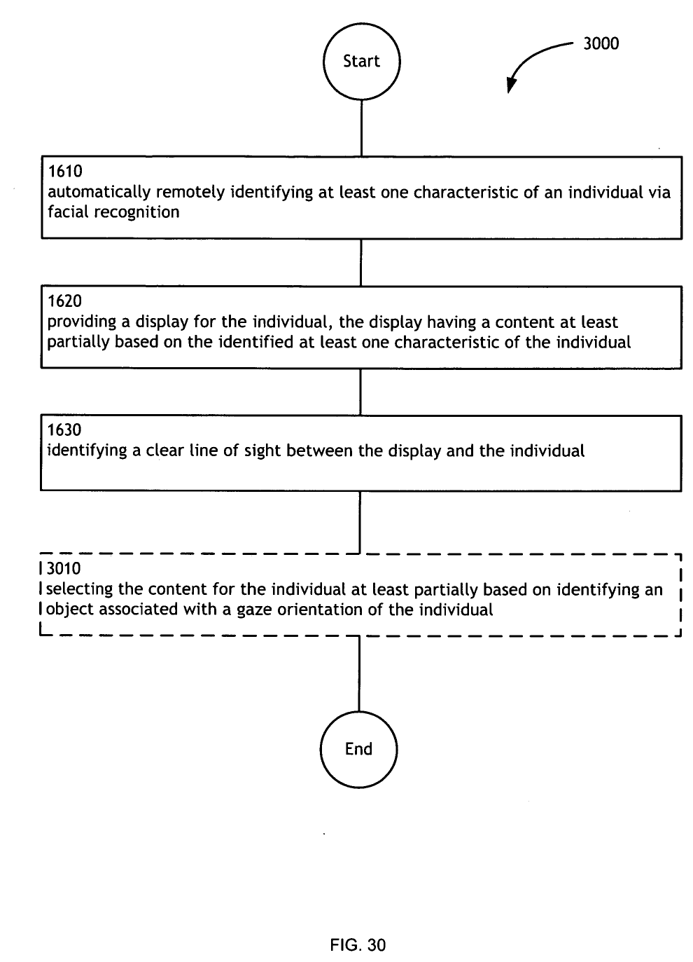

FIG. 30 illustrates an operational flow 3000 representing example operations related to automatically remotely identifying one or more characteristics of an individual utilizing facial recognition, providing a display for the individual having a content at least partially based on the one or more characteristics of the individual, identifying a clear line of sight between the display and the individual, and selecting the content for the display. FIG. 30 illustrates an example embodiment where the example operational flow 1600 of FIG. 16 may include at least one additional operation. Additional operations may include an operation 3010.

After a start operation, an operation 1610, an operation 1620, and an operation 1630, the operational flow 3000 moves to an operation 3010. Operation 3010 illustrates selecting the content for the individual at least partially based on identifying an object associated with a gaze orientation of the individual. For example, as shown in FIGS. 1 through 15, the content selected for the first individual 52 may be selected based on an action of the individual 62. The action of the individual 62 may include a gaze orientation 64. Gaze orientation 64 may include, for instance, glancing at an item but not moving towards it.

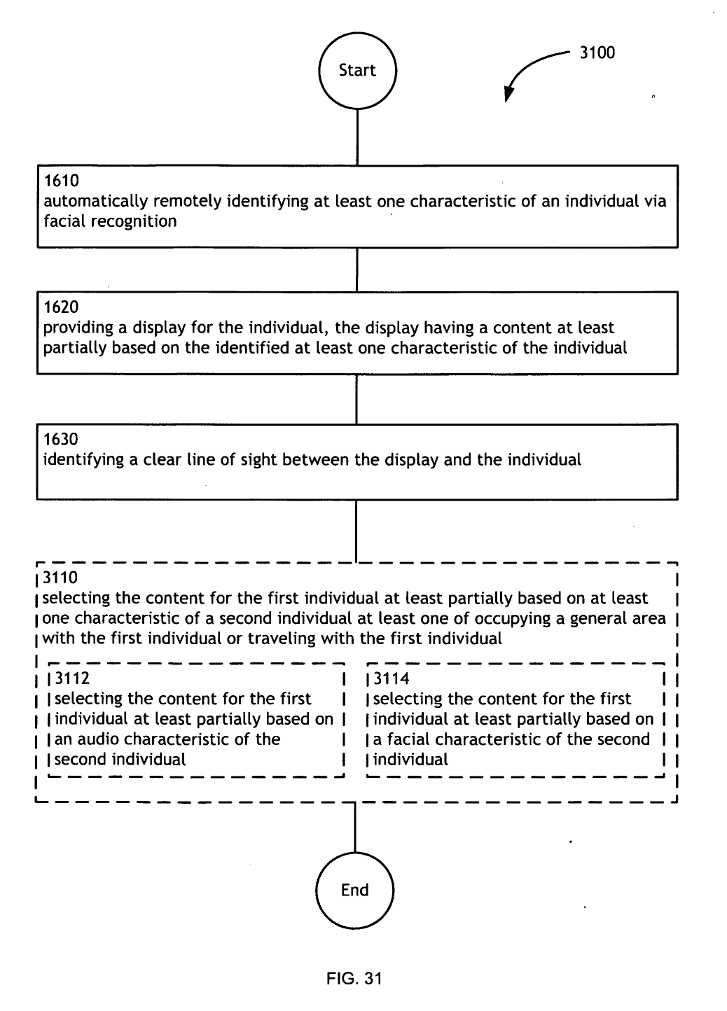

FIG. 31 illustrates an operational flow 3100 representing example operations related to automatically remotely identifying one or more characteristics of an individual utilizing facial recognition, providing a display for the individual having a content at least partially based on the one or more characteristics of the individual, identifying a clear line of sight between the display and the individual, and selecting the content for the display. FIG. 31 illustrates an example embodiment where the example operational flow 1600 of FIG. 16 may include at least one additional operation. Additional operations may include an operation 3110, an operation 3112, and/or an operation 3114.

After a start operation, an operation 1610, an operation 1620, and an operation 1630, the operational flow 3100 moves to an operation 3110. Operation 3110 illustrates selecting the content for the first individual at least partially based on at least one characteristic of a second individual at least one of occupying a general area with the first individual or traveling with the first individual. For example, as shown in FIGS. 1 through 15, the content of the first display may be targeted to the first individual 52 based on characteristics of one or more other individuals who share some type of relationship with (e.g., a spatial relationship) or connection (e.g., a social connection) to the first individual 52. The content of the first display 56 for the first individual 52 may be selected at least partially based on a characteristic (e.g., a facial characteristic, an audio characteristic, or an identity) of the second individual 80. In embodiments, the second individual 80 may occupy a general area in proximity with the first individual 52. In addition, the second individual 80 may be traveling with the first individual 52.

The operation 3112 illustrates selecting the content for the first individual at least partially based on an audio characteristic of the second individual. For example, as shown in FIGS. 1 through 15, the content of the first display 56 for the first individual 52 may be selected at least partially based on an audio characteristic of the second individual 80.

The operation 3114 illustrates selecting the content for the first individual at least partially based on a facial characteristic of the second individual. For example, as shown in FIGS. 1 through 15, the content of the first display 56 for the first individual 52 may be selected at least partially based on a facial characteristic of the second individual 80.

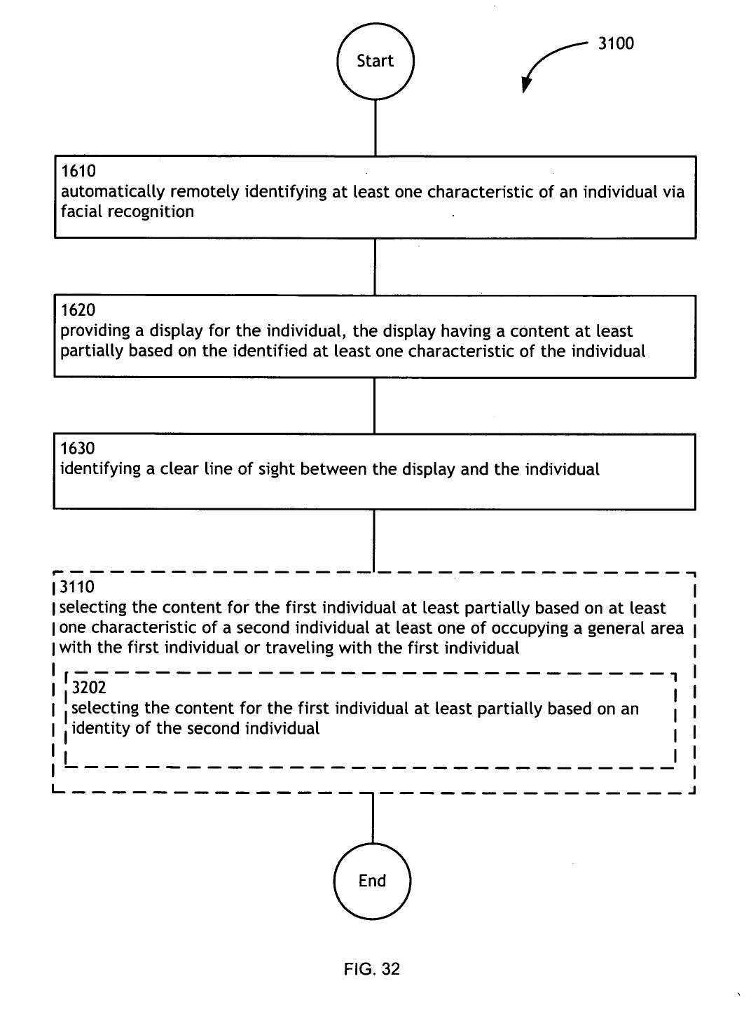

FIG. 32 illustrates alternative embodiments of the example operational flow 3100 of FIG. 31. FIG. 32 illustrates example embodiments where the operation 3110 may include at least one additional operation. Additional operations may include an operation 3202.

The operation 3202 illustrates selecting the content for the first individual at least partially based on an identity of the second individual. For example, as shown in FIGS. 1 through 15, the content of the first display 56 for the first individual 52 may be selected at least partially based on an identity of the second individual 80. For example, the facial recognition module 50 may be utilized to identify the second individual 80.

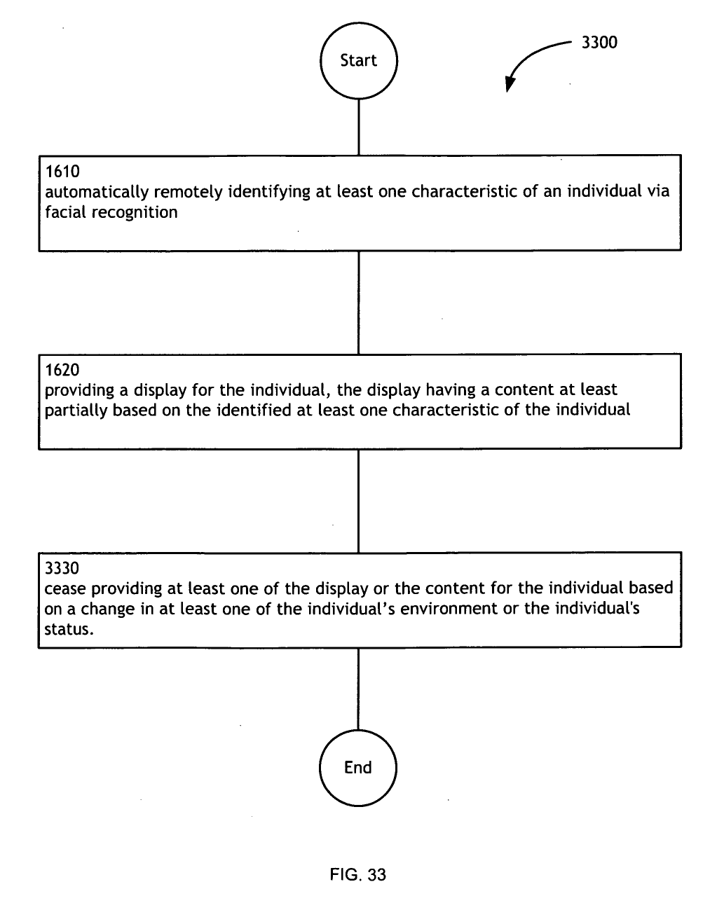

FIG. 33 illustrates an operational flow 3300 representing example operations related to automatically remotely identifying one or more characteristics of an individual utilizing facial recognition, providing a display for the individual having a content at least partially based on the one or more characteristics of the individual, and ceasing providing at least one of the display or the content for the individual. In FIG. 33 and in following figures that include various examples of operational flows, discussion and explanation may be provided with respect to the above-described examples of FIGS. 1 through 15, and/or with respect to other examples and contexts. However, it should be understood that the operational flows may be executed in a number of other environments and contexts, and/or in modified versions of FIGS. 1 through 15. Also, although the various operational flows are presented in the sequence(s) illustrated, it should be understood that the various operations may be performed in other orders than those which are illustrated, or may be performed concurrently.

After a start operation, the operational flow 3300 moves to an operation 1610. Operation 1610 depicts automatically remotely identifying at least one characteristic of an individual via facial recognition.

Then, operation 1620 depicts providing a display for the individual, the display having a content at least partially based on the identified at least one characteristic of the individual.

Then, operation 3330 depicts cease providing at least one of the display or the content for the individual based on a change in at least one of the individual's environment or the individual's status. For example, as shown in FIGS. 1 through 15, the first display module 54 may cease providing the first display 56 or the content of the first display 56 to the first individual 52 based on one or more of a change in the individual's environment or a change in the status of the first individual 52 (e.g., when the first individual 52 moves from a first region 58 where the first display 56 is visible to the first individual 52 to a second region 60 where the first display 56 is not visible to the first individual 52).

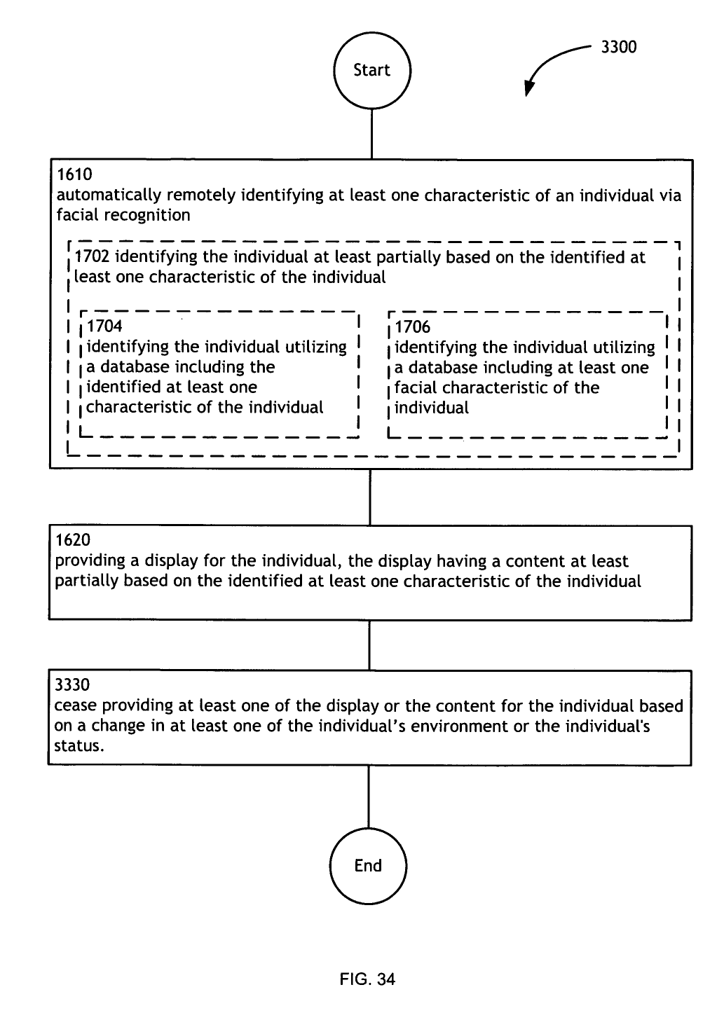

FIG. 34 illustrates alternative embodiments of the example operational flow 3300 of FIG. 33. FIG. 34 illustrates example embodiments where the operation 1610 may include at least one additional operation. Additional operations may include an operation 1702, an operation 3404, and/or an operation 3406.

The operation 1702 illustrates identifying the individual at least partially based on the identified at least one characteristic of the individual. Further, the operation 1704 illustrates identifying the individual utilizing a database including the identified at least one characteristic of the individual. Further, the operation 1706 illustrates identifying the individual utilizing a database including at least one facial characteristic of the individual.

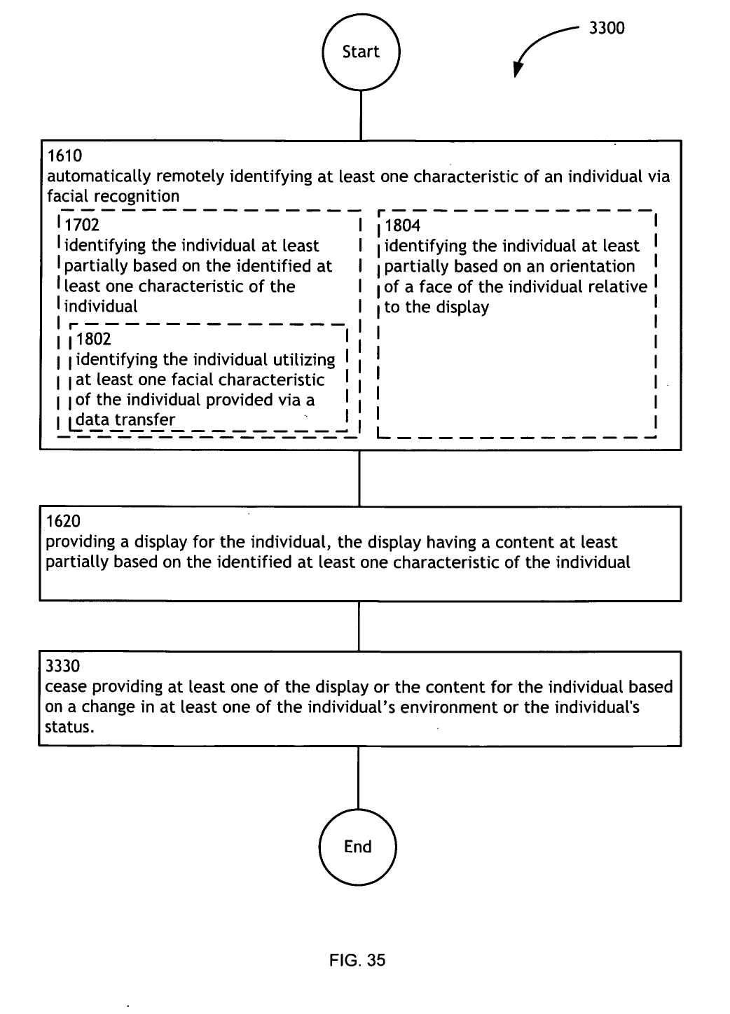

FIG. 35 illustrates alternative embodiments of the example operational flow 3300 of FIG. 33. FIG. 35 illustrates example embodiments where the operation 1610 may include at least one additional operation. Additional operations may include an operation 1802, and/or an operation 1804. Further, the operation 1802 illustrates identifying the individual utilizing at least one facial characteristic of the individual provided via a data transfer.

The operation 1804 illustrates identifying the individual at least partially based on an orientation of a face of the individual relative to the display.

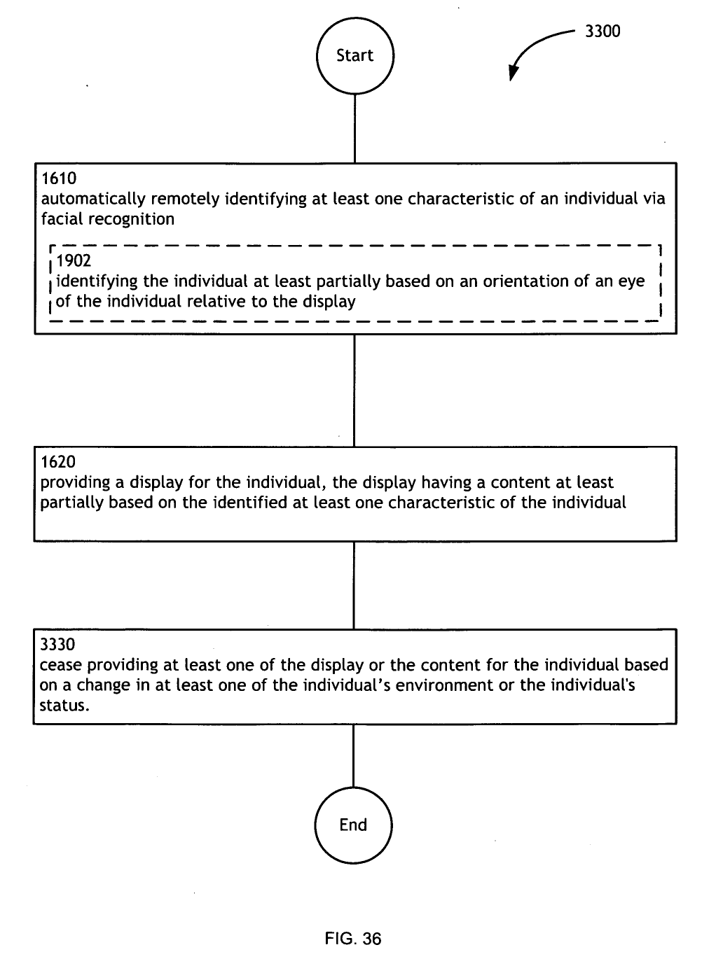

FIG. 36 illustrates alternative embodiments of the example operational flow 3300 of FIG. 33. FIG. 36 illustrates example embodiments where the operation 1610 may include at least one additional operation. Additional operations may include an operation 1902.

The operation 1902 illustrates identifying the individual at least partially based on an orientation of an eye of the individual relative to the display.

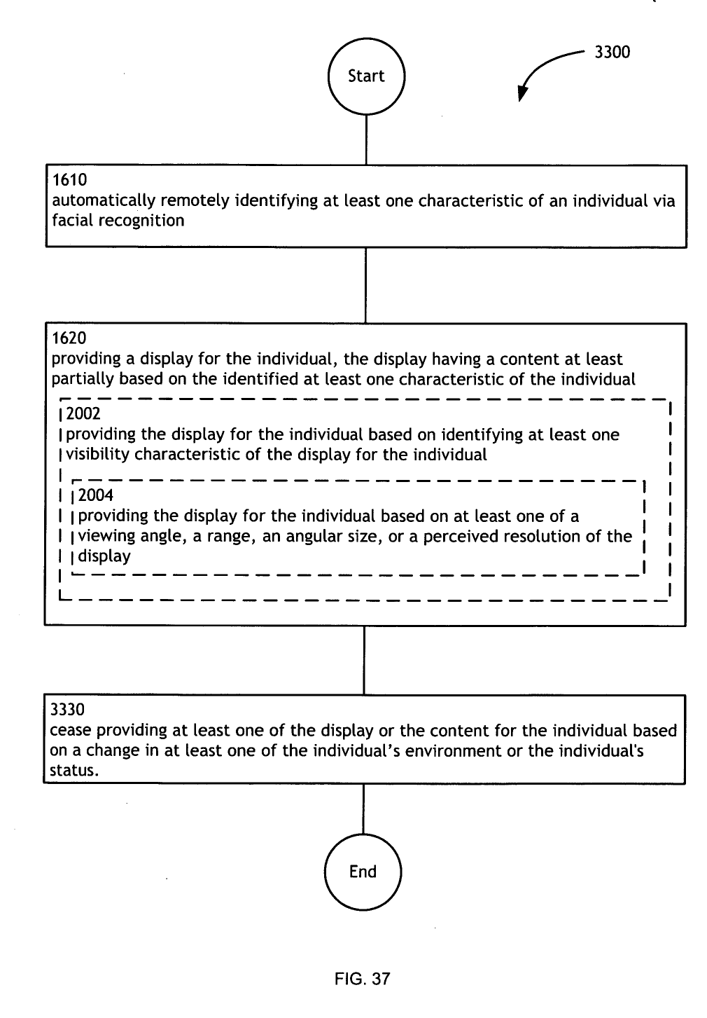

FIG. 37 illustrates alternative embodiments of the example operational flow 3300 of FIG. 33. FIG. 37 illustrates example embodiments where the operation 1620 may include at least one additional operation. Additional operations may include an operation 2002, and/or an operation 2004.

The operation 2002 illustrates providing the display for the individual based on identifying at least one visibility characteristic of the display for the individual. Further, the operation 2004 illustrates providing the display for the individual based on at least one of a viewing angle, a range, an angular size, or a perceived resolution of the display.

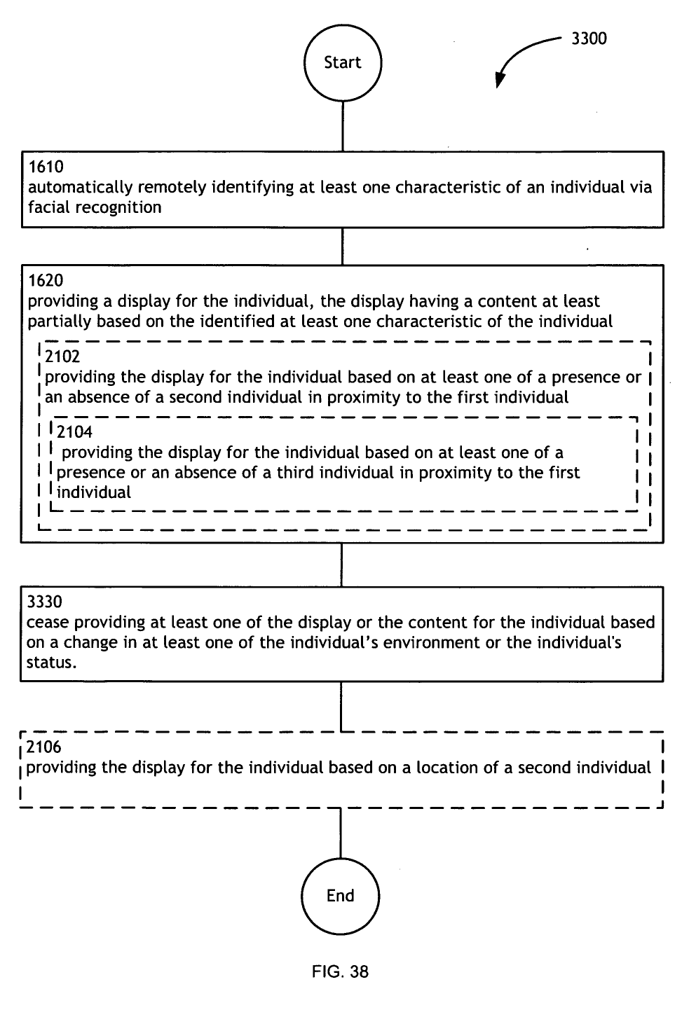

FIG. 38 illustrates alternative embodiments of the example operational flow 3300 of FIG. 33. FIG. 38 illustrates example embodiments where the operation 1620 may include at least one additional operation. FIG. 38 illustrates an example embodiment where the example operational flow 3300 of FIG. 33 may include at least one additional operation. Additional operations may include an operation 2102, an operation 2104, and/or an operation 2106.

The operation 2102 illustrates providing the display for the individual based on at least one of a presence or an absence of a second individual in proximity to the first individual. Further, the operation 2104 illustrates providing the display for the individual based on at least one of a presence or an absence of a third individual in proximity to the first individual.

The operation 2106 illustrates providing the display for the individual based on a location of a second individual.

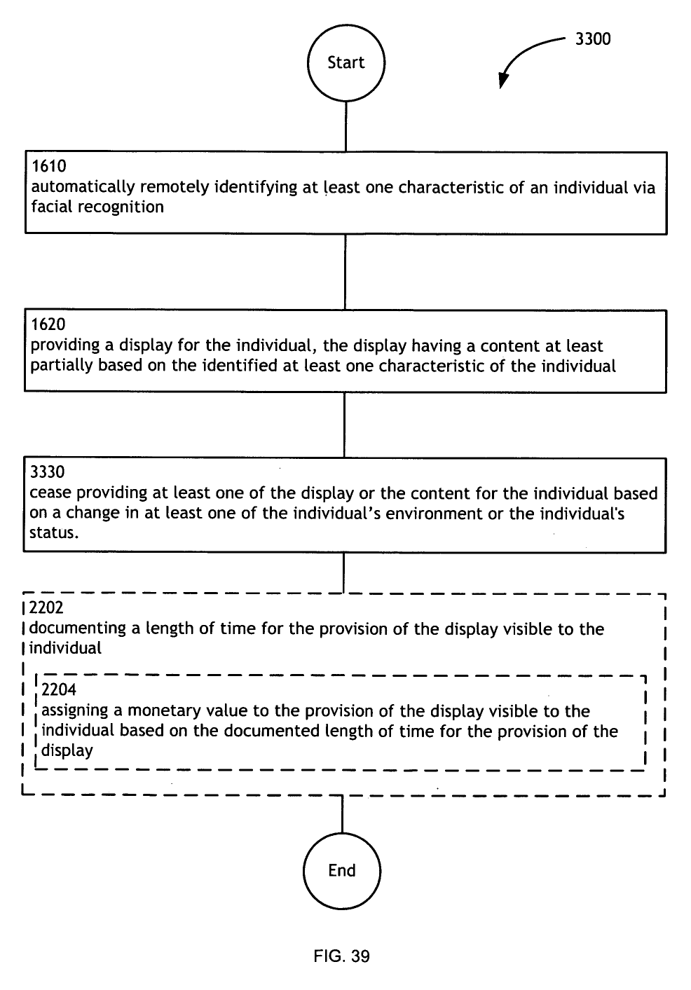

FIG. 39 illustrates alternative embodiments of the example operational flow 3300 of FIG. 33. FIG. 39 illustrates example embodiments where the example operational flow 3300 of FIG. 33 may include at least one additional operation. Additional operations may include an operation 2202, and/or an operation 2204.

The operation 2202 illustrates documenting a length of time for the provision of the display visible to the individual. Further, the operation 2204 illustrates assigning a monetary value to the provision of the display visible to the individual based on the documented length of time for the provision of the display.

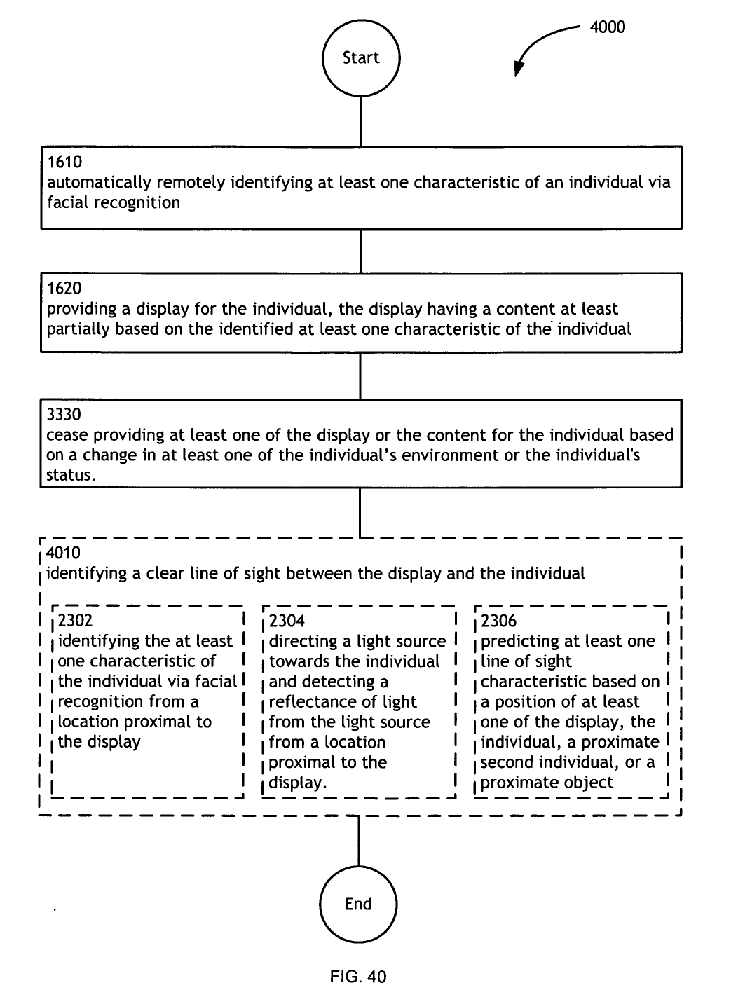

FIG. 40 illustrates an operational flow 4000 representing example operations related to automatically remotely identifying one or more characteristics of an individual utilizing facial recognition, providing a display for the individual having a content at least partially based on the one or more characteristics of the individual, ceasing providing at least one of the display or the content for the individual, and identifying a clear line of sight between the display and the individual. FIG. 40 illustrates an example embodiment where the example operational flow 3300 of FIG. 33 may include at least one additional operation. Additional operations may include an operation 4010, an operation 2302, an operation 2304, and/or an operation 2306.

After a start operation, an operation 1610, an operation 1620, and an operation 3330, the operational flow 4000 moves to an operation 4010. Operation 4010 illustrates identifying a clear line of sight between the display and the individual. For example, as shown in FIGS. 1 through 15, the first display module 54 may utilize various techniques to identify a clear line of sight to the first individual 52.

The operation 2302 illustrates identifying the at least one characteristic of the individual via facial recognition from a location proximal to the display.

The operation 2304 illustrates directing a light source towards the individual and detecting a reflectance of light from the light source from a location proximal to the display.

The operation 2306 illustrates predicting at least one line of sight characteristic based on a position of at least one of the display, the individual, a proximate second individual, or a proximate object.

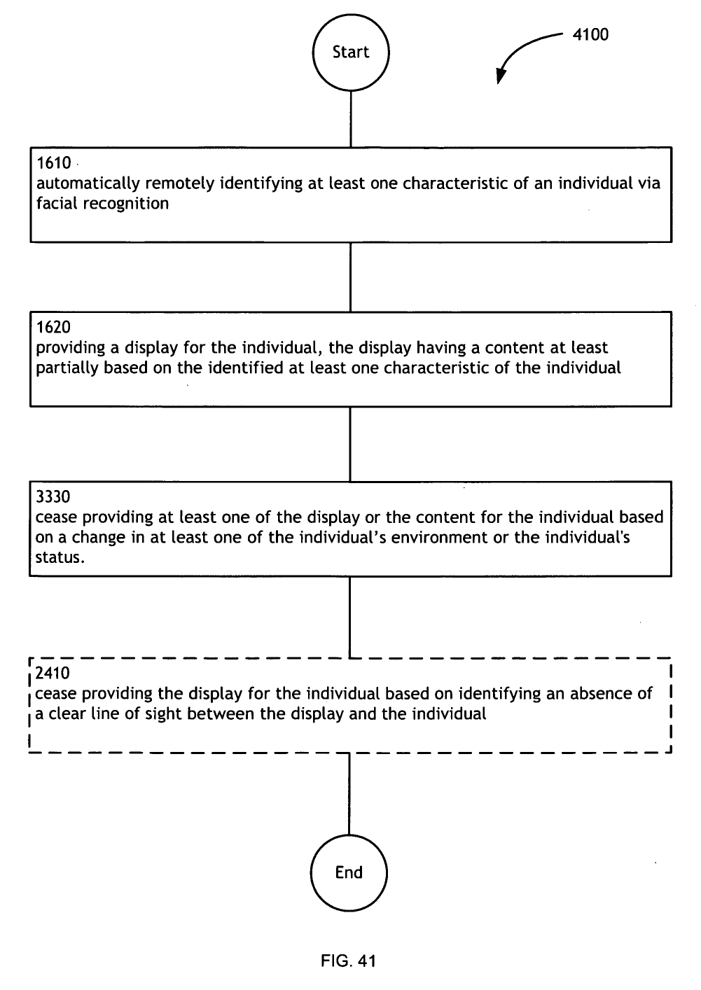

FIG. 41 illustrates an operational flow 4100 representing example operations related to automatically remotely identifying one or more characteristics of an individual utilizing facial recognition, providing a display for the individual having a content at least partially based on the one or more characteristics of the individual, ceasing providing at least one of the display or the content for the individual, and identifying a clear line of sight between the display and the individual. FIG. 41 illustrates an example embodiment where the example operational flow 3300 of FIG. 33 may include at least one additional operation. Additional operations may include an operation 2410.

After a start operation, an operation 1610, an operation 1620, and an operation 3330, the operational flow 4100 moves to an operation 2410. Operation 2410 illustrates cease providing the display for the individual based on identifying an absence of a clear line of sight between the display and the individual.

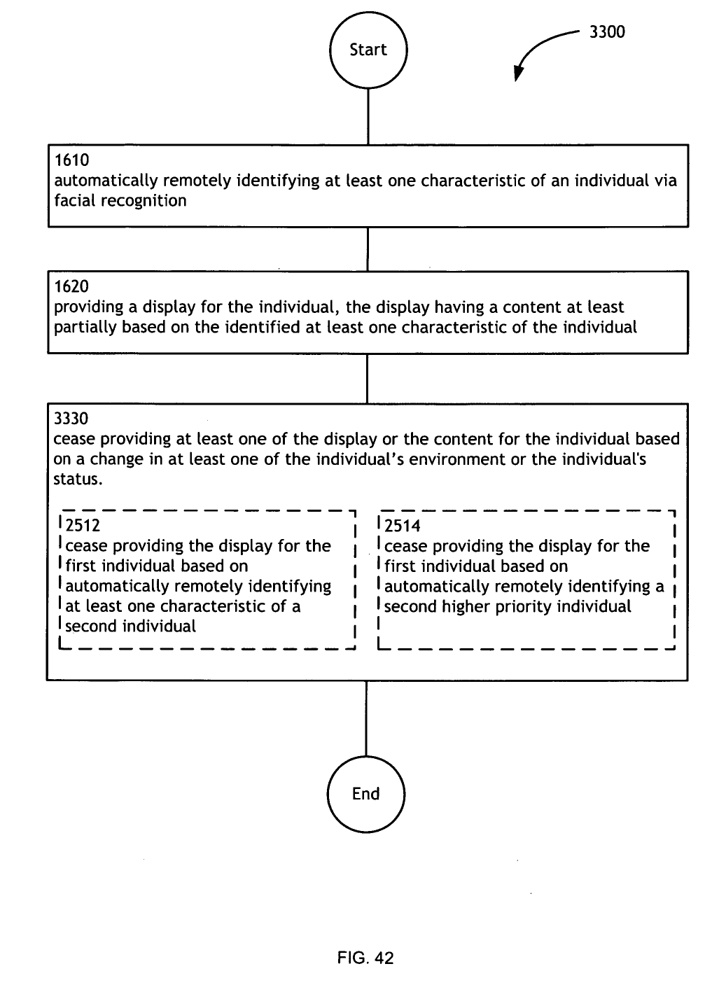

FIG. 42 illustrates alternative embodiments of the example operational flow 3300 of FIG. 33. FIG. 42 illustrates example embodiments where the operation 3330 may include at least one additional operation. Additional operations may include an operation 2512, and/or an operation 2514.

The operation 2512 illustrates cease providing the display for the first individual based on automatically remotely identifying at least one characteristic of a second individual.

The operation 2514 illustrates cease providing the display for the first individual based on automatically remotely identifying a second higher priority individual.

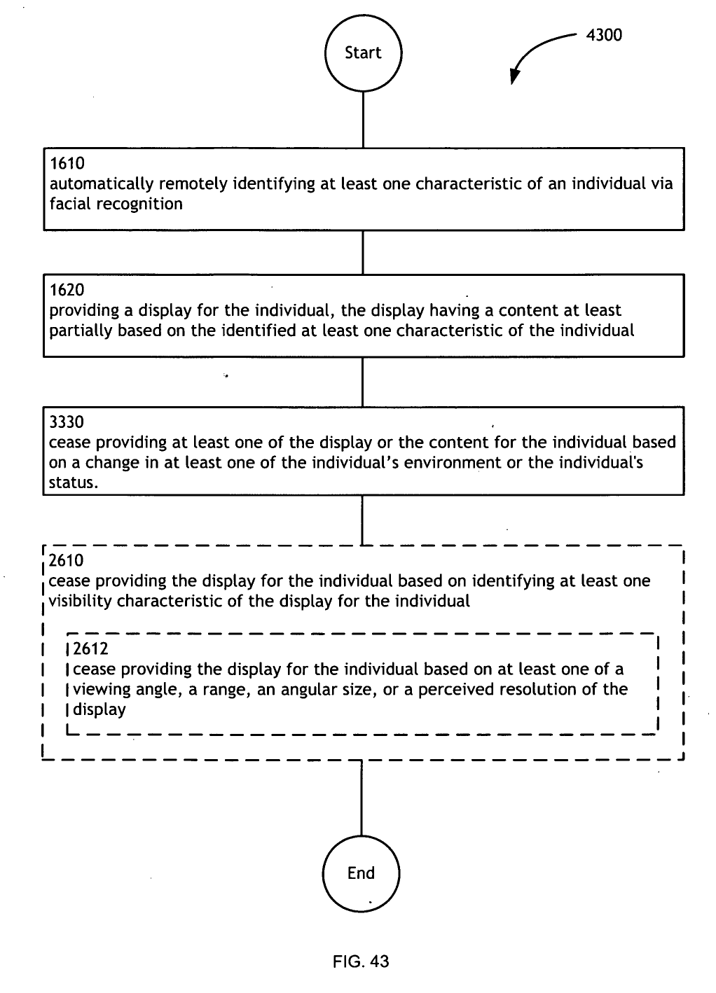

FIG. 43 illustrates an operational flow 4300 representing example operations related to automatically remotely identifying one or more characteristics of an individual utilizing facial recognition, providing a display for the individual having a content at least partially based on the one or more characteristics of the individual, and ceasing providing at least one of the display or the content for the individual. FIG. 43 illustrates an example embodiment where the example operational flow 3300 of FIG. 33 may include at least one additional operation. Additional operations may include an operation 2610, and/or an operation 2612.

After a start operation, an operation 1610, an operation 1620, and an operation 3330, the operational flow 4300 moves to an operation 2610. Operation 2610 illustrates cease providing the display for the individual based on identifying at least one visibility characteristic of the display for the individual.

The operation 2612 illustrates cease providing the display for the individual based on at least one of a viewing angle, a range, an angular size, or a perceived resolution of the display.

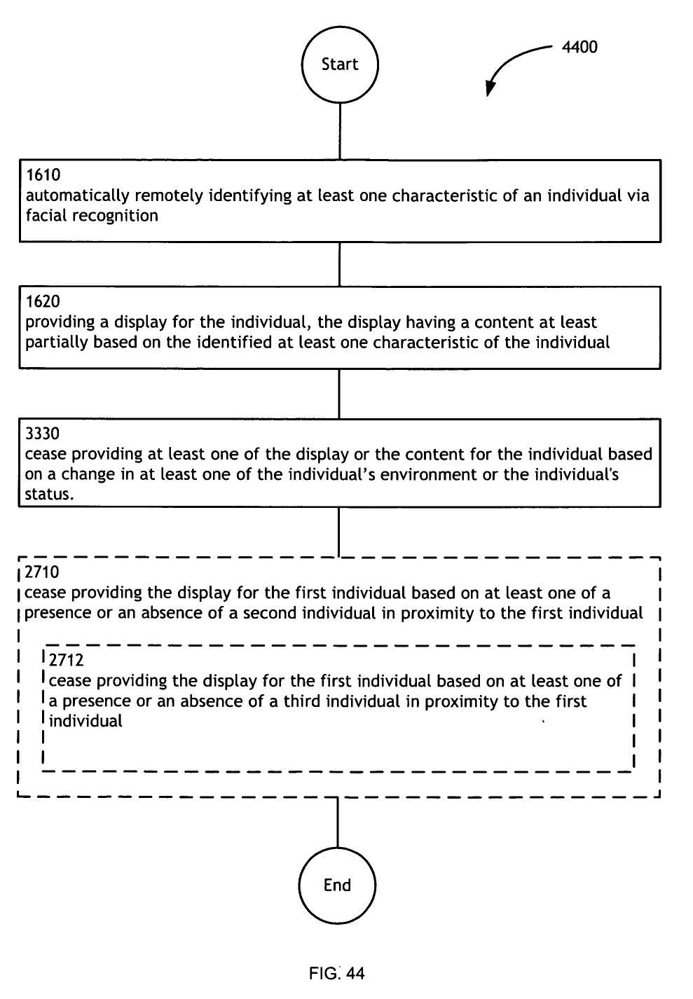

FIG. 44 illustrates an operational flow 4400 representing example operations related to automatically remotely identifying one or more characteristics of an individual utilizing facial recognition, providing a display for the individual having a content at least partially based on the one or more characteristics of the individual, and ceasing providing at least one of the display or the content for the individual. FIG. 44 illustrates an example embodiment where the example operational flow 3300 of FIG. 33 may include at least one additional operation. Additional operations may include an operation 2710, and/or an operation 2712.

After a start operation, an operation 1610, an operation 1620, and an operation 3330, the operational flow 4400 moves to an operation 2710. Operation 2710 illustrates cease providing the display for the first individual based on at least one of a presence or an absence of a second individual in proximity to the first individual.

The operation 2712 illustrates cease providing the display for the first individual based on at least one of a presence or an absence of a third individual in proximity to the first individual.

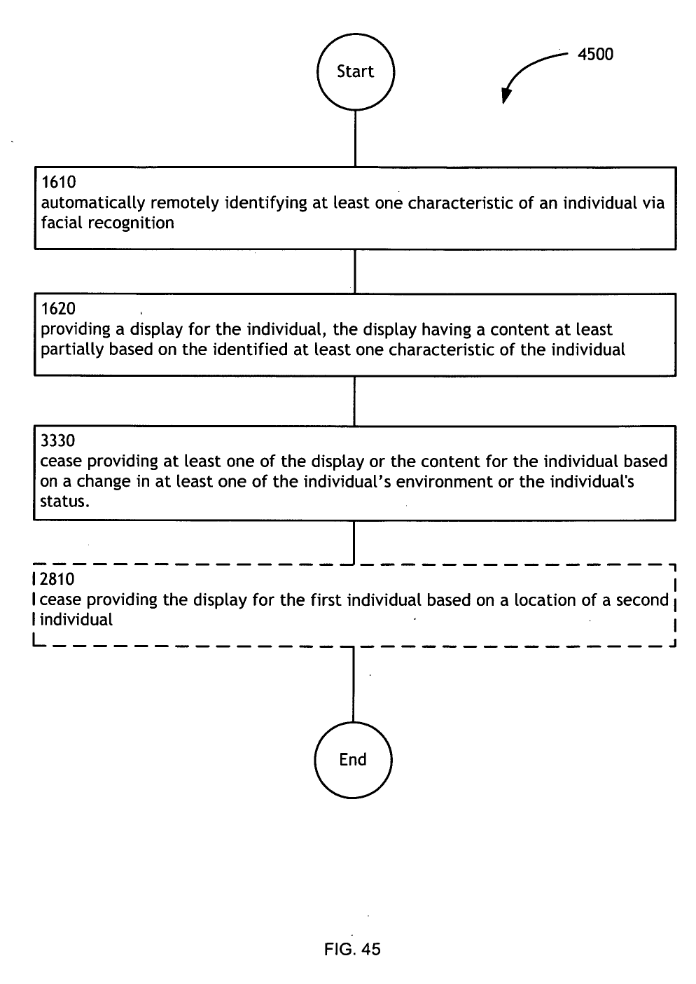

FIG. 45 illustrates an operational flow 4500 representing example operations related to automatically remotely identifying one or more characteristics of an individual utilizing facial recognition, providing a display for the individual having a content at least partially based on the one or more characteristics of the individual, and ceasing providing at least one of the display or the content for the individual. FIG. 45 illustrates an example embodiment where the example operational flow 3300 of FIG. 33 may include at least one additional operation. Additional operations may include an operation 2810.

After a start operation, an operation 1610, an operation 1620, and an operation 3330, the operational flow 4500 moves to an operation 2810. Operation 2810 illustrates cease providing the display for the first individual based on a location of a second individual.

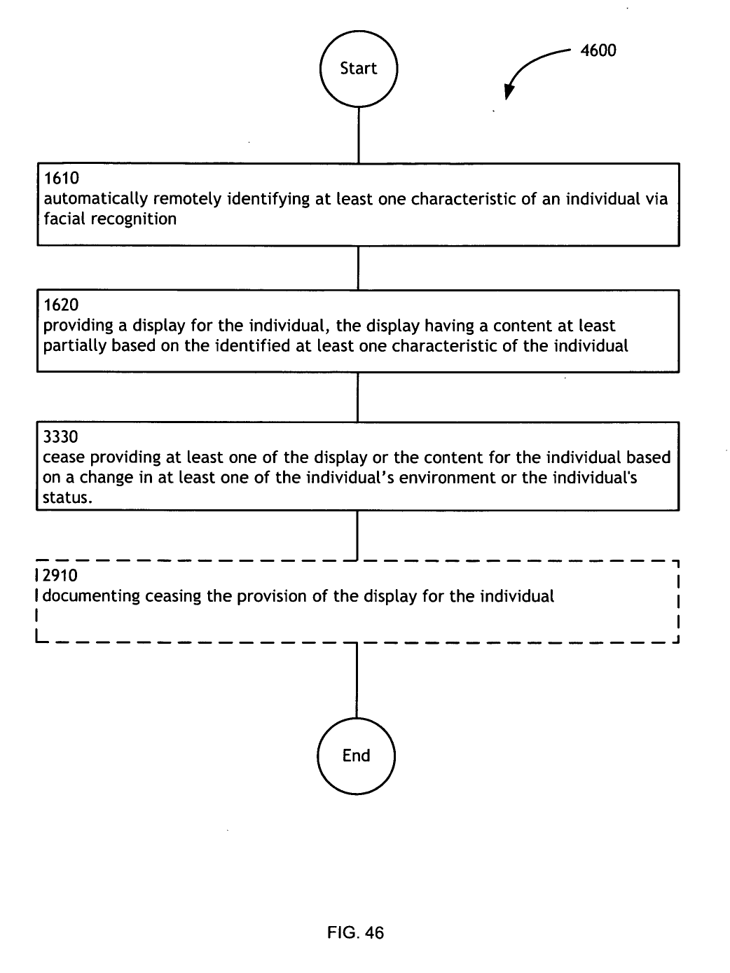

FIG. 46 illustrates an operational flow 4600 representing example operations related to automatically remotely identifying one or more characteristics of an individual utilizing facial recognition, providing a display for the individual having a content at least partially based on the one or more characteristics of the individual, and ceasing providing at least one of the display or the content for the individual. FIG. 46 illustrates an example embodiment where the example operational flow 3300 of FIG. 33 may include at least one additional operation. Additional operations may include an operation 2910.

After a start operation, an operation 1610, an operation 1620, and an operation 3330, the operational flow 4600 moves to an operation 2910. Operation 2910 illustrates documenting ceasing the provision of the display for the individual.

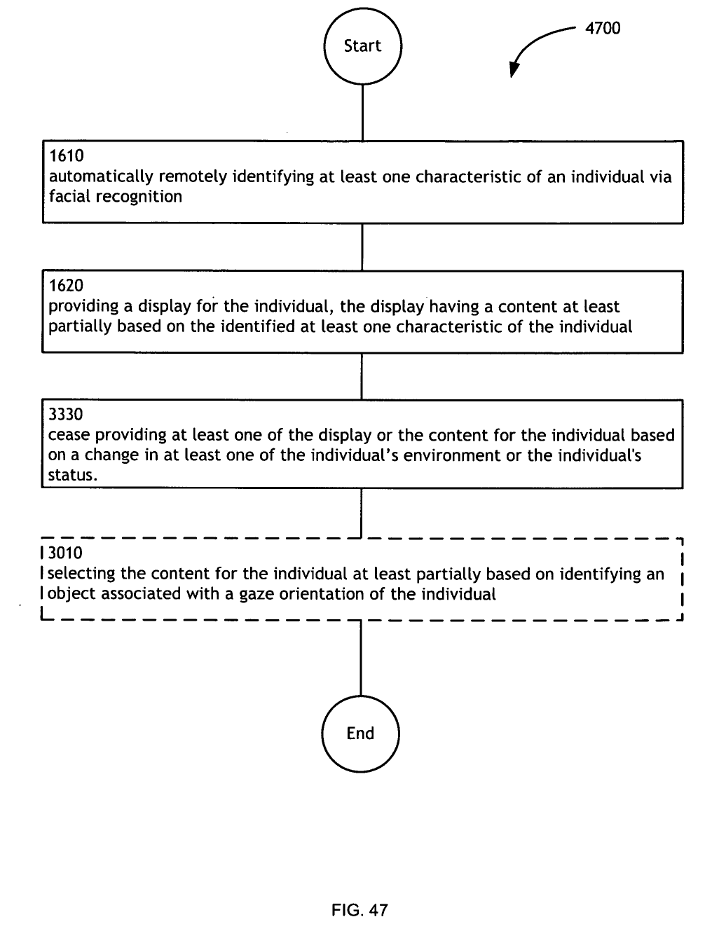

FIG. 47 illustrates an operational flow 4700 representing example operations related to automatically remotely identifying one or more characteristics of an individual utilizing facial recognition, providing a display for the individual having a content at least partially based on the one or more characteristics of the individual, and ceasing providing at least one of the display or the content for the individual. FIG. 47 illustrates an example embodiment where the example operational flow 3300 of FIG. 33 may include at least one additional operation. Additional operations may include an operation 3010.

After a start operation, an operation 1610, an operation 1620, and an operation 3330, the operational flow 4700 moves to an operation 3010. Operation 3010 illustrates selecting the content for the individual at least partially based on identifying an object associated with a gaze orientation of the individual.

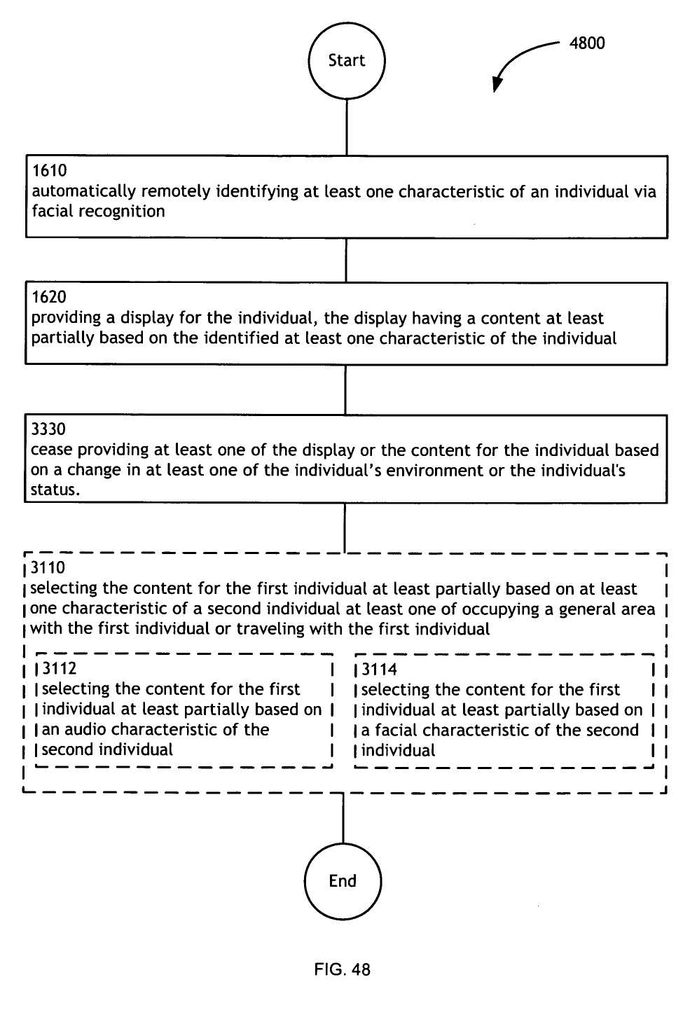

FIG. 48 illustrates an operational flow 4800 representing example operations related to automatically remotely identifying one or more characteristics of an individual utilizing facial recognition, providing a display for the individual having a content at least partially based on the one or more characteristics of the individual, and ceasing providing at least one of the display or the content for the individual. FIG. 48 illustrates an example embodiment where the example operational flow 3300 of FIG. 33 may include at least one additional operation. Additional operations may include an operation 3110, an operation 3112, and/or an operation 3114.

After a start operation, an operation 1610, an operation 1620, and an operation 3330, the operational flow 4800 moves to an operation 3110. Operation 3110 illustrates selecting the content for the first individual at least partially based on at least one characteristic of a second individual at least one of occupying a general area with the first individual or traveling with the first individual.

The operation 3112 illustrates selecting the content for the first individual at least partially based on an audio characteristic of the second individual.

The operation 3114 illustrates selecting the content for the first individual at least partially based on a facial characteristic of the second individual.

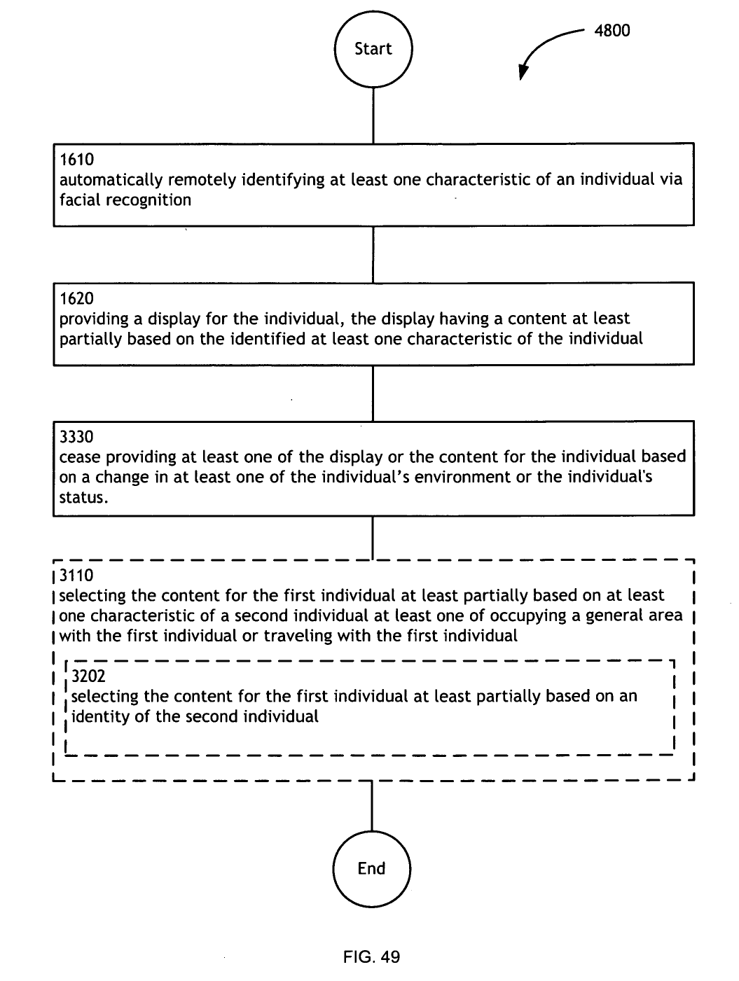

FIG. 49 illustrates alternative embodiments of the example operational flow 4800 of FIG. 48. FIG. 49 illustrates example embodiments where the operation 3110 may include at least one additional operation. Additional operations may include an operation 3202.

The operation 3202 illustrates selecting the content for the first individual at least partially based on an identity of the second individual.

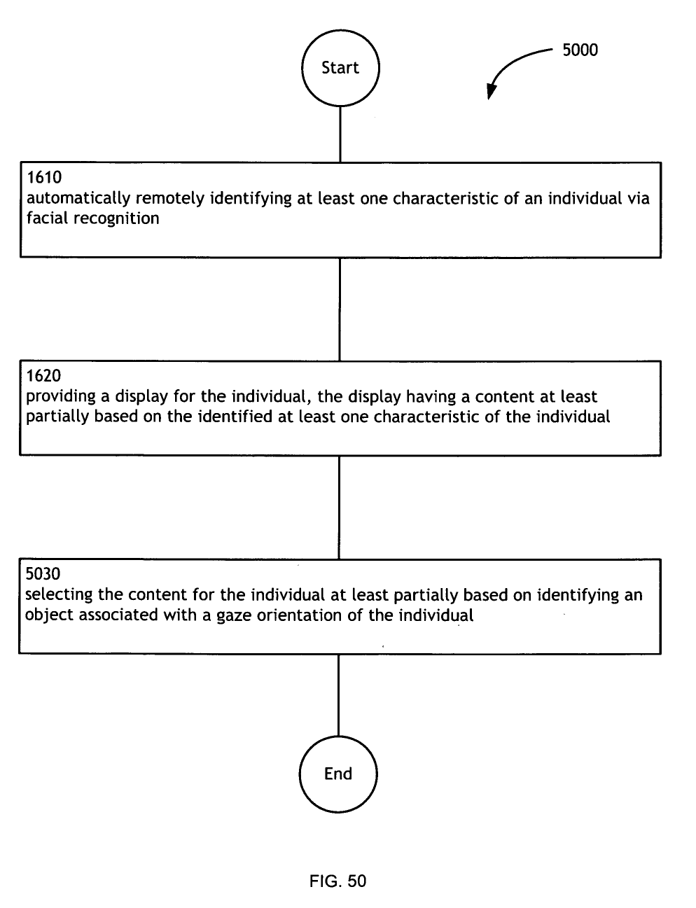

FIG. 50 illustrates an operational flow 5000 representing example operations related to automatically remotely identifying one or more characteristics of an individual utilizing facial recognition, providing a display for the individual having a content at least partially based on the one or more characteristics of the individual, and selecting the content for the individual at least partially based on identifying an object associated with a gaze orientation of the individual. In FIG. 50 and in following figures that include various examples of operational flows, discussion and explanation may be provided with respect to the above-described examples of FIGS. 1 through 15, and/or with respect to other examples and contexts. However, it should be understood that the operational flows may be executed in a number of other environments and contexts, and/or in modified versions of FIGS. 1 through 15. Also, although the various operational flows are presented in the sequence(s) illustrated, it should be understood that the various operations may be performed in other orders than those which are illustrated, or may be performed concurrently.

After a start operation, the operational flow 5000 moves to an operation 1610. Operation 1610 depicts automatically remotely identifying at least one characteristic of an individual via facial recognition.

Then, operation 1620 depicts providing a display for the individual, the display having a content at least partially based on the identified at least one characteristic of the individual.

Then, operation 5030 depicts selecting the content for the individual at least partially based on identifying an object associated with a gaze orientation of the individual. For example, as shown in FIGS. 1 through 15, the content selected for the first individual 52 may be selected based on an action of the individual 62. The action of the individual 62 may include one or more of a gaze orientation 64, a gesture 66, an audio sound 68, a vocal sound 70, a motion of at least a part of a body 72, or an orientation of at least a part of a body 74. In an embodiment, gaze orientation 64 may include, for instance, glancing at an item but not moving towards it.

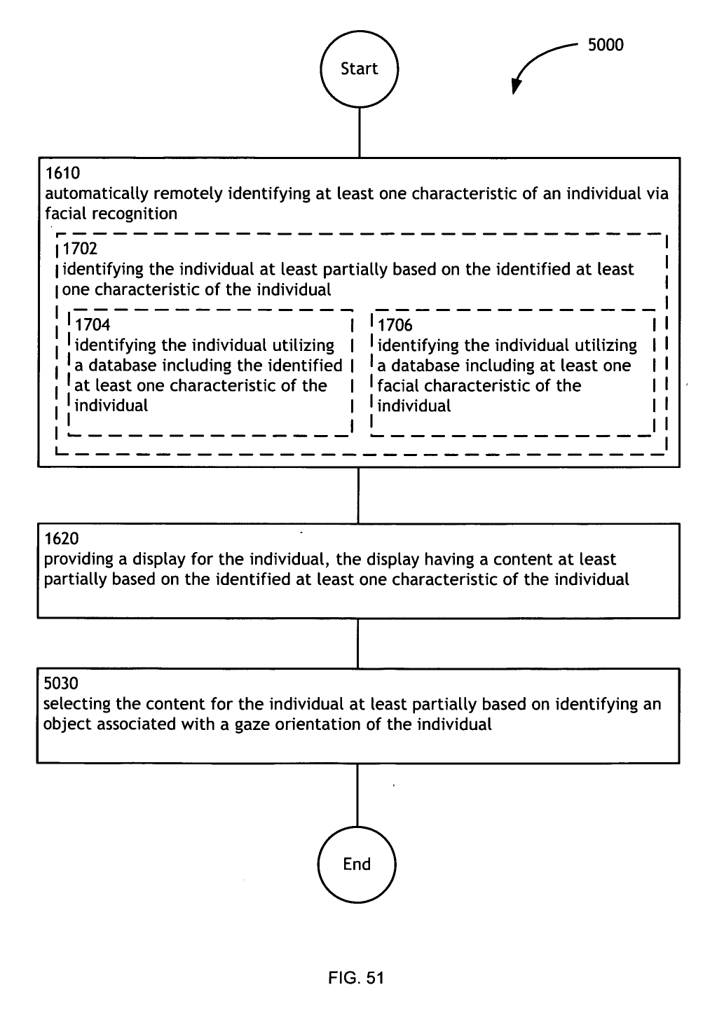

FIG. 51 illustrates alternative embodiments of the example operational flow 5000 of FIG. 50. FIG. 51 illustrates example embodiments where the operation 1610 may include at least one additional operation. Additional operations may include an operation 1702, an operation 1704, and/or an operation 1706.

The operation 1702 illustrates identifying the individual at least partially based on the identified at least one characteristic of the individual. Further, the operation 1704 illustrates identifying the individual utilizing a database including the identified at least one characteristic of the individual. Further, the operation 1706 illustrates identifying the individual utilizing a database including at least one facial characteristic of the individual.

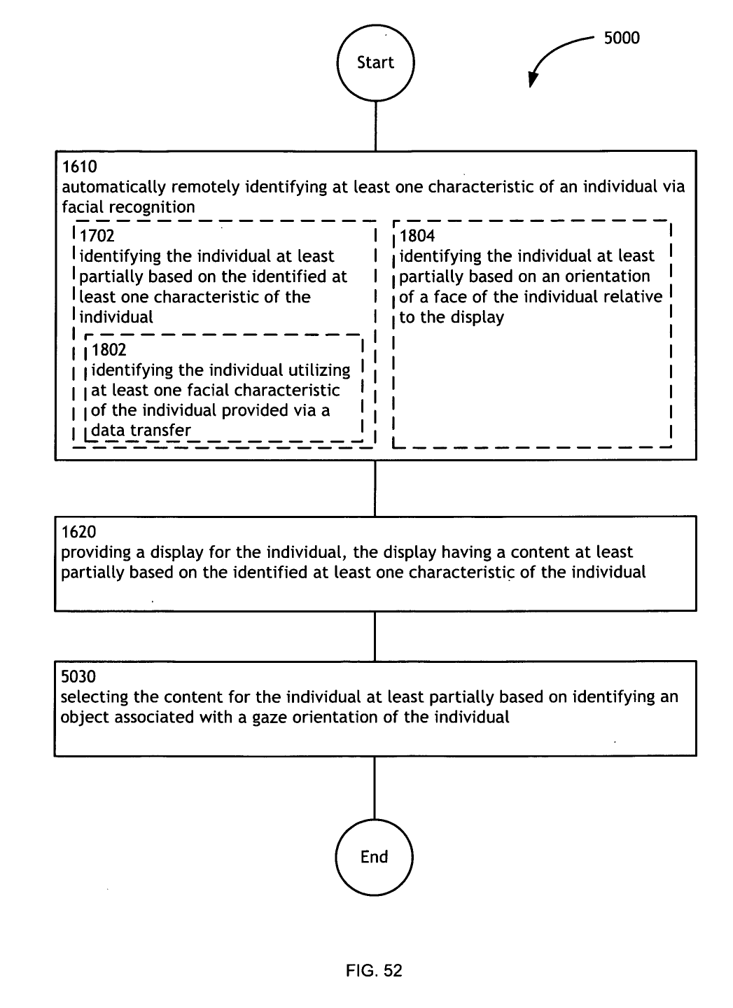

FIG. 52 illustrates alternative embodiments of the example operational flow 5000 of FIG. 50. FIG. 52 illustrates example embodiments where the operation 1610 may include at least one additional operation. Additional operations may include an operation 1802, and/or an operation 1804. Further, the operation 1802 illustrates identifying the individual utilizing at least one facial characteristic of the individual provided via a data transfer.

The operation 1804 illustrates identifying the individual at least partially based on an orientation of a face of the individual relative to the display.

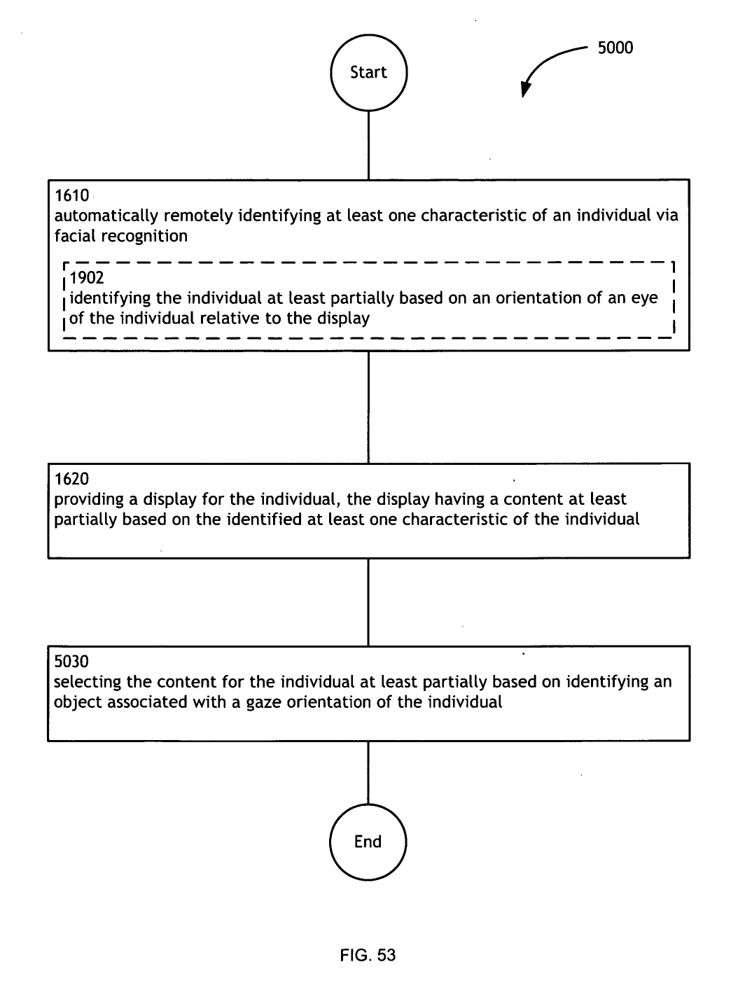

FIG. 53 illustrates alternative embodiments of the example operational flow 5000 of FIG. 50. FIG. 53 illustrates example embodiments where the operation 1610 may include at least one additional operation. Additional operations may include an operation 1902.

The operation 1902 illustrates identifying the individual at least partially based on an orientation of an eye of the individual relative to the display.

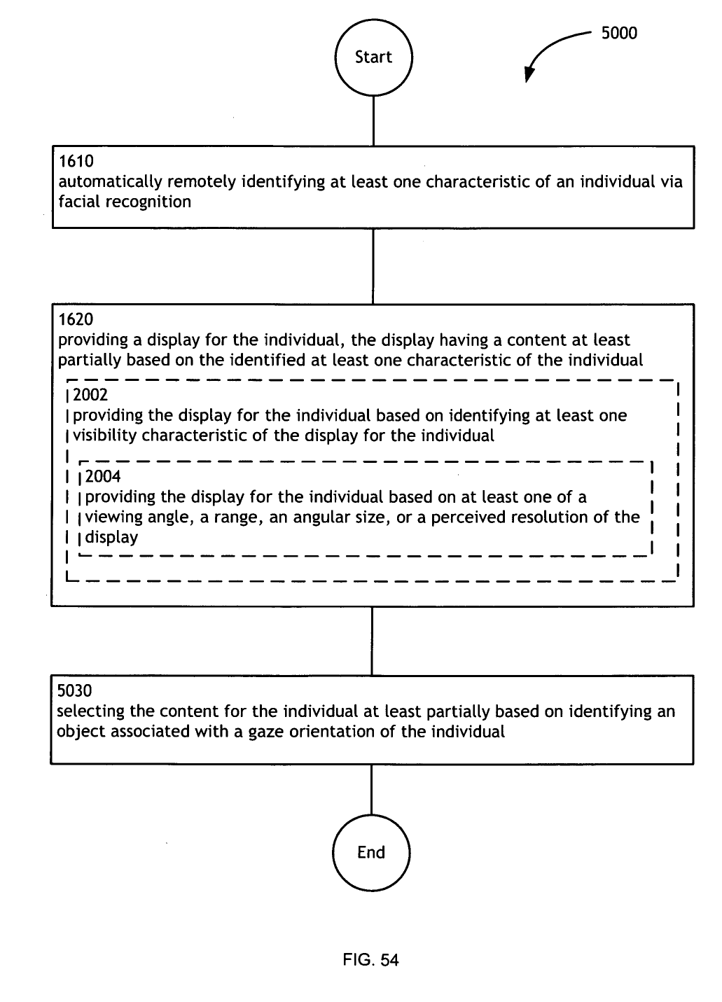

FIG. 54 illustrates alternative embodiments of the example operational flow 5000 of FIG. 50. FIG. 54 illustrates example embodiments where the operation 1620 may include at least one additional operation. Additional operations may include an operation 2002, and/or an operation 2004.

The operation 2002 illustrates providing the display for the individual based on identifying at least one visibility characteristic of the display for the individual. Further, the operation 2004 illustrates providing the display for the individual based on at least one of a viewing angle, a range, an angular size, or a perceived resolution of the display.

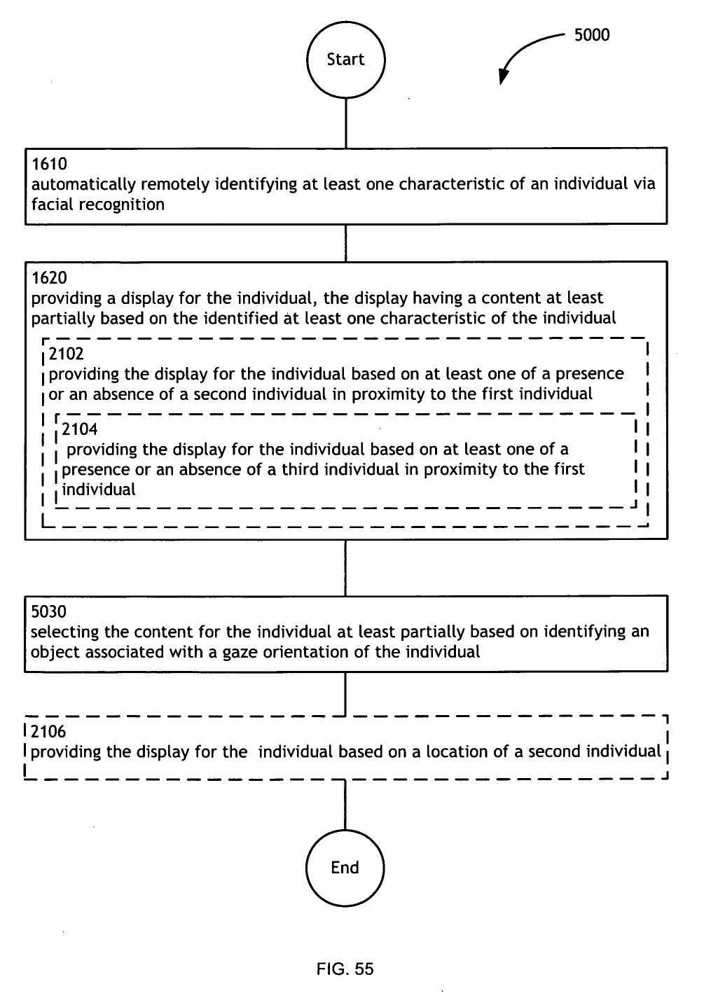

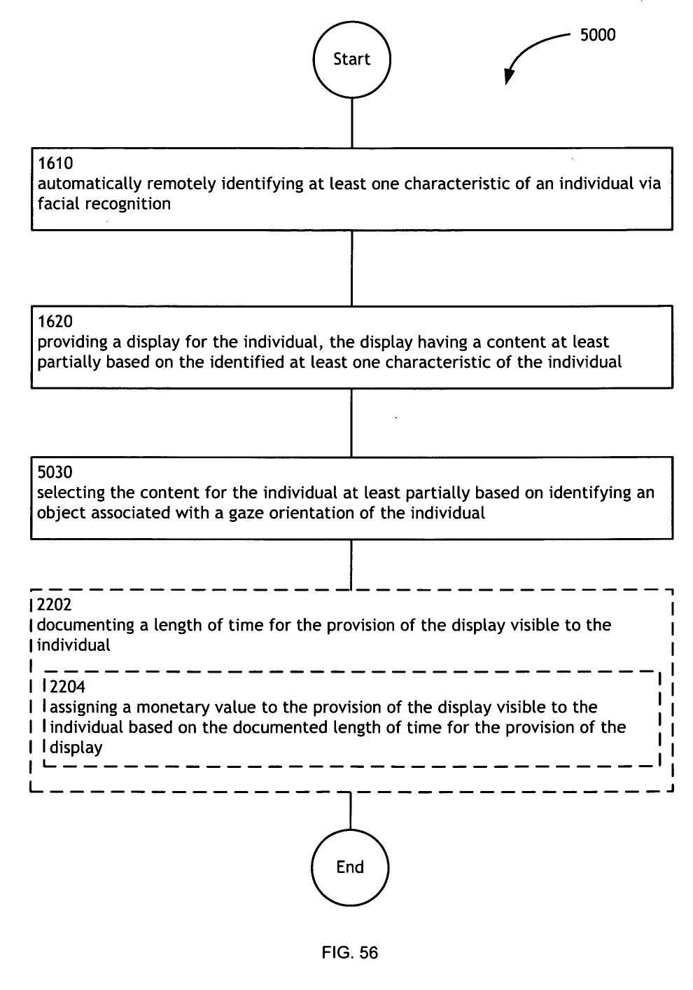

FIG. 55 illustrates alternative embodiments of the example operational flow 5000 of FIG. 50. FIG. 55 illustrates example embodiments where the operation 1620 may include at least one additional operation. FIG. 55 illustrates an example embodiment where the example operational flow 5000 of FIG. 50 may include at least one additional operation. Additional operations may include an operation 2102, an operation 2104, and/or an operation 2106.

The operation 2102 illustrates providing the display for the individual based on at least one of a presence or an absence of a second individual in proximity to the first individual. Further, the operation 2104 illustrates providing the display for the individual based on at least one of a presence or an absence of a third individual in proximity to the first individual.

The operation 2106 illustrates providing the display for the individual based on a location of a second individual.

FIG. 56 illustrates alternative embodiments of the example operational flow 5000 of FIG. 50. FIG. 56 illustrates example embodiments where the example operational flow 5000 of FIG. 50 may include at least one additional operation. Additional operations may include an operation 2202, and/or an operation 2204.

The operation 2202 illustrates documenting a length of time for the provision of the display visible to the individual. Further, the operation 2204 illustrates assigning a monetary value to the provision of the display visible to the individual based on the documented length of time for the provision of the display.

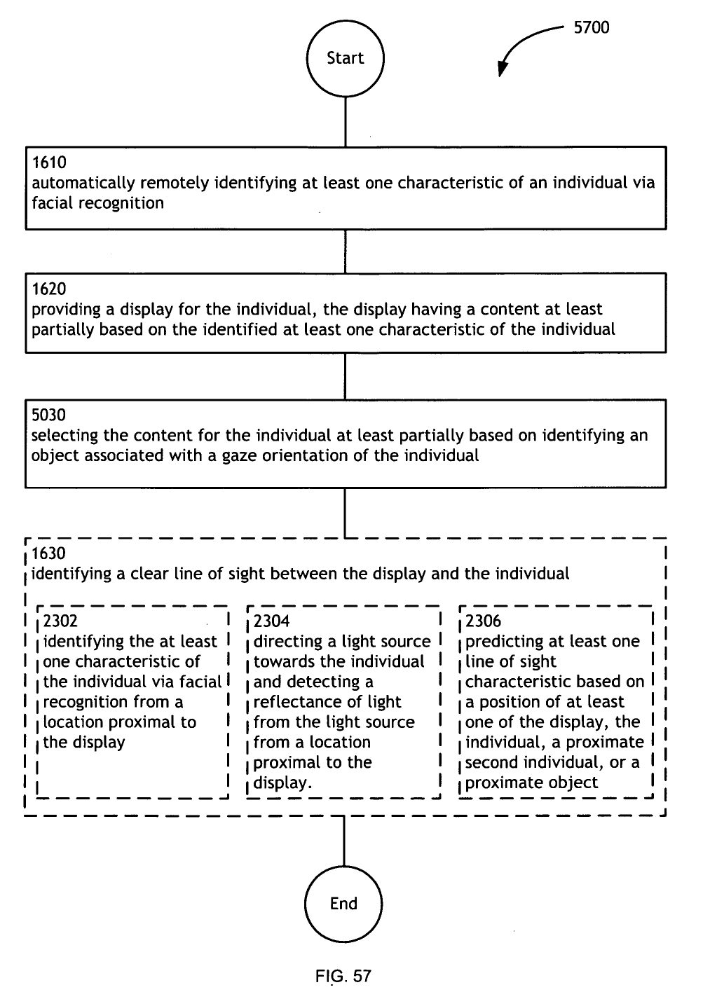

FIG. 57 illustrates an operational flow 5700 representing example operations related to automatically remotely identifying one or more characteristics of an individual utilizing facial recognition, providing a display for the individual having a content at least partially based on the one or more characteristics of the individual, selecting the content for the individual at least partially based on identifying an object associated with a gaze orientation of the individual, and identifying a clear line of sight between the display and the individual. FIG. 57 illustrates an example embodiment where the example operational flow 5000 of FIG. 50 may include at least one additional operation. Additional operations may include an operation 1630, an operation 2302, an operation 2304, and/or an operation 2306.

After a start operation, an operation 1610, an operation 1620, and an operation 5030, the operational flow 5700 moves to an operation 1630. Operation 1630 illustrates identifying a clear line of sight between the display and the individual.

The operation 2302 illustrates identifying the at least one characteristic of the individual via facial recognition from a location proximal to the display.

The operation 2304 illustrates directing a light source towards the individual and detecting a reflectance of light from the light source from a location proximal to the display.

The operation 2306 illustrates predicting at least one line of sight characteristic based on a position of at least one of the display, the individual, a proximate second individual, or a proximate object.

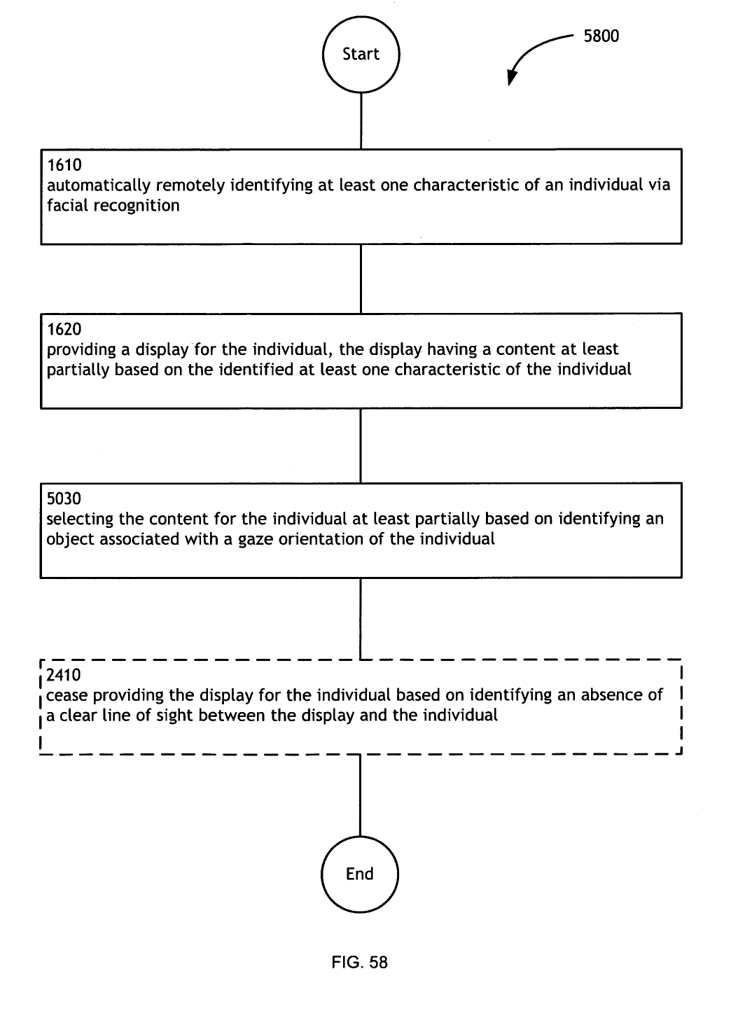

FIG. 58 illustrates an operational flow 5800 representing example operations related to automatically remotely identifying one or more characteristics of an individual utilizing facial recognition, providing a display for the individual having a content at least partially based on the one or more characteristics of the individual, selecting the content for the individual at least partially based on identifying an object associated with a gaze orientation of the individual, and ceasing providing the display for the individual. FIG. 58 illustrates an example embodiment where the example operational flow 5000 of FIG. 50 may include at least one additional operation. Additional operations may include an operation 2410.

After a start operation, an operation 1610, an operation 1620, and an operation 5030, the operational flow 5800 moves to an operation 2410. Operation 2410 illustrates cease providing the display for the individual based on identifying an absence of a clear line of sight between the display and the individual.

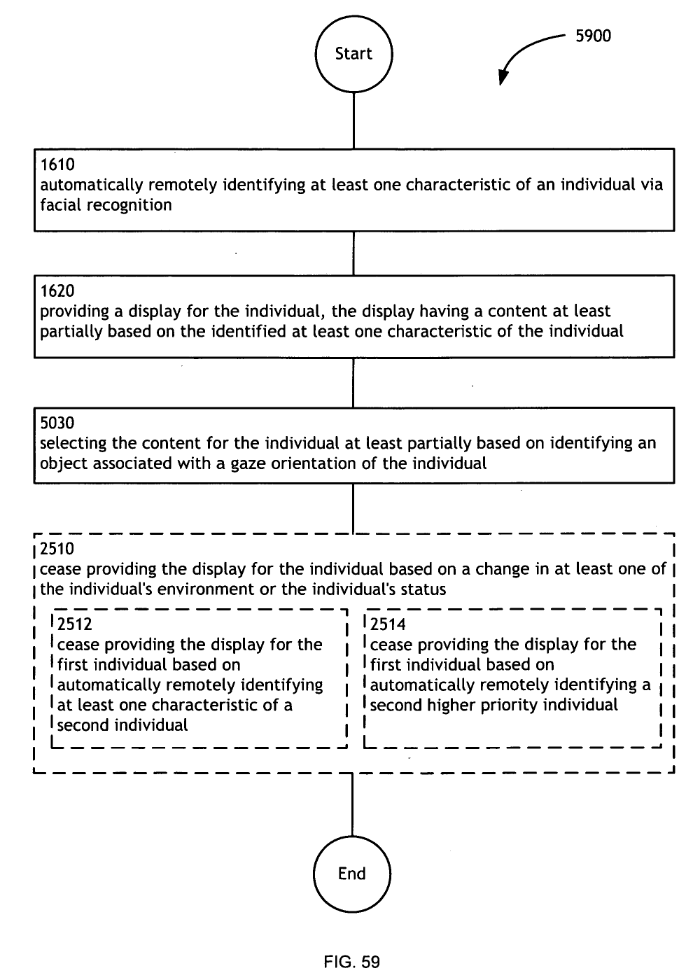

FIG. 59 illustrates an operational flow 5900 representing example operations related to automatically remotely identifying one or more characteristics of an individual utilizing facial recognition, providing a display for the individual having a content at least partially based on the one or more characteristics of the individual, selecting the content for the individual at least partially based on identifying an object associated with a gaze orientation of the individual, and ceasing providing the display for the individual. FIG. 59 illustrates an example embodiment where the example operational flow 5000 of FIG. 50 may include at least one additional operation. Additional operations may include an operation 2510, an operation 2512, and/or an operation 2514.

After a start operation, an operation 1610, an operation 1620, and an operation 5030, the operational flow 5900 moves to an operation 2510. Operation 2510 illustrates cease providing the display for the individual based on a change in at least one of the individual's environment or the individual's status.

The operation 2512 illustrates cease providing the display for the first individual based on automatically remotely identifying at least one characteristic of a second individual.

The operation 2514 illustrates cease providing the display for the first individual based on automatically remotely identifying a second higher priority individual.

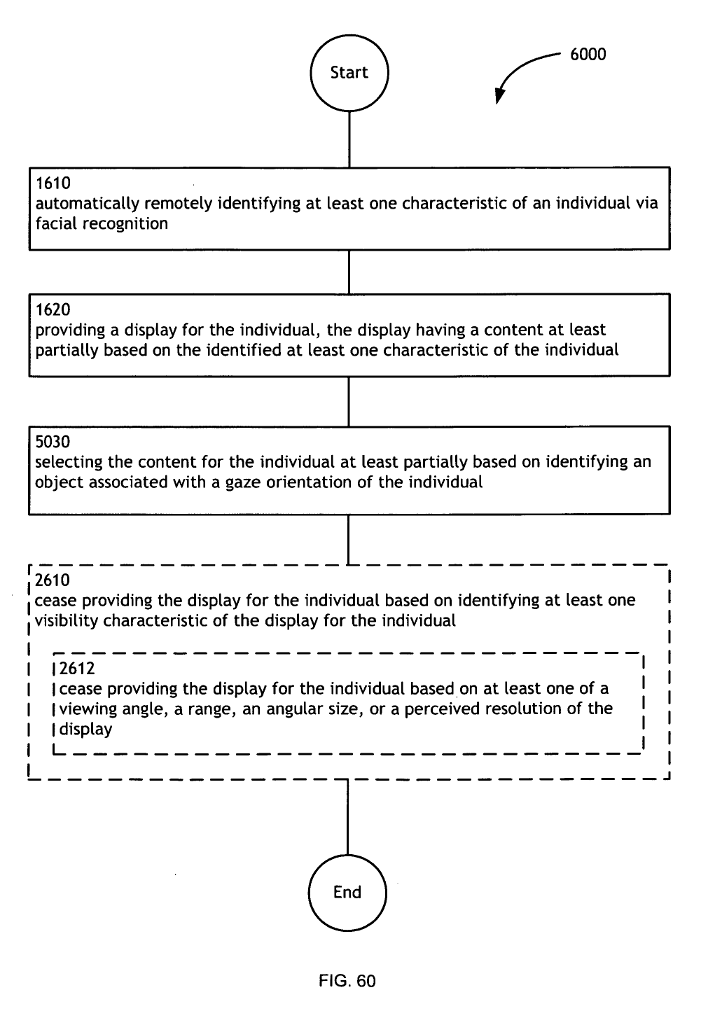

FIG. 60 illustrates an operational flow 6000 representing example operations related to automatically remotely identifying one or more characteristics of an individual utilizing facial recognition, providing a display for the individual having a content at least partially based on the one or more characteristics of the individual, selecting the content for the individual at least partially based on identifying an object associated with a gaze orientation of the individual, and ceasing providing the display for the individual. FIG. 60 illustrates an example embodiment where the example operational flow 5000 of FIG. 50 may include at least one additional operation. Additional operations may include an operation 2610, and/or an operation 2612.

After a start operation, an operation 1610, an operation 1620, and an operation 5030, the operational flow 6000 moves to an operation 2610. Operation 2610 illustrates cease providing the display for the individual based on identifying at least one visibility characteristic of the display for the individual.

The operation 2612 illustrates cease providing the display for the individual based on at least one of a viewing angle, a range, an angular size, or a perceived resolution of the display.

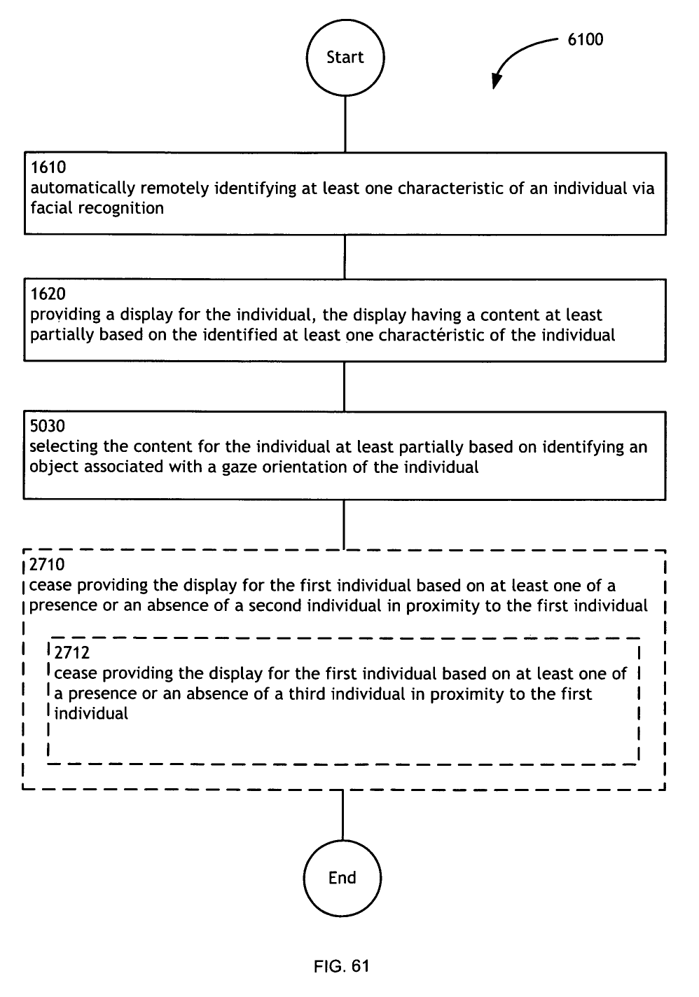

FIG. 61 illustrates an operational flow 6100 representing example operations related to automatically remotely identifying one or more characteristics of an individual utilizing facial recognition, providing a display for the individual having a content at least partially based on the one or more characteristics of the individual, selecting the content for the individual at least partially based on identifying an object associated with a gaze orientation of the individual, and ceasing providing the display for the individual. FIG. 61 illustrates an example embodiment where the example operational flow 5000 of FIG. 50 may include at least one additional operation. Additional operations may include an operation 2710, and/or an operation 2712.

After a start operation, an operation 1610, an operation 1620, and an operation 5030, the operational flow 6100 moves to an operation 2710. Operation 2710 illustrates cease providing the display for the first individual based on at least one of a presence or an absence of a second individual in proximity to the first individual.

The operation 2712 illustrates cease providing the display for the first individual based on at least one of a presence or an absence of a third individual in proximity to the first individual.

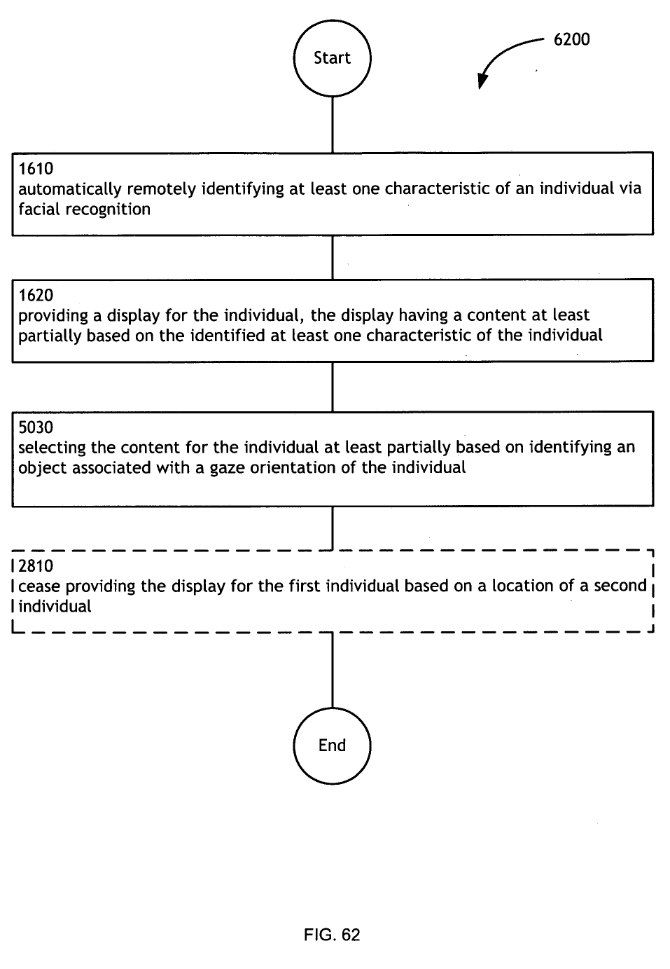

FIG. 62 illustrates an operational flow 6200 representing example operations related to automatically remotely identifying one or more characteristics of an individual utilizing facial recognition, providing a display for the individual having a content at least partially based on the one or more characteristics of the individual, selecting the content for the individual at least partially based on identifying an object associated with a gaze orientation of the individual, and ceasing providing the display for the individual. FIG. 62 illustrates an example embodiment where the example operational flow 5000 of FIG. 50 may include at least one additional operation. Additional operations may include an operation 2810.

After a start operation, an operation 1610, an operation 1620, and an operation 5030, the operational flow 6200 moves to an operation 2810. Operation 2810 illustrates cease providing the display for the first individual based on a location of a second individual.

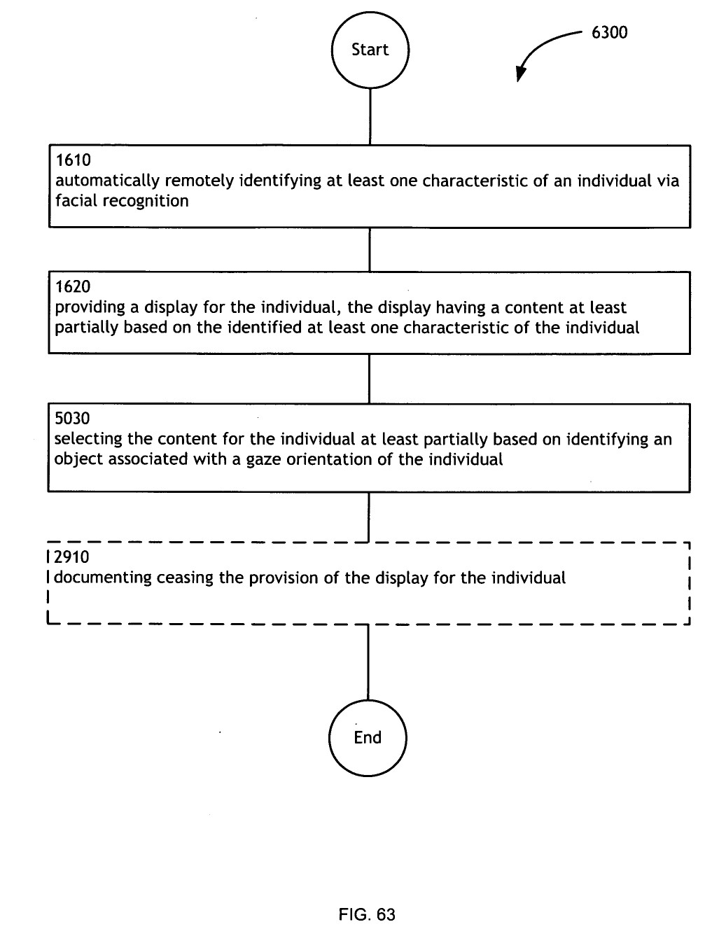

FIG. 63 illustrates an operational flow 6300 representing example operations related to automatically remotely identifying one or more characteristics of an individual utilizing facial recognition, providing a display for the individual having a content at least partially based on the one or more characteristics of the individual, selecting the content for the individual at least partially based on identifying an object associated with a gaze orientation of the individual, and ceasing providing the display for the individual. FIG. 63 illustrates an example embodiment where the example operational flow 5000 of FIG. 50 may include at least one additional operation. Additional operations may include an operation 2910.

After a start operation, an operation 1610, an operation 1620, and an operation 5030, the operational flow 6300 moves to an operation 2910. Operation 2910 illustrates documenting ceasing the provision of the display for the individual.

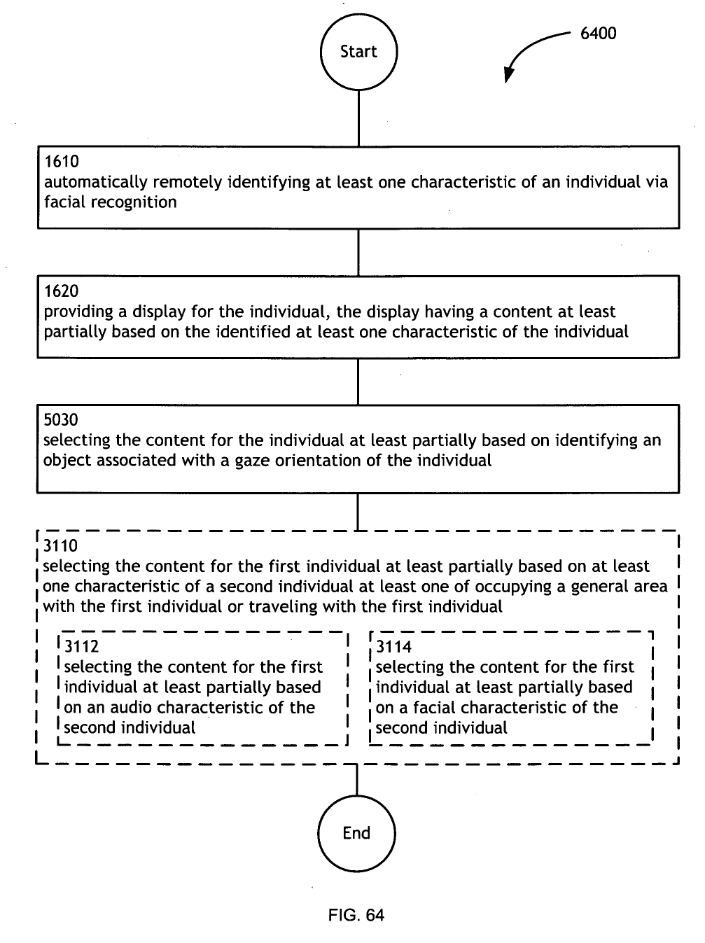

FIG. 64 illustrates an operational flow 6400 representing example operations related to automatically remotely identifying one or more characteristics of an individual utilizing facial recognition, providing a display for the individual having a content at least partially based on the one or more characteristics of the individual, selecting the content for the individual at least partially based on identifying an object associated with a gaze orientation of the individual, and selecting the content for the first individual at least partially based on at least one characteristic of a second individual. FIG. 64 illustrates an example embodiment where the example operational flow 5000 of FIG. 50 may include at least one additional operation. Additional operations may include an operation 3110, an operation 3112, and/or an operation 3114.

After a start operation, an operation 1610, an operation 1620, and an operation 5030, the operational flow 6400 moves to an operation 3110. Operation 3110 illustrates selecting the content for the first individual at least partially based on at least one characteristic of a second individual at least one of occupying a general area with the first individual or traveling with the first individual.

The operation 3112 illustrates selecting the content for the first individual at least partially based on an audio characteristic of the second individual.

The operation 3114 illustrates selecting the content for the first individual at least partially based on a facial characteristic of the second individual.

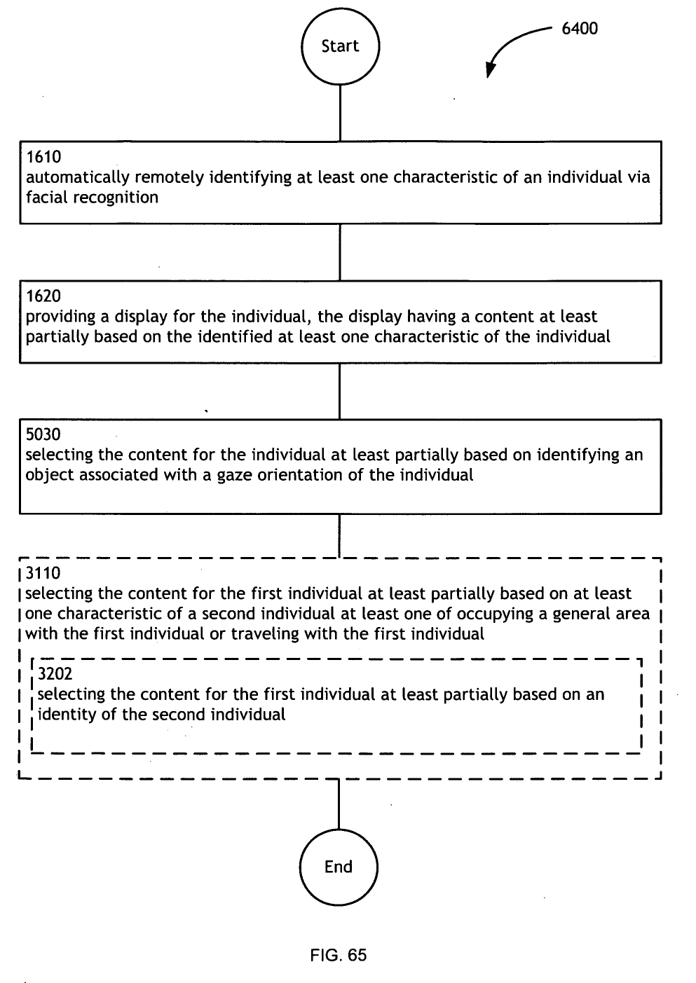

FIG. 65 illustrates alternative embodiments of the example operational flow 6400 of FIG. 64. FIG. 65 illustrates example embodiments where the operation 3110 may include at least one additional operation. Additional operations may include an operation 3202.

The operation 3202 illustrates selecting the content for the first individual at least partially based on an identity of the second individual.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method, comprising:
automatically remotely identifying at least one characteristic of an individual via facial recognition;
providing a display for the individual, the display having a content at least partially based on the identified at least one characteristic of the individual; and
cease providing at least one of the display or the content for the individual based on a change in at least one of the individual's environment or the individual's status.

2. The method of claim 1, wherein automatically remotely identifying at least one characteristic of an individual via facial recognition comprises:
identifying the individual at least partially based on the identified at least one characteristic of the individual.

3.-9. (canceled)

10. The method of claim 1, wherein automatically remotely identifying at least one characteristic of an individual via facial recognition comprises:
identifying the individual at least partially based on an orientation of a face of the individual relative to the display.

11. The method of claim 1, wherein automatically remotely identifying at least one characteristic of an individual via facial recognition comprises:
identifying the individual at least partially based on an orientation of an eye of the individual relative to the display.

12.-15. (canceled)

16. The method of claim 1, wherein providing a display for the individual, the display having a content at least partially based on the identified at least one characteristic of the individual comprises:
providing the display for the individual based on at least one of a presence or an absence of a second individual in proximity to the first individual.

17. (canceled)

18. The method of claim 1, further comprising:
providing the display for the individual based on a location of a second individual.

19.-22. (canceled)

23. The method of claim 1, further comprising:
identifying a clear line of sight between the display and the individual.

24. (canceled)

25. The method of claim 23, wherein identifying a clear line of sight between the display and the individual comprises:
directing a light source towards the individual and detecting a reflectance of light from the light source from a location proximal to the display.

26.-28. (canceled)

29. The method of claim 1, wherein cease providing at least one of the display or the content for the individual based on a change in at least one of the individual's environment or the individual's status comprises:
cease providing the display for the first individual based on automatically remotely identifying a second higher priority individual.

30.-33. (canceled)

34. The method of claim 1, further comprising:
cease providing the display for the first individual based on at least one of a presence or an absence of a second individual in proximity to the first individual.

35.-37. (canceled)

38. The method of claim 1, further comprising:
selecting the content for the individual at least partially based on identifying an object associated with a gaze orientation of the individual.

39. The method of claim 1, further comprising:
selecting the content for the first individual at least partially based on at least one characteristic of a second individual at least one of occupying a general area with the first individual or traveling with the first individual.

40.-42. (canceled)

43. A system, comprising:
means for automatically remotely identifying at least one characteristic of an individual via facial recognition;
means for providing a display for the individual, the display having a content at least partially based on the identified at least one characteristic of the individual; and
means for cease providing at least one of the display or the content for the individual based on a change in at least one of the individual's environment or the individual's status.

44. The system of claim 43, wherein means for automatically remotely identifying at least one characteristic of an individual via facial recognition comprises:
means for identifying the individual at least partially based on the identified at least one characteristic of the individual.

45. (canceled)

46. The system of claim 44, wherein means for identifying the individual at least partially based on the identified at least one characteristic of the individual comprises:
means for identifying the individual utilizing a database including at least one facial characteristic of the individual.

47. The system of claim 44, wherein means for identifying the individual at least partially based on the identified at least one characteristic of the individual comprises:
means for identifying the individual utilizing at least one facial characteristic of the individual provided via a data transfer.

48. The system of claim 47, wherein the data transfer includes at least one of a beacon, a mobile communications device, or an RFID tag.

49. The system of claim 44, wherein the content is at least partially based on a demographic for the individual.

50. (canceled)

51. The system of claim 44, wherein the content is at least partially based on the identity of the individual.

52. The system of claim 43, wherein means for automatically remotely identifying at least one characteristic of an individual via facial recognition comprises:
means for identifying the individual at least partially based on an orientation of a face of the individual relative to the display.

53. The system of claim 43, wherein means for automatically remotely identifying at least one characteristic of an individual via facial recognition comprises:
means for identifying the individual at least partially based on an orientation of an eye of the individual relative to the display.

54. (canceled)

55. The system of claim 43, wherein means for providing a display for the individual, the display having a content at least partially based on the identified at least one characteristic of the individual comprises:
means for providing the display for the individual based on identifying at least one visibility characteristic of the display for the individual.

56.-57. (canceled)

58. The system of claim 43, wherein means for providing a display for the individual, the display having a content at least partially based on the identified at least one characteristic of the individual comprises:
means for providing the display for the individual based on at least one of a presence or an absence of a second individual in proximity to the first individual.

59. The system of claim 58, wherein means for providing the display for the individual based on at least one of a presence or an absence of a second individual in proximity to the first individual further comprises:
means for providing the display for the first individual based on at least one of a presence or an absence of a third individual in proximity to the first individual.

60. The system of claim 43, further comprising:
means for providing the display for the individual based on a location of a second individual.

61. The system of claim 43, further comprising:
means for documenting a length of time for the provision of the display visible to the individual.

62. The system of claim 61, wherein the visibility to the individual is determined by a clear line of sight for the individual and a facial orientation of the individual relative to the display.

63. The system of claim 61, wherein means for documenting a length of time for the provision of the display visible to the individual comprises:
means for assigning a monetary value to the provision of the display visible to the individual based on the documented length of time for the provision of the display.

64. The system of claim 43, wherein the content includes at least one of advertisement, entertainment, or information.

65. The system of claim 43, further comprising:
means for identifying a clear line of sight between the display and the individual.

66. (canceled)

67. The system of claim 65, wherein means for identifying a clear line of sight between the display and the individual comprises:
means for directing a light source towards the individual and detecting a reflectance of light from the light source from a location proximal to the display.

68. The system of claim 65, wherein means for identifying a clear line of sight between the display and the individual comprises:
means for predicting at least one line of sight characteristic based on a position of at least one of the display, the individual, a proximate second individual, or a proximate object.

69. The system of claim 43, further comprising:
means for cease providing the display for the individual based on identifying an absence of a clear line of sight between the display and the individual.

70. The system of claim 43, wherein means for cease providing at least one of the display or the content for the individual based on a change in at least one of the individual's environment or the individual's status comprises:
means for cease providing the display for the first individual based on automatically remotely identifying at least one characteristic of a second individual.

71. The system of claim 43, wherein means for cease providing at least one of the display or the content for the individual based on a change in at least one of the individual's environment or the individual's status comprises:
means for cease providing the display for the first individual based on automatically remotely identifying a second higher priority individual.

72. (canceled)

73. The system of claim 43, further comprising:
means for cease providing the display for the individual based on identifying at least one visibility characteristic of the display for the individual.

74.-75. (canceled)

76. The system of claim 43, further comprising:
means for cease providing the display for the first individual based on at least one of a presence or an absence of a second individual in proximity to the first individual.

77. The system of claim 76, wherein means for cease providing the display for the first individual based on at least one of a presence or an absence of a second individual in proximity to the first individual further comprises:
means for cease providing the display for the first individual based on at least one of a presence or an absence of a third individual in proximity to the first individual.

78. The system of claim 43, further comprising:
means for cease providing the display for the first individual based on a location of a second individual.

79. (canceled)

80. The system of claim 43, further comprising:
means for selecting the content for the individual at least partially based on identifying an object associated with a gaze orientation of the individual.

81. The system of claim 43, further comprising:
means for selecting the content for the first individual at least partially based on at least one characteristic of a second individual at least one of occupying a general area with the first individual or traveling with the first individual.

82.-83. (canceled)

84. The system of claim 81, wherein means for selecting the content for the first individual at least partially based on at least one characteristic of a second individual at least one of occupying a general area with the first individual or traveling with the first individual comprises:
means for selecting the content for the first individual at least partially based on an identity of the second individual.
